(19) United States
(12) Patent Application Publication
(10) Pub. No.: US 2026/0206741 A1
(43) Pub. Date: Jul. 23, 2026

(54) OXYGEN IMPERMEABLE PORPHYRIN PHOTOSENSITIZER FILM COMPOSITION FOR APPLICATION TO PLANTS

(71) Applicant: NUTRIEN AG SOLUTIONS (CANADA) INC., Calgary (CA)

(72) Inventors: Kenneth Ng, Mississauga (CA); Michael Fefer, Mississauga (CA); Jun Liu, Mississauga (CA); Yuichi Terazono, Mississauga (CA); Adam Bleik, Barrie (CA)

(73) Assignee: NUTRIEN AG SOLUTIONS (CANADA) INC., Calgary (CA)

(21) Appl. No.: 19/566,565

(22) Filed: Mar. 13, 2026

Related U.S. Application Data
(63) Continuation of application No. 17/800,776, filed on Feb. 20, 2020.

(51) Int. Cl. A01N 3/00; A01N 25/10; A01P 1/00

(52) U.S. Cl. CPC A01N 3/00; A01N 25/10; A01P 1/00

(57) ABSTRACT

A method for promoting the health of a plant is provided. The method includes applying a composition to a plant and removing at least a portion of the aqueous carrier from the composition for the film forming agent to form a film on the plant that is substantially impermeable to oxygen when in a non-hydrated state. The composition includes a photosensitizer that generates reactive oxygen species in the presence of light and oxygen, the photosensitizer being selected from the group consisting of a porphyrin, a reduced porphyrin and a combination thereof, a film-forming agent, an antioxidant agent, and a liquid carrier, in which the photosensitizer, the film-forming agent and the antioxidant agent are solubilized or dispersed.

### CROSS-REFERENCE TO RELATED APPLICATION

This application is a Continuation of U.S. Non-Provisional application Ser. No. 17/800,776 filed on Aug. 18, 2022 that further claims priority to International Application No. PCT/CA2020/050219 filed Feb. 20, 2020, the entire disclosures of which are hereby incorporated by reference in entirety.

### FIELD

The technical field generally relates to photodynamic compositions for improving the health of plants, and more specifically relates to film-forming photodynamic compositions that include a photosensitizer, to be applied to plants.

### BACKGROUND

Photodynamic inhibition of microbial pathogens involves exposing a photosensitive agent to light in order to generate reactive oxygen species (ROS), such as singlet oxygen, which can have detrimental effects on the microbial pathogens. Photosensitizers typically degrade when in the presence of light and oxygen. There is a need for compositions that can extend the stability of photosensitizers.

### SUMMARY

In a first aspect, a composition for application to a plant is provided. The composition includes a photosensitizer that generates reactive oxygen species in the presence of light and oxygen, the photosensitizer being selected from the group consisting of a porphyrin, a reduced porphyrin and a combination thereof; a film-forming agent, the film-forming agent forming a film that is substantially impermeable to oxygen when in a non-hydrated state; an antioxidant agent; and a liquid carrier in which the photosensitizer, the film-forming agent and the antioxidant agent are solubilized and/or dispersed.

In another aspect, the compositions described herein are used for improving the health of a plant is provided.

In yet another aspect, a method for improving the health of a plant is provided. The method includes: applying to the plant a composition including: a photosensitizer that generates reactive oxygen species in the presence of light and oxygen, the photosensitizer being selected from the group consisting of a porphyrin, a reduced porphyrin and a combination thereof; a film-forming agent; an antioxidant agent; and an aqueous carrier in which the photosensitizer, film-forming agent and antioxidant agent are solubilized or dispersed; and removing at least a portion of the aqueous carrier from the composition for the film-forming agent to form a film on the plant that is substantially impermeable to oxygen when in a non-hydrated state.

In some implementations, the film-forming agent is selected from the group consisting of: ethylcellulose, methylcellulose, carboxymethyl cellulose, hydroxymethylcellulose, hydroxypropylcellulose, hydroxymethylpropylcellulose, guar gum, hydroxylpropyl cellulose polyvinylpyrrolidone, nanocellulose, soy protein isolate, whey protein, collagen, starch, hydroxypropylated amylomaize starch, amylomaize starch, xylan, polyvinylidene chloride, polyvinyl alcohol (PVOH), ethylene vinyl alcohol (EVA), polyvinyl alcohol copolymer, and combinations thereof.

In some implementations, the film-forming agent comprises polyvinyl alcohol.

In some implementations, the polyvinyl alcohol has an average molecular weight from about 10 kDa to about 200 kDa.

In some implementations, the polyvinyl alcohol is a degree of hydrolysis equal to or greater than 70%.

In some implementations, the polyvinyl alcohol has an average molecular weight from about 50 kDa to about 100 kDa, and a degree of hydrolysis equal to or greater than 99%.

In some implementations, the antioxidant agent is more reactive than the photosensitizer towards reactive oxygen species when in solution.

In some implementations, the antioxidant agent is more reactive than the photosensitizer towards reactive oxygen species when in a film that is in a hydrated state.

In some implementations, the antioxidant agent is selected from the group consisting of vanillin (4-hydroxy-3-methoxybenzaldehyde), o-vanillin (2-hydroxy-3-methoxybenzaldehyde), vanillyl alcohol, tannic acid, gallic acid, propyl gallate, lauryl gallate, carvacrol, eugenol, thymol, lignosulfonate sodium, t-butyl-hydroxyquinone, butylated hydroxytoluene, butylated hydroxyanisole, alpha-tocopherol, D-alpha-tocopheryl polyethylene glycol succinate, retinyl palmitate, beta-carotene, erythorbic acid, sodium erythorbate, sodium ascorbate, ascorbic acid, gluthatione, superoxide dismutase, catalase, sodium azide, 1,4-diazabicyclo[2.2.2]octane (DABCO), and combinations thereof.

In some implementations, the antioxidant agent comprises a phenolic antioxidant.

In some implementations, the phenolic antioxidant is selected from the group consisting of vanillin (4-hydroxy-3-methoxybenzaldehyde), o-vanillin (2-hydroxy-3-methoxybenzaldehyde), vanillyl alcohol, tannic acid, gallic acid, propyl gallate, lauryl gallate, carvacrol, eugenol, thymol, lignosulfonate, and combinations thereof.

In some implementations, the photosensitizer is metallated with a metal selected such that, in response to light and oxygen exposure, the metallated photosensitizer generates reactive oxygen species.

In some implementations, the metal is selected from the group consisting of Mg, Zn, Pd, Al, Pt, Sn, Si, Ga, In, Cu, Co, Fe, Ni, Mn and mixtures thereof.

In some implementations, the metal is selected from the group consisting of Mg(II), Zn(II), Pd(II), Sn(IV), Al(III), Pt(II), Si(IV), Ge(IV), Ga(II) and In(III), Cu(II), Co(II), Fe(II), Mn(II), Co(III), Fe(III), Fe(IV) and Mn(III).

In some implementations, the photosensitizer is metal-free and is selected such that, in response to light and oxygen exposure, the metal-free photosensitizer generates reactive oxygen species.

In some implementations, the photosensitizer comprises a reduced porphyrin.

In some implementations, the photosensitizer is selected from the group consisting of a chlorin, a bacteriochlorin, an isobacteriochlorin, a corrin, a corphin and a mixture thereof.

In some implementations, the photosensitizer is a chlorin.

In some implementations, the chlorin is chlorin e6 or a modified chlorin e6.

In some implementations, the photosensitizer comprises a porphyrin.

In some implementations, the porphyrin is a protoporphyrin or meso-tetra-(4-sulfonatophenyl) porphyrin (TPPS).

In some implementations, the photosensitizer comprises protoporphyrin IX (PP IX) or a modified PP IX.

In some implementations, the liquid carrier is an aqueous carrier.

In some implementations, the aqueous carrier comprises at least one water-soluble compound that increases the solubility and/or dispersibility of at least one of the photosensitizer, film-forming agent and antioxidant agent in the aqueous carrier.

In some implementations, the aqueous carrier comprises an oil and is an oil-in-water emulsion.

In some implementations, the oil is selected from the group consisting of a mineral oil, a vegetable oil and a mixture thereof.

In some implementations, the oil comprises a vegetable oil selected from the group consisting of coconut oil, canola oil, soybean oil, rapeseed oil, sunflower oil, safflower oil, peanut oil, cottonseed oil, palm oil, rice bran oil and mixtures thereof.

In some implementations, the oil comprises a mineral oil selected from the group consisting of a paraffinic oil, a branched paraffinic oil, naphthenic oil, an aromatic oil and mixtures thereof.

In some implementations, the oil comprises a poly-alpha-olefin (PAO).

In some implementations, the composition further comprises a chelating agent.

In some implementations, the chelating agent is selected from the group consisting of ethylenediaminetetraacetic acid (EDTA) or an agriculturally acceptable salt thereof, ethylenediamine-N,N′-disuccinic acid (EDDS) or an agriculturally acceptable salt thereof, iminodisuccinic acid (IDS) or an agriculturally acceptable salt thereof, nitrilotriacetic acid (NTA) or an agriculturally acceptable salt thereof, L-glutamic acid N,N-diacetic acid (GLDA) or an agriculturally acceptable salt thereof, methylglycine diacetic acid (MGDA) or an agriculturally acceptable salt thereof, diethylenetriaminepentaacetic acid (DTPA) or an agriculturally acceptable salt thereof, ethylenediamine-N,N′-diglutaric acid (EDDG) or an agriculturally acceptable salt thereof, ethylenediamine-N,N′-dimalonic acid (EDDM) or an agriculturally acceptable salt thereof, 3-hydroxy-2,2-iminodisuccinic acid (HIDS) or an agriculturally acceptable salt thereof, hydroxyethyliminodiacetic acid (HEIDA) or an agriculturally acceptable salt thereof, polyaspartic acid, and mixtures thereof.

In some implementations, the chelating agent is metallated.

In some implementations, the chelating agent is metal-free.

In some implementations, the composition further comprises a surfactant.

In some implementations, the surfactant is selected from the group consisting of an ethoxylated alcohol, a polymeric surfactant, a fatty acid ester, a polyethylene glycol, an ethoxylated alkyl alcohol, a monoglyceride, an alkyl monoglyceride and a mixture thereof.

In some implementations, the film-forming agent is present in an amount between about 0.01 wt % and about 20 wt %, based on a total weight of the composition.

In some implementations, the photosensitizer is present in an amount between about 0.01 wt % and about 10 wt %, based on a total weight of the composition.

In some implementations, the antioxidant agent is present in an amount between about 0.01 wt % and about 5 wt %, based on a total weight of the composition.

In some implementations, the composition is a ready-to-use composition to be applied to the plant.

In some implementations, the composition is a concentrate to be diluted prior to be applied to the plant.

In some implementations, the plant is a grown plant.

In some implementations, the plant is a non-woody crop plant, a woody plant or a turfgrass.

In some implementations, the film is substantially impermeable to oxygen when in an environment of relative humidity lower than about 50% RH.

In some implementations, the film is substantially impermeable to oxygen when in an environment of relative humidity lower than about 60% RH.

In some implementations, the film is substantially permeable to oxygen when in a hydrated state.

In some implementations, the film is substantially permeable to oxygen when in an environment of relative humidity between 50% RH and 100% RH.

In some implementations, the film is substantially permeable to oxygen when in an environment of relative humidity between 60% RH and 100% RH.

In some implementations, the composition is for application to the plant by at least one of irrigating, spraying, misting, sprinkling, pouring and dipping.

In some implementations, the composition is applied to a non-regenerable part of the plant.

In some implementations, the liquid carrier is removed by air drying after the composition is applied to the plant.

In some implementations, the film-forming agent forms a film when at least a portion of the liquid carrier is removed from the composition.

In some implementations, the composition is for use in promoting the health of a plant.

In some implementations, promoting the health of the plant comprises preventing or inhibiting growth of a microbial pathogen of the plant.

In some implementations, the microbial pathogen comprises a fungal pathogen, a bacterial pathogen, a virus, a viroid, a virus-like organism or a phytoplasma.

In some implementations, the microbial pathogen is a fungal pathogen.

In some implementations, the microbial pathogen is a bacterial pathogen.

In some implementations, promoting the health of the plant comprises increasing resistance of the plant to one or more abiotic stress.

In some implementations, the one or more abiotic stress is selected from the group consisting of cold stress, heat stress, water stress, transplant shock stress, low light stress, photooxidative stress, drought stress and salinity stress.

In some implementations, promoting the health of the plant comprises controlling an insect pest of the plant.

In some implementations, the insect pest is selected from the group consisting of insects and insect larvae.

### BRIEF DESCRIPTION OF THE FIGURES

FIG. 1 is a schematic representation of a film comprising a photosensitizer and an antioxidant, in (a) a non-hydrated state and in a (b) hydrated state.

### DETAILED DESCRIPTION

Photodynamic inhibition of microbial pathogens and/or insects that can infest plants can be achieved by applying a photosensitizer compound. The photosensitizer compound reacts to light by generating reactive oxygen species (ROS). The photosensitizer compound can also be used to increase resistance of plants to damage caused by one or more abiotic stress. While the ROS that are generated by the photosensitizers are reactive enough to help inhibit microbial pathogens and/or insects on plants, they are typically also reactive enough to degrade the photosensitizer compound. As such, there is a need to stabilize the photosensitizer compounds so that they are stable enough to be applied to the plant and generate ROS for a sufficient time to effectively promote the health of the plant.

The present description provides film-forming combinations and compositions for application to a plant, that includes a photosensitizer that generates reactive oxygen species in the presence of light and oxygen, a film-forming agent, and an aqueous carrier. The film-forming composition can also include an antioxidant agent. The photosensitizer is selected from the group consisting of a porphyrin, a reduced porphyrin and a combination thereof. The film-forming agent can be a film-forming polymer, such as polyvinyl alcohol. The film-forming agent forms a film that is substantially impermeable to oxygen when at least a portion of the aqueous carrier is removed after application to the plant. The antioxidant agent can be a phenolic antioxidant. The photosensitizer, film-forming agent and antioxidant agent are solubilized and/or dispersed in the aqueous carrier. In an implementation, the photosensitizer compound is a porphyrin or a reduced porphyrin compound, such as a chlorin compound.

An exemplary porphyrin compound is protoporphyrin IX or a modified protoporphyrin IX or an agriculturally acceptable salt thereof. An exemplary chlorin compound is chlorophyllin, a modified chlorophyllin or an agriculturally acceptable salt thereof.

More detail about the photosensitizer, film-forming agent and the other components of the film-forming composition as well as the methods of preparing such compositions are provided in the present description.

### Definitions

Unless stated otherwise, the following terms and phrases as used herein are intended to have the following meanings.

When trade names are used herein, it is intended to independently include the tradename product and the active ingredient(s) of the tradename product.

As used herein, the phrase “a compound of Formula I” means a compound of Formula I or an agriculturally acceptable salt thereof. With respect to isolatable intermediates, the phrase “a compound of Formula (number)” means a compound of that formula and salts thereof, and optionally agriculturally acceptable salts thereof.

The term “Alkyl”, as used herein, means a hydrocarbon containing primary, secondary, tertiary or cyclic carbon atoms. For example, and without being limiting, an alkyl group can have 1 to 20 carbon atoms (i.e, C₁-C₂₀ alkyl), 1 to 8 carbon atoms (i.e., C₁-C₈ alkyl), 1 to 6 carbon atoms (i.e., C₁-C₆ alkyl) or 1 to 4 carbon atoms (i.e., C₁-C₄ alkyl). Examples of suitable alkyl groups include, but are not limited to, methyl (Me, —CH₃), ethyl (Et, —CH₂CH₃), 1-propyl (n-Pr, n-propyl, —CH₂CH₂CH₃), 2-propyl (i-Pr, i-propyl, —CH(CH₃)₂), 1-butyl (n-Bu, n-butyl, —CH₂CH₂CH₂CH₃), 2-methyl-1-propyl (i-Bu, i-butyl, —CH₂CH(CH₃)₂), 2-butyl (s-Bu, s-butyl, —CH(CH₃)CH₂CH₃), 2-methyl-2-propyl (t-Bu, t-butyl, —C(CH₃)₃), 1-pentyl (n-pentyl, —CH₂CH₂CH₂CH₂CH₃), 2-pentyl (—CH(CH₃)CH₂CH₂CH₃), 3-pentyl (—CH(CH₂CH₃)₂), 2-methyl-2-butyl (—C(CH₃)₂CH₂CH₃), 3-methyl-2-butyl (—CH(CH₃)CH(CH₃)₂), 3-methyl-1-butyl (—CH₂CH₂CH(CH₃)₂), 2-methyl-1-butyl (—CH₂CH(CH₃)CH₂CH₃), 1-hexyl (—CH₂CH₂CH₂CH₂CH₂CH₃), 2-hexyl (—CH(CH₃)CH₂CH₂CH₂CH₃), 3-hexyl (—CH(CH₂CH₃)(CH₂CH₂CH₃)), 2-methyl-2-pentyl (—C(CH₃)₂CH₂CH₂CH₃), 3-methyl-2-pentyl (—CH(CH₃)CH(CH₃)CH₂CH₃), 4-methyl-2-pentyl (—CH(CH₃)CH₂CH(CH₃)₂), 3-methyl-3-pentyl (—C(CH₃)(CH₂CH₃)₂), 2-methyl-3-pentyl (—CH(CH₂CH₃)CH(CH₃)₂), 2,3-dimethyl-2-butyl (—C(CH₃)₂CH(CH₃)₂), 3,3-dimethyl-2-butyl (—CH(CH₃)C(CH₃)₃, and octyl (—(CH₂)₇CH₃).

The term “Alkenyl”, as used herein, means a hydrocarbon containing primary, secondary, tertiary or cyclic carbon atoms with at least one site of unsaturation, i.e. a carbon-carbon sp² double bond. For example, and without being limiting, an alkenyl group can have 2 to 20 carbon atoms (i.e., C₂-C₂₀ alkenyl), 2 to 8 carbon atoms (i.e., C₂-C₈ alkenyl), 2 to 6 carbon atoms (i.e., C₂-C₆ alkenyl) or 2 to 4 carbon atoms (i.e., C₂-C₄ alkenyl). Examples of suitable alkenyl groups include, but are not limited to, ethylene or vinyl (—CH═CH₂), allyl (—CH₂CH═CH₂), cyclopentenyl (—C₅H₇), and 5-hexenyl (—CH₂CH₂CH₂CH₂CH═CH₂).

The term “Alkynyl”, as used herein, means a hydrocarbon containing primary, secondary, tertiary or cyclic carbon atoms with at least one site of unsaturation, i.e. a carbon-carbon, sp triple bond. For example, and without being limiting, an alkynyl group can have 2 to 20 carbon atoms (i.e., C₂-C₂₀ alkynyl), 2 to 8 carbon atoms (i.e., C₂—C alkynyl), 2 to 6 carbon atoms (i.e., C₂-C₆ alkynyl) or 2 to 4 carbon atoms (i.e., C₂-C₄ alkynyl). Examples of suitable alkynyl groups include, but are not limited to, acetylenic (—C═CH) and propargyl (—CH₂C═CH).

The term “Alkoxy”, as used herein, is interchangeable with the term “O(Alkyl)”, in which an “Alkyl” group as defined above is attached to the parent molecule via an oxygen atom. For example, and without being limiting, the alkyl portion of an O(Alkyl) group can have 1 to 20 carbon atoms (i.e, C₁-C₂₀ alkyl), 1 to 8 carbon atoms (i.e., C₁-C₅ alkyl), 1 to 6 carbon atoms (i.e., C₁-C₆ alkyl) or 1 to 4 carbon atoms (i.e., C₁-C₄ alkyl). Examples of suitable Alkoxy or O(Alkyl) groups include, but are not limited to, methoxy (—OCH₃ or —OMe), ethoxy (—OCH₂CH₃ or —OEt) and t-butoxy (—O—C(CH₃)₃ or —OtBu). Similarly, “O(alkenyl)”, “O(alkynyl)” and the corresponding substituted groups will be understood by a person skilled in the art.

The term “Acyl”, as used herein, is meant to encompass several functional moieties such as “C═O(Alkyl)”, “C═O(Alkenyl)”, “C═O(Alkynyl)” and their corresponding substituted groups, in which an “Alkyl”, “Alkenyl” and “Alkynyl” groups are as defined above and attached to an O, N, S of a parent molecule via a C═O group. For example, and without being limiting, the alkyl portion of a C═O(Alkyl) group can have 1 to 20 carbon atoms (i.e, C₁-C₂₀ alkyl), 1 to 8 carbon atoms (i.e., C₁-C₈ alkyl), 1 to 6 carbon atoms (i.e., C₁-C₆ alkyl) or 1 to 4 carbon atoms (i.e., C₁-C₄ alkyl). Examples of suitable Acyl groups include, but are not limited to, formyl (i.e., a carboxyaldehyde group), acetyl, trifluoroacetyl, propionyl, and butanoyl. A person skilled in the art will understand that a corresponding definition applies for “C═O(Alkenyl)” and “C═O(Alkynyl)” moieties. In the present description, “C═O(Alkyl)”, “C═O(Alkenyl)”, “C═O(Alkynyl)” can also be written as “CO(Alkyl)”, “CO(Alkenyl) and “CO(Alkynyl)”, respectively.

The term “Alkylene”, as used herein, means a saturated, branched or straight chain or cyclic hydrocarbon radical having two monovalent radical centers derived by the removal of two hydrogen atoms from the same or two different carbon atoms of a parent alkane. For example, and without being limiting, an alkylene group can have 1 to 20 carbon atoms, 1 to 10 carbon atoms, 1 to 6 carbon atoms or 1 to 4 carbon atoms. Typical alkylene radicals include, but are not limited to, methylene (—CH₂—), 1,1-ethyl (—CH(CH₃)—), 1,2-ethyl (—CH₂CH₂—), 1,1-propyl (—CH(CH₂CH₃)—), 1,2-propyl (—CH₂CH(CH₃)—), 1,3-propyl (—CH₂CH₂CH₂—) and 1,4-butyl (—CH₂CH₂CH₂CH₂—).

The term “Alkenylene”, as used herein, means an unsaturated, branched or straight chain or cyclic hydrocarbon radical having two monovalent radical centers derived by the removal of two hydrogen atoms from the same or two different carbon atoms of a parent alkene. For example, and without being limiting, and alkenylene group can have 1 to 20 carbon atoms, 1 to 10 carbon atoms, 1 to 6 carbon atoms or 1 to 4 carbon atoms. Typical alkenylene radicals include, but are not limited to, 1,2-ethylene (—CH═CH—).

The term “Alkynylene”, as used herein, means an unsaturated, branched or straight chain or cyclic hydrocarbon radical having two monovalent radical centers derived by the removal of two hydrogen atoms from the same or two different carbon atoms of a parent alkyne. For example, and without being limiting, an alkynylene group can have 2 to 20 carbon atoms, 2 to 10 carbon atoms, 2 to 6 carbon atoms or 2 to 4 carbon atoms. Typical alkynylene radicals include, but are not limited to, acetylene (—C≡C—), propargyl (—CH₂C≡C—), and 4-pentynyl (—CH₂CH₂CH₂C≡C—).

The term “Aryl”, as used herein, means an aromatic hydrocarbon radical derived by the removal of one hydrogen atom from a single carbon atom of a parent aromatic ring system. For example, and without being limiting, an aryl group can have 6 to 20 carbon atoms, 6 to 14 carbon atoms, or 6 to 10 carbon atoms. Typical aryl groups include, but are not limited to, radicals derived from benzene (e.g., phenyl), substituted benzene, naphthalene, anthracene and biphenyl.

The term “Arylalkyl”, as used herein, means an acyclic alkyl radical in which one of the hydrogen atoms bonded to a carbon atom, typically a terminal or sp³ carbon atom, is replaced with an aryl radical. Typical arylalkyl groups include, but are not limited to, benzyl, 2-phenylethan-1-yl, naphthylmethyl, 2-naphthylethan-1-yl, naphthobenzyl, 2-naphthophenylethan-1-yl and the like. For example, and without being limiting, the arylalkyl group can include 7 to 20 carbon atoms, e.g., the alkyl moiety is 1 to 6 carbon atoms and the aryl moiety is 6 to 14 carbon atoms.

The term “Arylalkenyl”, as used herein, means an acyclic alkenyl radical in which one of the hydrogen atoms bonded to a carbon atom, typically a terminal or sp³ carbon atom, but also an sp² carbon atom, is replaced with an aryl radical. The aryl portion of the arylalkenyl can include, for example, any of the aryl groups described herein, and the alkenyl portion of the arylalkenyl can include, for example, any of the alkenyl groups described herein. The arylalkenyl group can include 8 to 20 carbon atoms, e.g., the alkenyl moiety is 2 to 6 carbon atoms and the aryl moiety is 6 to 14 carbon atoms.

The term “Arylalkynyl”, as used herein, means an acyclic alkynyl radical in which one of the hydrogen atoms bonded to a carbon atom, typically a terminal or sp³ carbon atom, but also an sp carbon atom, is replaced with an aryl radical. The aryl portion of the arylalkynyl can include, for example, any of the aryl groups disclosed herein, and the alkynyl portion of the arylalkynyl can include, for example, any of the alkynyl groups disclosed herein. For example, and without being limiting, the arylalkynyl group can include 8 to 20 carbon atoms, e.g., the alkynyl moiety is 2 to 6 carbon atoms and the aryl moiety is 6 to 14 carbon atoms.

The term “heterocycle”, as used herein, means a group including a covalently closed ring wherein at least one atom forming the ring is a heteroatom. For example, and without being limiting, heterocyclic rings can be formed by three, four, five, six, seven, eight, nine, or more than nine atoms. Any number of those atoms can be heteroatoms (i.e., a heterocyclic ring can include one, two, three, four, five, six, seven, eight, nine, or more than nine heteroatoms). In heterocyclic rings including two or more heteroatoms, those two or more heteroatoms can be the same or different from one another. Heterocycles can be substituted. Binding to a heterocycle can be at a heteroatom or via a carbon atom. It should also be understood that in the present description, the term “heterocycle” also encompasses “heteroaryl” groups.

The term “protecting group”, as used herein, means a moiety of a compound that masks or alters the properties of a functional group or the properties of the compound as a whole. The chemical substructure of a protecting group can greatly vary. One function of a protecting group is to serve as an intermediate in the synthesis of the parental active substance. Chemical protecting groups and strategies for protection/deprotection are well known in the art. See: “Protective Groups in Organic Chemistry”, Theodora W. Greene (John Wiley & Sons, Inc., New York, 1991).

The term “substituted”, as used herein in reference to alkyl, alkylene, alkoxy, alkenyl, alkynyl, alkenylene, aryl, alkynylene, etc., for example “substituted alkyl”, “substituted alkylene”, “substituted alkoxy”-“or substituted O(Alkyl)”, “substituted alkenyl”, “substituted alkynyl”, “substituted alkenylene”, “substituted aryl” and “substituted alkynylene”, unless otherwise indicated, means alkyl, alkylene, alkoxy, alkenyl, alkynyl, alkenylene, aryl and alkynylene, respectively, in which one or more hydrogen atoms are each independently replaced with a non-hydrogen substituent.

Typical non-hydrogen substituents include, but are not limited to, —X, —R^{B}, —O⁻, ═O, —OR^{B}, —SR^{B}, —S⁻, —NR^{B}₂, Si(R^{C})₃, —N⁺R^{B}₃, —NR^{b}-(Alk)-NR^{B}₂, —NR^{B}-(Alk)-N⁺R^{B}₃, —NR^{B}-(Alk)-OR^{B}, —NR^{B}-(Alk)-OP(═O)(OR^{B})(O⁻), —NR^{B}-(Alk)-OP(═O)(OR^{B})₂, —NR^{B}-(Alk)-Si(R^{C})₃, —NR^{B}-(Alk)-SR^{B}, —O-(Alk)-NR^{B}₂, —O-(Alk)-N⁺R^{B}₃, —O-(Alk)-OR^{B}, —O-(Alk)-OP(═O)(OR^{B})(O⁻), —O-(Alk)-OP(═O)(OR^{B})₂, —O-(Alk)-Si(R^{C})₃, —O-(Alk)-SR^{B}, ═NR^{B}, —CX₃, —CN, —OCN, —SCN, —N═C═O, —NCS, —NO, —NO₂, ═N₂, —N₃, —NHC(═O)R^{B}, —OC(═O)R^{B}, —NHC(═O)NR^{B}₂, —S(═O)₂—, —S(═O)₂OH, —S(═O)₂R^{B}, —OS(═O)₂OR^{B}, —S(═O)₂NR^{B}₂, —S(═O)R^{B}, —OP(═O)(OR^{B})(O⁻), —OP(═O)(OR^{B})₂, —P(═O)(OR^{B})₂, —P(═O)(O⁻)₂, —P(═O)(OH)₂, —P(O)(OR^{B})(O⁻), —C(═O)R^{B}, —C(═O)X, —C(S)R^{B}, —C(O)OR^{B}, —C(O)O⁻, —C(S)OR^{B}, —C(O)SR^{B}, —(S)SR^{B}, —C(O)NR^{B}₂, —C(S)NR^{B}₂ or —C(═NR^{B})NR^{B}₂ where each X is independently a halogen: F, Cl, Br, or I; each R^{B} is independently H, alkyl, aryl, arylalkyl, a heterocycle, an alkyloxy group such as poly(ethyleneoxy), PEG or poly(methyleneoxy), or a protecting group; each R^{C} is independently alkyl, O(alkyl) or O(tri-substituted silyl); and each Alk is independently alkylene, substituted alkylene, alkenylene, substituted alkenylene, alkynylene or substituted alkynylene. Unless otherwise indicated, when the term “substituted” is used in conjunction with groups such as arylalkyl, which have two or more moieties capable of substitution, the substituents can be attached to the aryl moiety, the alkyl moiety, or both.

Is should also be understood that the term “tri-substituted silyl” refers to a silyl group that is independently substituted with three functional groups selected from alkyl, alkenyl, alkynyl, aryl and arylalkyl. Non-limiting examples of tri-substituted silyl groups include trimethylsilyl and dimethylphenylsilyl.

The term “PEG” or “poly(ethylene glycol)”, as used herein, is meant to encompass any water-soluble poly(ethylene oxide). Typically, substantially all, or all monomeric subunits are ethylene oxide subunits, though the PEG can contain distinct end capping moieties or functional groups. PEG chains of the present description can include one of the following structures: —(CH₂CH₂O)ₘ or —(CH₂CH₂O)ₘ₋₁CH₂CH₂—, depending on if the terminal oxygen has been displaced, where m is an integer, optionally selected from 1 to 100, 1 to 50, 1 to 30, 5 to 30, 5 to 20 or 5 to 15. The PEG can be capped with an “end capping group” that is generally a non-reactive carbon-containing group attached to a terminal oxygen or other terminal atom of the PEG. Non-limiting examples of end capping groups can include alkyl, substituted alkyl, aryl, substituted aryl, alkenyl, substituted alkenyl, alkynyl, substituted alkynyl, CO(alkyl), CO(substituted alkyl), CO(alkenyl), CO(substituted alkenyl), CO(alkynyl) or CO(substituted alkynyl).

A person skilled in the art will recognize that substituents and other moieties of the compounds of the present description should be selected in order to provide an agriculturally useful compound which can be formulated into an acceptably stable agricultural composition that can be applied to plants. The definitions and substituents for various genus and subgenus of the compounds of the present description are described and illustrated herein. It should be understood by a person skilled in the art that any combination of the definitions and substituents described herein should not result in an inoperable species or compound. It should also be understood that the phrase “inoperable species or compound” means compound structures that violate relevant scientific principles (such as, for example, a carbon atom connecting to more than four covalent bonds) or compounds too unstable to permit isolation and formulation into agriculturally acceptable compositions.

Selected substituents of the compounds of the present description can be present to a recursive degree. In this context, “recursive substituent” means that a substituent may recite another instance of itself. Because of the recursive nature of such substituents, theoretically, a large number of compounds can be present in any given implementation. For example, R^{x} includes a R^{y} substituent. R^{y} can be R. R can be W³. W³ can be W⁴ and W⁴ can be R or include substituents including R^{y}. A person skilled in the art of organic chemistry understands that the total number of such substituents is to be reasonably limited by the desired properties of the compound intended. Such properties include, by way of example and not limitation, physical properties such as molecular weight, solubility or log P, application properties such as activity against the intended target, possibility of application to plants, and practical properties such as ease of synthesis. Typically, each recursive substituent can independently occur 20, 19, 18, 17, 16, 15, 14, 13, 12, 11, 10, 9, 8, 7, 6, 5, 4, 3, 2, 1, or 0, times in a given implementation. For example, each recursive substituent can independently occur 3 or fewer times in a given embodiment. Recursive substituents are an intended aspect of the compounds of the present description. A person skilled in the art of organic chemistry understands the versatility of such substituents.

The term “agriculturally acceptable salt”, as used herein, refers to salts that exhibit pesticidal activity (i.e., that are active against one or more biotic stress) or that can improve resistance of a plant to one or more abiotic stress. The term also refers to salts that are or can be converted in plants, water or soil to a compound or salt that exhibits pesticidal activity or that can improve resistance of a plant to one or more abiotic stress. The “agriculturally acceptable salt” can be an agriculturally acceptable cation or agriculturally acceptable anion. Non-limiting examples of agriculturally acceptable cations can include cations derived from alkali or alkaline earth metals and cations derived from ammonia and amines. For example, agriculturally acceptable cations can include sodium, potassium, magnesium, alkylammonium and ammonium cations. Non-limiting examples of agriculturally acceptable anions can include halide, phosphate, alkylsulfate and carboxylate anions. For example, agriculturally acceptable anions can include chloride, bromide, methylsulfate, ethylsulfate, acetate, lactate, dimethyl phosphate or polyalkoxylated phosphate anions.

The term “optionally substituted”, as used herein in reference to a particular moiety of the compounds of the present description, means a moiety wherein all substituents are hydrogen or wherein one or more of the hydrogens of the moiety can be replaced by substituents such as those listed under the definition of the term “substituted” or as otherwise indicated.

It will be understood that all enantiomers, diastereomers, and racemic mixtures, tautomers, polymorphs, and pseudopolymorphs of compounds within the scope of the formulae and compositions described herein and their agriculturally acceptable salts thereof, are embraced by the present description. All mixtures of such enantiomers and diastereomers are also within the scope of the present description.

A compound of the present description and its agriculturally acceptable salts may exist as different polymorphs or pseudopolymorphs. As used herein, crystalline polymorphism means the ability of a crystalline compound to exist in different crystal structures. The crystalline polymorphism may result from differences in crystal packing (packing polymorphism) or differences in packing between different conformers of the same molecule (conformational polymorphism). As used herein, crystalline pseudopolymorphism means the ability of a hydrate or solvate of a compound to exist in different crystal structures. Pseudopolymorphs of the compounds of the present description may exist due to differences in crystal packing (packing pseudopolymorphism) or due to differences in packing between different conformers of the same molecule (conformational pseudopolymorphism). The description and depiction of the compounds of the present description is intended to include all polymorphs and pseudopolymorphs of the compounds and their agriculturally acceptable salts.

A compound of the present description and its agriculturally acceptable salts may also exist as an amorphous solid. As used herein, an amorphous solid is a solid in which there is no long-range order of the positions of the atoms in the solid. The description and depiction of the compounds of the present description is intended to include all amorphous forms of the compounds and their agriculturally acceptable salts.

The modifier “about” used in connection with a quantity is inclusive of the stated value and has the meaning dictated by the context. For example, the modifier “about” can include the degree of error associated with the measurement of the quantity.

For agricultural use (i.e., for application to plants), salts of the compounds of the present description are agriculturally acceptable salts. However, salts which are not agriculturally acceptable can also find use, for example, in the preparation or purification of an agriculturally acceptable compound. All salts, whether or not they are agriculturally acceptable salts, are therefore to be understood as within the scope of the present description.

It will be understood that the compounds described herein can be in their un-ionized, ionized, as well as zwitterionic form, and in combinations with various amounts of water (e.g., stoichiometric amounts of water) such as in hydrates.

Whenever a compound described herein is substituted with more than one of the same designated group, e.g., “R¹” or “R²”, then it will be understood that the groups may be the same or different, i.e., each group is independently selected. For example, in the expression “Si(OR⁷)₃ with each R⁷ being independently alkyl or aryl”, it is understood that each R⁷ can independently be selected from alkyl groups and aryl groups. Si(OR⁷)₃ therefore includes both symmetrical groups where all three R⁷ are the same and asymmetrical groups where at least one R⁷ group is different from the other two R⁷ groups, or where each R⁷ group is different. It is also understood that this applies to all R^{q} or Z^{q} groups defined herein (e.g., q being selected from 1 to 17, from a to f or from A to C). A group “Z¹” will be understood to be necessarily the same as another group “Z²” only when it is explicitly stated that “Z¹=Z²”.

The compounds described herein can also exist as tautomeric forms in certain cases. Although only one delocalized resonance structure will typically be depicted, all such forms are contemplated within the scope of the present description. For example, various tautomers can exist for the tetrapyrole ring systems described herein, and all their possible tautomeric forms are within the scope of the present description.

The term “growing medium”, as used herein, refers to any soil (of any composition) or soil-free (e.g., hydroponic) medium that is suitable for growing and cultivating a plant. The growing medium can further include any naturally occurring and/or synthetic substance(s) that are suitable for growing and cultivating the plant. The phrase “any surface of the growing medium” or “a surface of the growing medium”, as used herein, refers to a surface that is directly exposed to natural and/or simulated light and/or weather.

The term “applying”, as used herein, refers to contacting a surface of the plant or a surface of the growing medium with at least one combination or composition of the present description, by any means known in the art (e.g., pouring, root bathing, soil drenching, drip irrigation, etc.), or contacting an area that is beneath the surface of the growing medium with at least one combination or composition of the present description (e.g., by soil injection), or any combination thereof, or directly contacting the plant with at least one combination or composition of the present description (e.g., spraying).

The term “crop plant”, as used herein, refers to a non-woody plant, which is grown, tended to, and harvested in a cycle of one year or less as source of foodstuffs and/or energy. Non-limiting examples of crop plants include sugar cane, wheat, rice, corn (maize), potatoes, sugar beets, barley, sweet potatoes, cassava, soybeans, tomatoes, and legumes (beans and peas).

The term “woody plant”, as used herein, refers to a woody perennial plant having a single stem or trunk, and bearing lateral branches at some distance from the ground (e.g., a tree). The woody plant can be a deciduous tree, an evergreen tree (e.g., a coniferous) or a shrub. Non-limiting examples of woody plants include maple trees, citrus trees, apple trees, pear trees, oak trees, ash trees, pine trees, and spruce trees.

The term “turf grass”, as used herein, refers to a cultivated grass that provides groundcover, for example a turf or lawn that is periodically cut or mowed to maintain a consistent height. Grasses belong to the Poaceae family, which is subdivided into six subfamilies, three of which include common turf grasses: the Festucoideae subfamily of cool-season turf grasses; and the Panicoideae and Eragrostoideae subfamiles of warm-season turf grasses. A limited number of species are in widespread use as turf grasses, generally meeting the criteria of forming uniform soil coverage and tolerating mowing and traffic. In general, turf grasses have a compressed crown that facilitates mowing without cutting off the growing point. In the present context, the term “turf grass” includes areas in which one or more grass species are cultivated to form relatively uniform soil coverage, including blends that are a combination of different cultivars of the same species, or mixtures that are a combination of different species and/or cultivars.

Non-limiting examples of turf grasses include: bluegrasses (e.g., Kentucky bluegrass), bentgrasses (e.g., creeping bentgrass), Redtop, fescues (e.g., red fescue), ryegrasses (e.g., annual ryegrass), wheatgrasses (e.g., crested wheatgrass), beachgrass, Brome grasses (e.g., Arizona Brome), cattails (e.g., sand cattail), Alkaligrass (Puccinellia distans), crested dog's-tail (Cynosurus cristatus), bermudagrass (Cynodon spp. such as Cynodon dactylon), hybrid bermudagrass (e.g., tifdwarf bermudagrass), Zoysiagrasses (e.g., Zoysia japonica), St. Augustinegrass (e.g., Bitter Blue St. Augustinegrass), Centipedegrass (Eremochloa ophiuroides), Carpetgrass (Axonopus fissifolius), Bahiagrass (Paspalum notatum), Kikuyugrass (Pennisetum clandestinum), Buffalograss (Buchloe dactyloids), Seashore paspalum (Paspalum vaginatum), Blue Grama (Bouteloua gracilis), Black Grama (Bouteloua eriopoda), Sideoats Grama (Bouteloua curtipendula), Sporobolus spp. (e.g., Alkali Sacaton), Sand Dropseed (Sporobolus cryptandrus), Prairie Dropseed (Sporobolus heterolepis), Hordeum spp. (e.g., California Barley), Common Barley, Meadow Barley, Alopecurus spp. (e.g., Creeping Foxtail and Meadow Foxtail), Stipa spp. (e.g., Needle & Thread), Elymus spp. (e.g., Blue Wildrye), Buffelgrass (Cenchrus ciliaris), Big Quaking Grass (Briza maxima), Big Bluestem (Andropogon gerardii), Little Bluestem (Schizachyruim scoparium, Sand Bluestem (Andropogon hallii), Deergrass (Muhlenbergia rigens), Eastern Gamagrass (Tripsacum dactyloides), Galleta (Hilaria jamesii), Tufted Hairgrass (Deschampsia caespitosa), Indian Rice Grass (Oryzopsis hymenoides), Indian Grass (Sorghastrum nutans), Sand Lovegrass (Eragrostis trichodes); Weeping Lovegrass (Eragrostis curvula), California Melic (Melica californica), Prairie Junegrass (Koeleria pyramidata), Prairie Sandreed (Calamovilfa longifolia), Redtop (Agrostis alba), Reed Canarygrass (Phalaris arundinacea), Sloughgrass (Spartina pectinata), Green Sprangletop (Leptochloa dubia), Bottlebush Squirreltail (Sitanion hystrix), Panicum Switchgrass (virgatum), and Purple Threeawn (Aristida purpurea).

The phrase “promoting the health of a plant”, as used herein, includes at least one of controlling a disease, condition, or injury caused by a pest of a plant and increasing abiotic stress resistance or tolerance in a plant. In other words, the phrase “promoting the health of a plant” includes at least one of “controlling infection of a plant by one or more biotic agent”, “controlling infestation of a plant by one or more insect” and “increasing resistance of a plant to one or more abiotic stress”.

The phrase “controlling infection of a plant by a biotic agent”, as used herein, means to diminish, ameliorate, or stabilize the infection and/or any other existing unwanted condition or side effect that is caused by the association of a microbial pathogen or infestation of an insect on the plant. The microbial pathogen can include fungi, bacteria (gram positive or gram negative), viruses, viroids, virus-like organisms, phytoplasma, etc.

The term “abiotic stress”, as used herein, refers to environmental conditions that negatively impact growth, development, yield and yield quality of crop and other plants. below optimum levels. Non-limiting examples of abiotic stresses include, for example: photooxidative conditions, drought (water deficit), excessive watering (flooding, and submergence), extreme temperatures (chilling, freezing and heat), extreme levels of light (high and low), radiation (UV-B and UV-A), salinity due to excessive Na⁺ (sodicity), chemical factors (e.g., pH), mineral (metal and metalloid) toxicity, deficiency or excess of essential nutrients, gaseous pollutants (ozone, sulfur dioxide), wind, mechanical factors, and other stressors.

As used herein, the term “increasing stress resistance” (and the like) refers to an increase in the ability of a plant to survive or thrive in stress conditions. Enhanced resistance or tolerance can be specific for a particular stressor, e.g., drought, excess water, nutrient deficiency, salt, cold, shade or heat, or multiple stressors. In some scenarios, increased resistance to one or more abiotic stresses can be exemplified by the reduction in degradation of quality of the plant, as compared to an untreated plant subjected to the same stress. In other scenarios, increased resistance to one or more abiotic stress can be exemplified by maintained or improved plant quality, as compared to an untreated plant subjected to the same stress.

### Photosensitizer Compounds

The compositions of the present description include photosensitizer compounds that can enable photodynamic inhibition of biotic agents (i.e., microbial pathogens and/or insects) that can be present on a plant and/or that can protect the plant from abiotic stresses. The photosensitizer compounds react to light by generating reactive oxygen species (ROS).

Depending on the type of ROS generated, photosensitizers can be classified into two classes, namely Type I photosensitizers and Type II photosensitizers. On the one hand, Type I photosensitizers form short lived free radicals through electron abstraction or transfer from a substrate when excited at an appropriate wavelength in the presence of oxygen. On the other hand, Type II photosensitizers form a highly reactive oxygen state known as “singlet oxygen”, also referred to herein as “reactive singlet oxygen species”. Singlet oxygens are generally relatively long lived and can have a large radius of action.

It should be understood that the photosensitizer compound can be metallated or non-metallated. When metallated, as can be the case for various nitrogen-bearing macrocyclic compounds that are complexed with a metal, the metal can be selected to generate either a Type I or a Type II photosensitizer in response to light exposure. For example, when chlorin-type compounds are metallated with copper, the ROS that are generated are typically Type I photosensitizers. When the same chlorin-type compounds are metallated with magnesium, the ROS that are generated are typically Type II photosensitizers. Both Type I and Type II photosensitizers can be used to enable photodynamic inhibition of biotic agents that are present on plants or to protect a plant from abiotic stress. In some scenarios, the photosensitizer compound is a Type I photosensitizer. In other scenarios, the photosensitizer compound is a Type II photosensitizer.

It should be understood that the term “singlet oxygen photosensitizer”, as used herein, refers to a compound that produces reactive singlet oxygen species when excited by light. In other words, the term “singlet oxygen photosensitizer” refers to a photosensitizer in which the Type II process defined above is dominant compared to the Type I process.

In some implementations, the photosensitizer compound is a photosensitive nitrogen-bearing macrocyclic compound that can include four nitrogen-bearing heterocyclic rings linked together. In some implementations, the nitrogen-bearing heterocyclic rings are selected from the group consisting of pyrroles and pyrrolines, and are linked together by methine groups (i.e., ═CH— groups) to form tetrapyrroles. The nitrogen-bearing macrocyclic compound can for example include a porphyrin compound (four pyrrole groups linked together by methine groups), a chlorin compound (three pyrrole groups and one pyrroline group linked together by methine groups), a bacteriochlorin compound or an isobacteriochlorin compound (two pyrrole groups and two pyrroline groups linked together by methine groups), or porphyrinoids (such as texaphrins or subporphyrins), or a functional equivalent thereof having a heterocyclic aromatic ring core or a partially aromatic ring core (i.e., a ring core which is not aromatic through the entire circumference of the ring), or again multi-pyrrole compounds (such as boron-dipyrromethene). It should also be understood that the term “nitrogen-bearing macrocyclic compound” can be one of the compounds listed herein or can be a combination of the compounds listed herein. The nitrogen-bearing macrocyclic compound can therefore include a porphyrin, a reduced porphyin, or a mixture thereof. Such nitrogen-bearing macrocyclic compounds can also be referred to as “multi-pyrrole macrocyclic compounds” (e.g., tetra-pyrrole macrocyclic compounds).

It should be understood that the term “reduced porphyrin” as used herein, refers to the group consisting of chlorin, bacteriochlorin, isobacteriochlorin and other types of reduced porphyrins such as corrin and corphin.

It should be understood that the nitrogen-bearing macrocyclic compound can be a non-metal macrocycle (e.g., chlorin e6, Protoporphyrin IX or Tetra PhenylPorphyrin) or a metal macrocyclic complex (e.g., a Mg-porphyrin, Mg-chlorophyllin, Cu-chlorophyllin, Fe-Protoporphyrin IX etc.). The nitrogen-bearing macrocyclic compound can be an extracted naturally occurring compound, or a synthetic compound.

In implementations where the porphyrin or the reduced porphyrin compound is metallated, the metal can be chosen such that the metallated nitrogen-bearing macrocyclic compound is a Type I photosensitizer or a Type II photosensitizer that generates reactive singlet oxygen species. For, example in the case of chlorins and porphyrins, non-limiting examples of metals that generally enable generation of reactive singlet oxygen species through the formation of a Type II photosensitizer are Mg, Zn, Pd, Sn, Al, Pt, Si, Ge, Ga and In. Similarly, non-limiting examples of metals that are known to form Type I photosensitizers when complexed with chlorins and/or porphyrins are Cu, Co, Fe, Ni and Mn.

It should be understood that when a metal species is mentioned without its degree of oxidation, all suitable oxidation states of the metal species are to be considered, as would be understood by a person skilled in the art. In other implementations, the metal species can be selected from the group consisting of Mg(II), Zn(II), Pd(II), Sn(IV), Al(III), Pt(II), Si(IV), Ge(IV), Ga(III) and In(III). In yet other implementations, the metal species can be selected from the group consisting of Cu(II), Co(II), Fe(II) and Mn(II). In yet other implementations, the metal species can be selected from the group consisting of Co(III), Fe(III), Fe(IV) and Mn(III).

It should also be understood that the specific metals that can lead to the formation of Type II photosensitizers versus metals that lead to the formation of Type I photosensitizers may vary depending on the type of nitrogen-bearing macrocyclic compound to which it is to be bound. It should also be understood that non-metallated nitrogen-bearing macrocyclic compounds can be Type I photosensitizers or Type II photosensitizers. For example, chlorin e6 and protoporphyrin IX are both Type II photosensitizers.

It should be understood that the nitrogen-bearing macrocyclic compound to be used in the methods and compositions of the present description can also be selected based on their toxicity to humans or based on their impact on the environment. For example, porphyrins and reduced porphyrins tend to have a lower toxicity to humans as well as enhanced environmental biodegradability properties when compared to other types of nitrogen-bearing macrocyclic compounds such as phthalocyanines.

The following formulae illustrate several non-limiting examples of nitrogen-bearing macrocyclic compounds that can be used in the methods and compositions described herein:

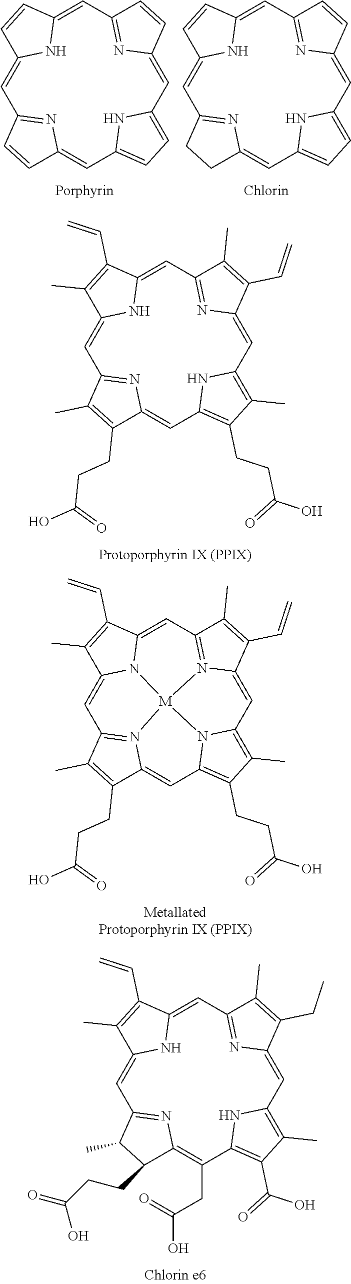

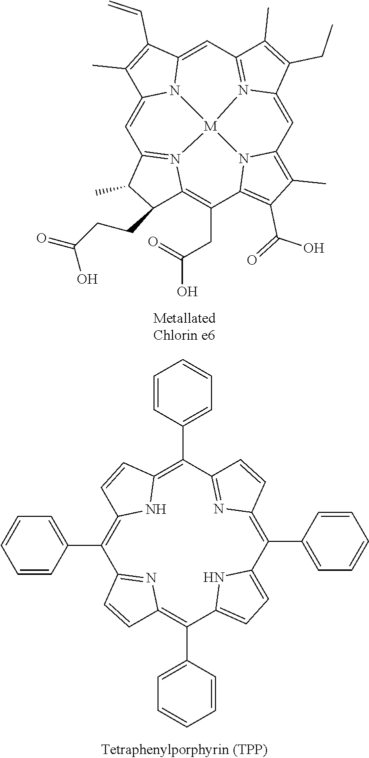

Various nitrogen-bearing macrocyclic compounds such as Zn-TPP and Mg-Chlorophyllin can be obtained from chemical suppliers such as Organic Herb Inc., Sigma Aldrich or Frontier Scientific. In some scenarios, the nitrogen-bearing macrocyclic compounds are not 100% pure and may include other components such as organic acids and carotenes. In other scenarios, the nitrogen-bearing macrocyclic compounds can have a high level of purity.

### Modified Ce6 Photosensitizers

One of the compounds mentioned above, chlorin e6 (Ce6), is a tetrapyrrole having a 20-carbon atom macrocyclic ring, each pyrrole being linked to two other pyrroles of the macrocyclic ring by a one-carbon bridge. In the depiction of Ce6 below, the carbons of the macrocyclic ring are numbered from 1 to 20. In the chemical structure of Ce6, three carboxylic acid-bearing groups are provided at the C13 (COOH), C15 (CH₂COOH) and C17 (CH₂CH₂COOH) positions.

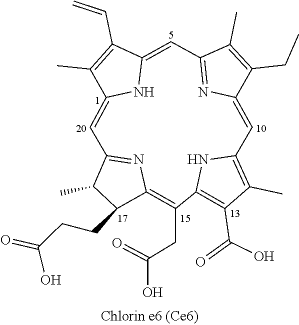 [SMILES: C=Cc1c(C)c2cc3nc(c(CC(=O)O)c4[nH]c(cc5nc(cc1[nH]2)C(C)=C5CC)c(C)c4C(=O)O)[C@@H](CCC(=O)O)[C@@H]3C]

The photosensitizer compounds of the present description can be based on the Ce6 scaffold above, where at least one of the C13, C15 and C17 carboxylic acids can be functionalized. The modified Ce6 compounds can be metallated or non-metallated. Examples of such modified Ce6, their activity and methods of manufacture are described in PCT patent application No. PCT/CA2020/050083 which is incorporated herein by reference in its entirety.

In some implementations, the modified Ce6 can be a compound of Formula I:

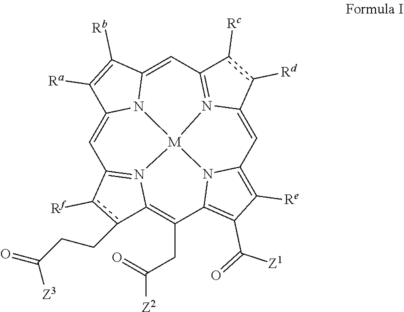

or an agriculturally acceptable salt thereof,
wherein:
each Z¹, Z² and Z³ is independently OR¹ or NR²R³;
each R¹, R² and R³ is independently H, alkyl, substituted alkyl, aryl, substituted aryl, alkenyl, substituted alkenyl, alkynyl, or substituted alkynyl, wherein if Z¹, Z² and Z³ are each OR¹ then at least one R¹ is not H and if Z¹, Z² and Z³ are each NR²R³ then at least one R³ is not H;
each R^{a}, R^{b}, R^{c}, R^{d}, R^{e} and R^{f} is, independently, H, alkyl, substituted alkyl, aryl, substituted aryl, alkenyl, substituted alkenyl, alkynyl or substituted alkynyl;
[symbol] is a single bond or a double bond;
[symbol] is a single bond or a double bond; and
M is 2H or a metal species,
wherein the substituted alkyl, substituted aryl, substituted alkenyl and substituted alkynyl groups are, independently, substituted with one or more —X, —R^{B}, —O⁻, ═O, —OR^{B}, —SR^{B}, —S⁻, —NR^{B}₂, Si(R^{C})₃, —N⁺R^{B}₃, —NR^{B}-(Alk)-NR^{B}₂, —NR^{B}-(Alk)-N⁺R^{B}₃, —NR^{B}-(Alk)-OR^{B}, —NR^{B}-(Alk)-OP(═O)(OR^{B})(O⁻), —NR^{B}-(Alk)-OP(═O)(OR^{B})₂, —NR^{B}-(Alk)-Si(R^{C})₃, —NR^{B}-(Alk)-SR^{B}, —O-(Alk)-NR^{B}₂, —O-(Alk)-N⁺R^{B}₃, —O-(Alk)-OR^{B}, —O-(Alk)-OP(═O)(OR^{B})(O⁻), —O-(Alk)-OP(═O)(OR^{B})₂, —O-(Alk)-Si(R^{C})₃, —O-(Alk)-SR^{B}, ═NR^{B}, —CX₃, —CN, —OCN, —SCN, —N═C═O, —NCS, —NO, —NO₂, ═N₂, —N₃, —NHC(═O)R^{B}, —OC(═O)R^{B}, —NHC(═O)NR^{B}₂, —S(═O)₂—, —S(═O)₂OH, —S(═O)₂R^{B}, —OS(═O)₂OR^{B}, —S(═O)₂NR^{B}₂, —S(═O)R^{B}, —OP(═O)(OR^{B})(O⁻), —OP(═O)(OR^{B})₂, —P(═O)(OR^{B})₂, —P(═O)(O⁻)₂, —P(═O)(OH)₂, —P(O)(OR^{B})(O⁻), —C(═O)R^{B}, —C(═O)X, —C(S)R^{B}, —C(O)OR^{B}, —C(O)O⁻, —C(S)OR^{B}, —C(O)SR^{B}, —C(S)SR^{B}, —C(O)NR^{B}₂, —C(S)NR^{B}₂ or —C(═NR^{B})NR^{B}₂;
each X is independently a halogen: F, Cl, Br or I;
each R^{B} is independently H, alkyl, aryl, arylalkyl, a heterocycle, an alkyloxy group such as poly(ethyleneoxy), PEG or poly(methyleneoxy), a capped poly(ethyleneoxy), capped PEG or capped polymethyleneoxy, or a protecting group;
the capped poly(ethyleneoxy), capped PEG and capped poly(methyleneoxy) groups being each independently capped with alkyl, aryl, arylalkyl, alkenyl, alkynyl, CO(alkyl), CO(aryl), CO(arylalkyl), CO(alkenyl) or CO(alkynyl);
each R^{C} is independently alkyl, aryl, arylalkyl, O(alkyl), O(aryl), O(arylalkyl), or O(tri-substituted silyl);
each tri-substituted silyl is independently substituted with three functional groups selected from alkyl, alkenyl, alkynyl, aryl and arylalkyl; and
each Alk is independently alkylene, alkenylene, or alkynylene.

In some implementations, the modified Ce6 can be a compound of Formula I:

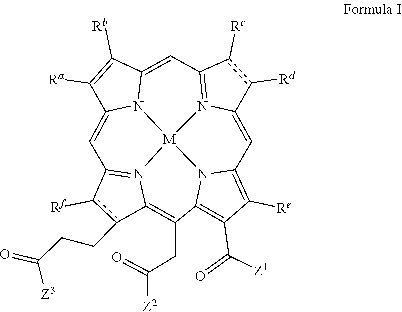

or an agriculturally acceptable salt thereof,
wherein:
Z¹ is OR¹;
one of Z² and Z³ is NR²R³, NR²—(CH₂)ₙ—NR⁴R⁵, NR²—(CH₂)ₙ—N⁺R⁴R⁵R⁶ Y⁻, NR²—(CH₂)ₙ—O(PO₃H)⁻ W⁺, NR²—(CH₂)ₙ—Si(R⁷)₃, NR²—(CH₂)ₙ—SR⁸, NR²—(CH₂)ₙ—NR⁴—(CH₂)ₚ—NR⁹R¹⁰, NR²—(CH₂)ₙ—NR⁴—(CH₂)ₚ—N⁺R⁹R¹⁰R¹¹ Y⁻, NR²—(CH₂)ₙ—NR⁴—(CH₂)ₚ—O(PO₃H)⁻ W⁺, NR²—(CH₂)ₙ—NR⁴—(CH₂)ₚ—Si(R⁷)₃, NR²—(CH₂)ₙ—NR⁴—(CH₂)ₚ—SR⁸, OR³, O(CH₂)ₙ—NR⁴R⁵, O(CH₂)ₙ—N⁺R⁴R⁵R⁶ Y⁻, O(CH₂)ₙ—O(PO₃H)⁻ W⁺, O(CH₂)ₙ—Si(R⁷)₃, O(CH₂)ₙ—SR⁸, O(CH₂)ₙ—NR⁴—(CH₂)ₚ—NR⁹R¹⁰, O(CH₂)ₙ—NR⁴—(CH₂)ₚ—N⁺R⁹R¹⁰R¹¹ Y⁻, O(CH₂)ₙ—NR⁴—(CH₂)ₚ—O(PO₃H)⁻ W⁺ or O(CH₂)ₙ—NR⁴—(CH₂)ₚ—Si(R⁷)₃; and
the other one of Z² and Z³ is OR¹²;
or
Z² is NR²R³, NR²—(CH₂)ₙ—NR⁴R⁵, NR²—(CH₂)ₙ—N⁺R⁴R⁵R⁶ Y⁻, NR²—(CH₂)ₙ—O(PO₃H)⁻ W⁺, NR²—(CH₂)ₙ—Si(R⁷)₃, NR²—(CH₂)ₙ—SR⁸, NR²—(CH₂)ₙ—NR⁴—(CH₂)ₚ—NR⁹R¹⁰, NR²—(CH₂)ₙ—NR⁴—(CH₂)ₚ—N⁺R⁹R¹⁰R¹¹ Y⁻, NR²—(CH₂)ₙ—NR⁴—(CH₂)ₚ—O(PO₃H)⁻ W⁺, NR²—(CH₂)ₙ—NR⁴—(CH₂)ₚ—Si(R⁷)₃, NR²—(CH₂)ₙ—NR⁴—(CH₂)ₚ—SR⁸, OR³, O(CH₂)ₙ—NR⁴R⁵, O(CH₂)ₙ—N⁺R⁴R⁵R⁶ Y⁻, O(CH₂)ₙ—O(PO₃H)⁻ W⁺, O(CH₂)ₙ—Si(R⁷)₃, O(CH₂)ₙ—SR⁸, O(CH₂)ₙ—NR⁴—(CH₂)ₚ—NR⁹R¹⁰, O(CH₂)ₙ—NR⁴—(CH₂)ₚ—N⁺R⁹R¹⁰R¹¹ Y⁻, O(CH₂)ₙ—NR⁴—(CH₂)ₚ—O(PO₃H)⁻ W⁺ or O(CH₂)ₙ—NR⁴—(CH₂)ₚ—Si(R⁷)₃; and
Z³═Z²;
each R¹, R², R⁴, R⁶, R⁸, R⁹, R¹⁰, R¹¹ and R¹² is, independently, H, alkyl, substituted alkyl, aryl, substituted aryl, alkenyl, substituted alkenyl, alkynyl, substituted alkynyl or —(CH₂)_{q}—(CH₂CH₂O)ₘ—R¹³;
each R³ and R⁵ is, independently, alkyl, substituted alkyl, aryl, substituted aryl, alkenyl, substituted alkenyl, alkynyl, substituted alkynyl or —(CH₂)_{q}—(CH₂CH₂O)ₘ—R¹³;
R⁷ is alkyl, O(alkyl) or O(tri-substituted silyl);
R¹³ is H, alkyl, substituted alkyl, aryl, substituted aryl, CO(alkyl) or CO(substituted alkyl), alkenyl, substituted alkenyl, CO(alkenyl) or CO(substituted alkenyl), alkynyl, substituted alkynyl, CO(alkynyl) or CO(substituted alkynyl);
W⁺ is an agriculturally acceptable cation;
Y⁻ is an agriculturally acceptable anion;
n is an integer selected from 1 to 16;
p is an integer selected from 1 to 16;
q is an integer selected from 0 to 16;
m is an integer selected from 1 to 100;
each R^{a}, R^{b}, R^{c}, R^{d}, R^{e} and R^{f} is, independently, H, alkyl, substituted alkyl, aryl, substituted aryl, alkenyl, substituted alkenyl, alkynyl or substituted alkynyl;
[symbol] is a single bond or a double bond;
[symbol] is a single bond or a double bond; and
M is 2H or a metal species,
wherein each substituted alkyl, substituted aryl, substituted alkenyl and substituted alkynyl groups are, independently, substituted with one or more F, Cl, Br, I, hydroxy, CN and N₃.

In some implementations, the modified Ce6 can be a compound of Formula I:

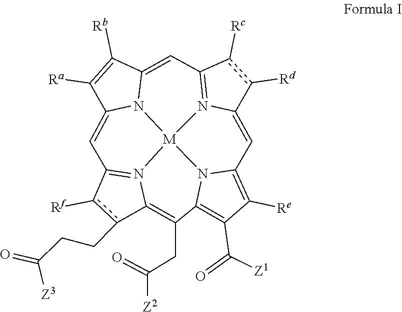

or an agriculturally acceptable salt thereof,
wherein:
Z¹ is OR¹;
one of Z² and Z³ is NR²R³, NR²—(CH₂)ₙ—NR⁴R⁵, NR²—(CH₂)ₙ—N⁺R⁴R⁵R⁶ Y⁻, NR²—(CH₂)ₙ—O(PO₃H)⁻ W⁺, NR²—(CH₂)ₙ—Si(R⁷)₃, NR²—(CH₂)ₙ—SR⁸, NR²—(CH₂)ₙ—NR⁴—(CH₂)ₚ—NR⁹R¹⁰, NR²—(CH₂)ₙ—NR⁴—(CH₂)ₚ—N⁺R⁹R¹⁰R¹¹ Y⁻, NR²—(CH₂)ₙ—NR⁴—(CH₂)ₚ—O(PO₃H)⁻ W⁺, NR²—(CH₂)ₙ—NR⁴—(CH₂)ₚ—Si(R⁷)₃, NR²—(CH₂)ₙ—NR⁴—(CH₂)ₚ—SR⁸, O(CH₂)ₙ—NR⁴R⁵, O(CH₂)ₙ—N⁺R⁴R⁵R⁶ Y⁻, O(CH₂)ₙ—O(PO₃H)⁻ W⁺, O(CH₂)ₙ—Si(R⁷)₃, O(CH₂)ₙ—SR⁸, O(CH₂)ₙ—NR⁴—(CH₂)ₚ—NR⁹R¹⁰, O(CH₂)ₙ—NR⁴—(CH₂)ₚ—N⁺R⁹R¹⁰R¹¹ Y⁻, O(CH₂)ₙ—NR⁴—(CH₂)ₚ—O(PO₃H)⁻ W⁺ or O(CH₂)ₙ—NR⁴—(CH₂)ₚ—Si(R⁷)₃; and
the other one of Z² and Z³ is OR¹²
or
Z² is NR²R³, NR²—(CH₂)ₙ—NR⁴R⁵, NR²—(CH₂)ₙ—N⁺R⁴R⁵R⁶ Y⁻, NR²—(CH₂)ₙ—O(PO₃H)⁻ W⁺, NR²—(CH₂)ₙ—Si(R⁷)₃, NR²—(CH₂)ₙ—SR⁸, NR²—(CH₂)ₙ—NR⁴—(CH₂)ₚ—NR⁹R¹⁰, NR²—(CH₂)ₙ—NR⁴—(CH₂)ₚ—N⁺R⁹R¹⁰R¹¹ Y⁻, NR²—(CH₂)ₙ—NR⁴—(CH₂)ₚ—O(PO₃H)⁻ W⁺, NR²—(CH₂)ₙ—NR⁴—(CH₂)ₚ—Si(R⁷)₃, NR²—(CH₂)ₙ—NR⁴—(CH₂)ₚ—SR⁸, O(CH₂)ₙ—NR⁴R⁵, O(CH₂)ₙ—N⁺R⁴R⁵R⁶ Y⁻, O(CH₂)ₙ—O(PO₃H)⁻ W⁺, O(CH₂)ₙ—Si(R⁷)₃, O(CH₂)ₙ—SR⁸, O(CH₂)ₙ—NR⁴—(CH₂)ₚ—NR⁹R¹⁰, O(CH₂)ₙ—NR⁴—(CH₂)ₚ—N⁺R⁹R¹⁰R¹¹ Y⁻, O(CH₂)ₙ—NR⁴—(CH₂)ₚ—O(PO₃H)⁻ W⁺ or O(CH₂)ₙ—NR⁴—(CH₂)ₚ—Si(R⁷)₃; and
Z³=Z²;
each R¹, R² and R¹² is, independently, H, alkyl, substituted alkyl, aryl, substituted aryl, alkenyl, substituted alkenyl, alkynyl or substituted alkynyl;
R³ is alkyl substituted alkyl, alkenyl, substituted alkenyl, alkynyl or substituted alkynyl;
each R⁴, R⁶, R⁸, R⁹, R¹⁰ and R¹¹ is, independently, H, alkyl, substituted alkyl, aryl, substituted aryl, alkenyl, substituted alkenyl, alkynyl, substituted alkynyl or —(CH₂)_{q}—(CH₂CH₂O)ₘ—R¹³;
R⁵ is alkyl, substituted alkyl, aryl, substituted aryl, alkenyl, substituted alkenyl, alkynyl, substituted alkynyl or —(CH₂)_{q}—(CH₂CH₂O)ₘ—R¹³;
R⁷ is alkyl, O(alkyl) or O(tri-substituted silyl);
R¹³ is H, alkyl, substituted alkyl, aryl, substituted aryl, alkenyl, substituted alkenyl, alkynyl, substituted alkynyl, CO(alkyl), CO(substituted alkyl), CO(alkenyl), CO(substituted alkenyl), CO(alkynyl) or CO(substituted alkynyl);
W⁺ is an agriculturally acceptable cation;
Y⁻ is an agriculturally acceptable anion;
n is an integer selected from 1 to 16;
p is an integer selected from 1 to 16;
m is an integer selected from 1 to 100;
q is an integer selected from 0 to 16;
each R^{a}, R^{b}, R^{c}, R^{d}, R^{e} and R^{f} is, independently, H, alkyl, substituted alkyl, aryl, substituted aryl, alkenyl, substituted alkenyl, alkynyl or substituted alkynyl;
[symbol] is a single bond or a double bond;
[symbol] is a single bond or a double bond; and
M is 2H or a metal species,
wherein each substituted alkyl, substituted aryl, substituted alkenyl and substituted alkynyl groups are, independently, substituted with one or more F, Cl, Br, I, CN and N₃.

In some implementations, [symbol] is a single bond; and [symbol] is a double bond.

When [symbol] is a single bond, the two asymmetric carbons in the modified Ce6 can independently be of any configuration (R) or (S). For example, the two asymmetric carbons in the modified Ce6 can each be of (S) configuration.

In some implementations, each R^{a}, R^{b}, R^{c}, R^{d}, R^{e} and R^{f} is, independently, alkyl or alkenyl. For example, and without being limiting, R^{a}, R^{c}, R^{e} and R^{f} can be methyl; R^{b} can be vinyl; and R^{d} can be ethyl.

In some implementations, M is 2H. In some implementations, M is a metal species selected from the group consisting of Mg, Zn, Pd, Sn, Al, Pt, Si, Ge, Ga, In, Cu, Co, Fe and Mn. It should be understood that when a metal species is mentioned without its degree of oxidation, all suitable oxidation states of the metal species are to be considered, as would be understood by a person skilled in the art. In other implementations, M is a metal species selected from the group consisting of Mg(II), Zn(II), Pd(II), Sn(IV), Al(III), Pt(II), Si(IV), Ge(IV), Ga(III) and In(III). In yet other implementations, M is a metal species selected from the group consisting of Cu(II), Co(II), Fe(II) and Mn(II).

In some implementations, each R¹, R², R⁴, R⁶, R⁸, R⁹, R¹⁰, R¹¹ and R¹² is, independently, H, alkyl or substituted alkyl. In some implementations, each R³ and R⁵ is, independently, alkyl or substituted alkyl. In some implementations, R¹³ is H, alkyl, substituted alkyl, CO(alkyl) or CO(substituted alkyl).

In some implementations, the compound is selected such that at least one of the following is true: R¹ is H, R² is H, R³ is alkyl, R⁴ is H or alkyl, R⁵ is alkyl, R⁶ is alkyl, R⁷ is O(tri-substituted silyl), R⁸ is —(CH₂)_{q}—(CH₂CH₂O)ₘ—R¹³, R⁹ is alkyl, R¹⁰ is alkyl, R¹¹ is alkyl, R¹² is H and R¹³ is H, alkyl, alkenyl, CO(alkyl) or CO(alkenyl).

In some implementations, W⁺ is selected from the group consisting of sodium, potassium, magnesium and ammonium cations. In some implementations, Y⁻ is selected from the group consisting of chloride, bromide, phosphate, dimethylphosphate, methylsulfate, ethylsulfate, acetate and lactate.

In some implementations, n is an integer selected from 1 to 16, or from 1 to 12, or from 1 to 8, or from 1 to 6, or from 1 to 4, or from 2 to 4. Similarly, in some implementations, p is an integer selected from 1 to 16, or from 1 to 12, or from 1 to 8, or from 1 to 6, or from 1 to 4, or from 2 to 4. Regarding the PEG moieties, m is an integer that can be selected from 1 to 100, or from 1 to 80, or from 1 to 60, or from 1 to 50, or from 1 to 30, or from 1 to 20, or from 1 to 10, or from 5 to 30, or from 5 to 20, or from 5 to 10. Similarly, in some implementations, q is an integer selected from 0 to 16, or from 0 to 12, or from 0 to 8, or from 0 to 6, or from 0 to 4. In some implementations, q=1. In yet other implementations, q=0.

In some implementations, Z² is NR²R³, NR²—(CH₂)ₙ—NR⁴R⁵, NR²—(CH₂)ₙ—N⁺R⁴R⁵R⁶ Y⁻, NR²—(CH₂)ₙ—O(PO₃H)⁻ W⁺, NR²—(CH₂)ₙ—Si(R⁷)₃, NR²—(CH₂)ₙ—SR⁸, NR²—(CH₂)ₙ—NR⁴—(CH₂)ₚ—NR⁹R¹⁰, NR²—(CH₂)ₙ—NR⁴—(CH₂)ₚ—N⁺R⁹R¹⁰R¹¹ Y⁻; NR²—(CH₂)ₙ—NR⁴—(CH₂)ₚ—O(PO₃H)⁻ W⁺, NR²—(CH₂)ₙ—NR⁴—(CH₂)ₚ—Si(R⁷)₃, NR²—(CH₂)ₙ—NR⁴—(CH₂)ₚ—SR⁸, OR³, O(CH₂)ₙ—NR⁴R⁵, O(CH₂)ₙ—N⁺R⁴R⁵R⁶ Y⁻, O(CH₂)ₙ—O(PO₃H)⁻ W⁺, O(CH₂)ₙ—Si(R⁷)₃, O(CH₂)ₙ—SR⁸, O(CH₂)ₙ—NR⁴—(CH₂)ₚ—NR⁹R¹⁰, O(CH₂)ₙ—NR⁴—(CH₂)ₚ—N⁺R⁹R¹⁰R¹¹ Y⁻, O(CH₂)ₙ—NR⁴—(CH₂)ₚ—O(PO₃H)⁻ W⁺ or O(CH₂)ₙ—NR⁴—(CH₂)ₚ—Si(R⁷)₃; and Z³ is OR¹² or Z³=Z².

In some implementations, Z² is NR²R³, NR²—(CH₂)ₙ—NR⁴R⁵, NR²—(CH₂)ₙ—N⁺R⁴R⁵R⁶ Y⁻, NR²—(CH₂)ₙ—O(PO₃H)⁻ W⁺, NR²—(CH₂)ₙ—Si(R⁷)₃, NR²—(CH₂)ₙ—SR⁸, NR²—(CH₂)ₙ—NR⁴—(CH₂)ₚ—NR⁹R¹⁰; and Z³ is OR¹² or Z³=Z².

In some implementations, Z³ is OR¹². For example, Z³ can be OH. In other implementations, Z³=Z².

In some implementations, the modified Ce6 can be a compound of Formula I-B1:

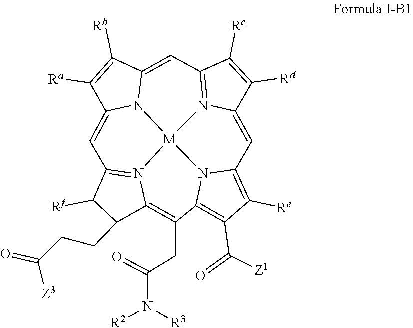

or an agriculturally acceptable salt thereof,
wherein:
Z¹ is OR¹;
R² is H, alkyl or substituted alkyl;
R³ is alkyl or substituted alkyl;
Z³ is OR¹² or Z³=NR²R³,
each R¹ and R¹² is, independently, H, alkyl or substituted alkyl;
each R^{a}, R^{b}, R^{c}, R^{d}, R^{e} and R^{f} is, independently, H, alkyl, substituted alkyl, alkenyl, substituted alkenyl, alkynyl or substituted alkynyl; and
M is 2H or a metal species,
wherein the substituted alkyl, substituted alkenyl and substituted alkynyl groups are, independently, substituted with one or more F, Cl, Br, I, CN and N₃.

In some implementations, R¹ is H, R² is H and/or R³ is alkyl. R³ can for example be a (C₁-C₁₂)alkyl, a (C₁-C₅)alkyl or a (C₁-C₄)alkyl. In some implementations, Z³ is OR¹², and R¹² can be H. In other implementations, Z³=NR²R³.

In some implementations, the modified Ce6 can be a compound of Formula I-B2:

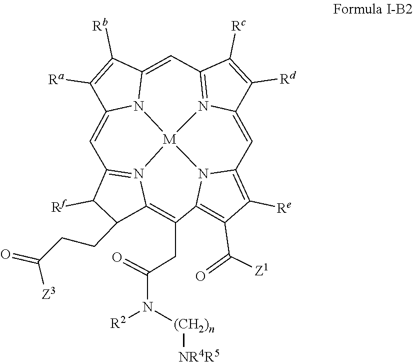

or an agriculturally acceptable salt thereof,
wherein:
Z¹ is OR¹;
R⁵ is alkyl, substituted alkyl or —(CH₂)ₚ—NR⁹R¹⁰;
each R², R⁴, R⁹ and R¹⁰ is, independently, H, alkyl or substituted alkyl;
n is an integer selected from 1 to 16;
p is an integer selected from 1 to 16;
Z³ is OR¹² or Z³=NR²—(CH₂)ₙ—NR⁴R⁵;
each R¹ and R¹² is, independently, H, alkyl or substituted alkyl;
each R^{a}, R^{b}, R^{c}, R^{d}, R^{e} and R^{f} is, independently, H, alkyl, substituted alkyl, alkenyl, substituted alkenyl, alkynyl or substituted alkynyl; and
M is 2H or a metal species,
wherein the substituted alkyl, substituted alkenyl and substituted alkynyl groups are, independently, substituted with one or more F, Cl, Br, I, hydroxy, CN and N₃.

In some implementations, R¹ is H, R² is H and/or R⁴ is H or alkyl. In some implementations, R⁴ is H and R⁵ is alkyl. In some implementations, R⁴ and R⁵ are alkyl. R⁴ and/or R⁵ can for example be a (C₁-C₁₂)alkyl, a (C₁-C₅)alkyl or a (C₁-C₄)alkyl. In some implementations, R⁵ is —(CH₂)ₚ—NR⁹R¹⁰. In some implementations, R⁹ and R¹⁰ are alkyl, or R⁹ is H and R¹⁰ is alkyl. R⁹ and/or R¹⁰ can for example be a (C₁-C₁₂)alkyl, a (C₁-C₃)alkyl or a (C₁-C₄)alkyl. In some implementations, n is an integer selected from 1 to 16, or from 1 to 12, or from 1 to 8, or from 1 to 6, or from 1 to 4, or from 2 to 4.

In some implementations, the modified Ce6 can be a compound of Formula I-B3:

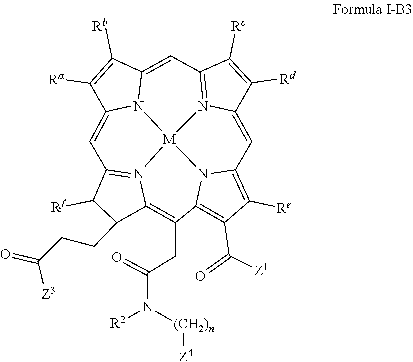

or an agriculturally acceptable salt thereof,
wherein:
Z¹ is OR¹;
Z⁴ is Si(R⁷)₃ or SR⁸;
Z³ is OR¹² or Z³=NR²—(CH₂)ₙ—Z⁴;
each R¹, R² and R¹² is, independently, H, alkyl or substituted alkyl;
R⁷ is alkyl, O(alkyl) or O(trisubstituted silyl);
R⁸ is H, alkyl, substituted alkyl or —(CH₂CH₂)ₘ—R¹³;
R¹³ is H, alkyl, substituted alkyl, alkenyl, substituted alkenyl, alkynyl, substituted alkynyl, CO(alkyl), CO(substituted alkyl), CO(alkenyl), CO(substituted alkenyl), CO(alkynyl) or CO(substituted alkynyl);
n is an integer selected from to 16
m is an integer selected from 1 to 100;
each R^{a}, R^{b}, R^{c}, R^{d}, R^{e} and R^{f} is, independently, H, alkyl, substituted alkyl, alkenyl, substituted alkenyl, alkynyl or substituted alkynyl; and
M is 2H or a metal species,
wherein the substituted alkyl, substituted alkenyl and substituted alkynyl groups are, independently, substituted with one or more F, Cl, Br, I, hydroxy, ON and N₃.

In some implementations, R¹ is H, R² is H and/or R¹² is H or alkyl. In some implementations, R⁷ is alkyl, O(alkyl) or O(tri-substituted silyl), with the alkyl groups being a (C₁-C₁₂)alkyl, a (C₁-C₈)alkyl or a (C₁-C₄)alkyl. In some implementations, n is an integer selected from 1 to 16, or from 1 to 12, or from 1 to 8, or from to 6, or from 1 to 4, or from 2 to 4. In some implementations, Z³ is OR¹². In other implementations, Z³=NR²—(CH₂)ₙ—Z⁴.

In some implementations, the modified Ce6 can be a compound of Formula I-B4a:

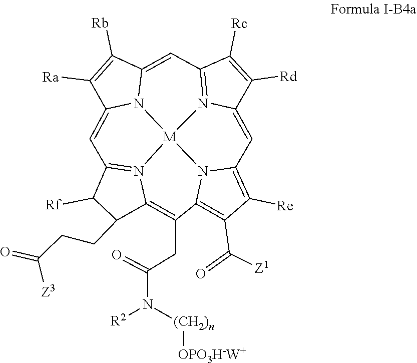

or an agriculturally acceptable salt thereof,
wherein:
Z¹ is OR¹;
Z³ is OR¹² or Z³=NR₂—(CH₂)ₙ—O(PO₃H)⁻ W⁺;
each R¹, R² and R¹² is, independently, H, alkyl or substituted alkyl;
n is an integer selected from 1 to 16;
W⁺ is an agriculturally acceptable cation;
each R^{a}, R^{b}, R^{c}, R^{d}, R^{e} and R^{f} is, independently, H, alkyl, substituted alkyl, alkenyl, substituted alkenyl, alkynyl or substituted alkynyl; and
M is 2H or a metal species,
wherein the substituted alkyl, substituted alkenyl and substituted alkynyl groups are, independently, substituted with one or more F, Cl, Br, I, hydroxy, CN and N₃.

In some implementations, R¹ is H, R² is H and/or R¹² is H or alkyl. In some implementations, n is an integer selected from 1 to 16, or from 1 to 12, or from 1 to 8, or from 1 to 6, or from 1 to 4, or from 2 to 4. W⁺ is selected from the group consisting of sodium, potassium, magnesium and ammonium cations. In some implementations, Z³ is OR¹². In other implementations, Z³=NR₂—(CH₂)ₙ—O(PO₃H)⁻W⁺.

In some implementations, the modified Ce6 can be a compound of Formula I-B4c:

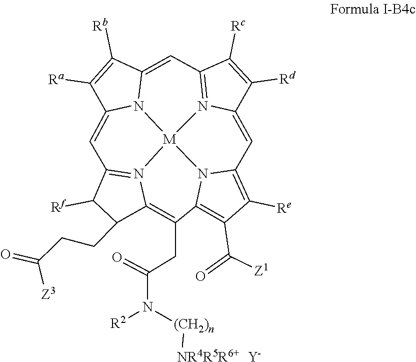

or an agriculturally acceptable salt thereof,
wherein:
Z¹ is OR¹;
Z³ is OR¹² or Z³=NR₂—(CH₂)ₙ—NR⁴R⁵R⁶⁺ Y⁻;
each R¹, R² and R¹² is, independently, H, alkyl or substituted alkyl;
each R⁴, R⁵ and R⁶ is, independently, alkyl or substituted alkyl;
n is an integer selected from 1 to 16;
Y⁻ is an agriculturally acceptable anion;
each R^{a}, R^{b}, R^{c}, R^{d}, R^{e} and R^{f} is, independently, H, alkyl, substituted alkyl, alkenyl, substituted alkenyl, alkynyl or substituted alkynyl; and
M is 2H or a metal species,
wherein the substituted alkyl, substituted alkenyl and substituted alkynyl groups are, independently, substituted with one or more F, Cl, Br, I, hydroxy, CN and N₃.

In some implementations, R¹ is H, R² is H and/or R¹² is H or alkyl. In some implementations, n is an integer selected from 1 to 16, or from 1 to 12, or from 1 to 8, or from 1 to 6, or from 1 to 4, or from 2 to 4. In some implementations, R⁴, R⁵ and R⁶ are alkyl and optionally R⁴=R⁵=R⁶. Y⁻ is selected from the group consisting of chloride, bromide, phosphate, dimethylphosphate, methylsulfate, ethylsulfate, acetate and lactate. In some implementations, Z³ is OR¹². In other implementations, Z³=NR₂—(CH₂)ₙ—NR⁴R⁵R⁶⁺ Y⁻.

In some implementations, the modified Ce6 can be a compound of Formula I-C:

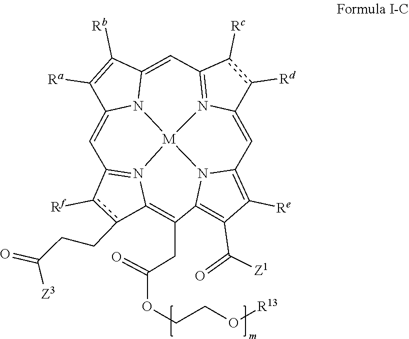

or an agriculturally acceptable salt thereof,
wherein:
Z¹ is OR¹;
Z³=OR¹² and m is an integer selected from 1 to 100; or
Z³=O(CH₂CH₂O)ₘ—R¹³ and m is an integer selected from 5 to 100;
each R¹ and R¹² is, independently, H, alkyl or substituted alkyl;
R¹³ is H, alkyl, substituted alkyl, alkenyl, substituted alkenyl, alkynyl, substituted alkynyl, CO(alkyl), CO(substituted alkyl), CO(alkenyl), CO(substituted alkenyl), CO(alkynyl) or CO(substituted alkynyl);
each R^{a}, R^{b}, R^{c}, R^{d}, R^{e} and R^{f} is, independently, H, alkyl, substituted alkyl, alkenyl, substituted alkenyl, alkynyl or substituted alkynyl;
[symbol] is a single bond or a double bond;
[symbol] is a single bond or a double bond; and
M is 2H or a metal species,
wherein the substituted alkyl, substituted alkenyl and substituted alkynyl groups are, independently, substituted with one or more F, Cl, Br, I, hydroxy, CN and N₃.

In some implementations, R¹ is H and/or R¹² is H. In some implementations, m is an integer selected from 5 to 100, or from 5 to 80, or from 5 to 50, or from 5 to 20, or from 5 to 10. In some implementations, Z³ is OR¹². In other implementations, Z³=O(CH₂CH₂O)ₘ—R¹³. In some implementations, R¹³ is H, alkyl, alkenyl, CO(alkyl) or CO(alkenyl).

Non-limiting examples of modified Ce6 photosensitizers include:

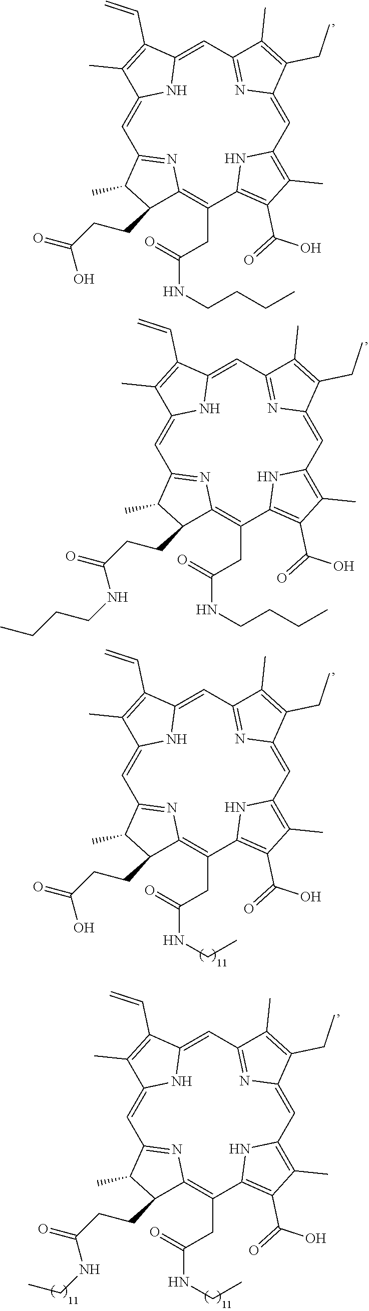

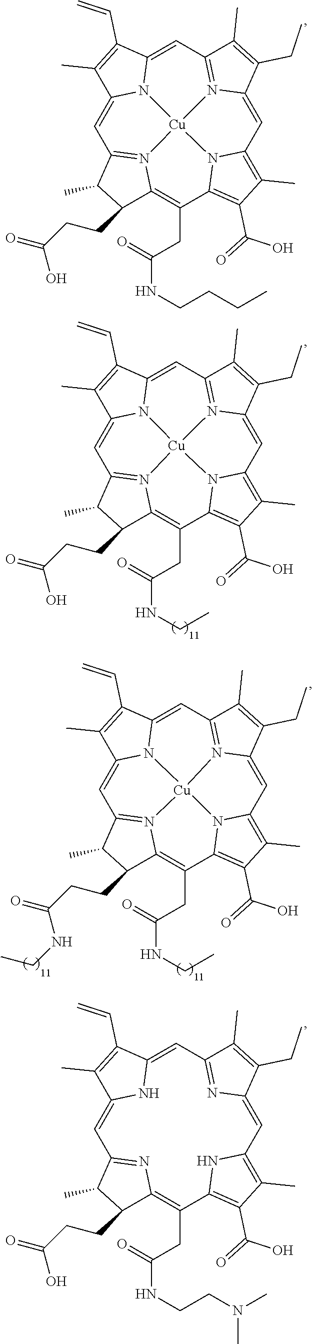

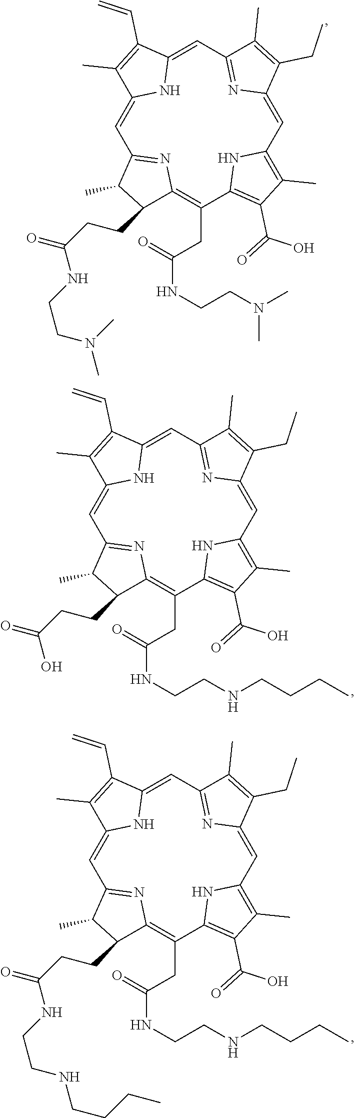

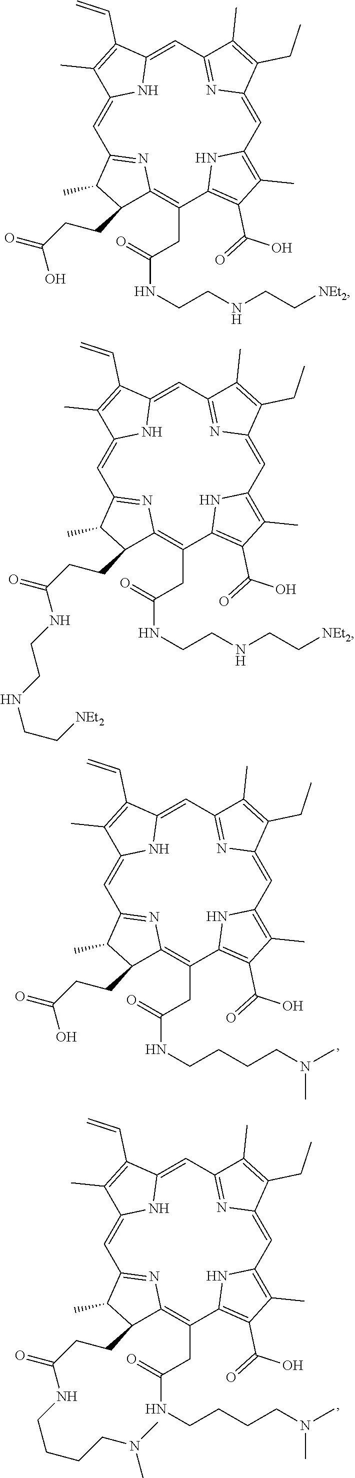

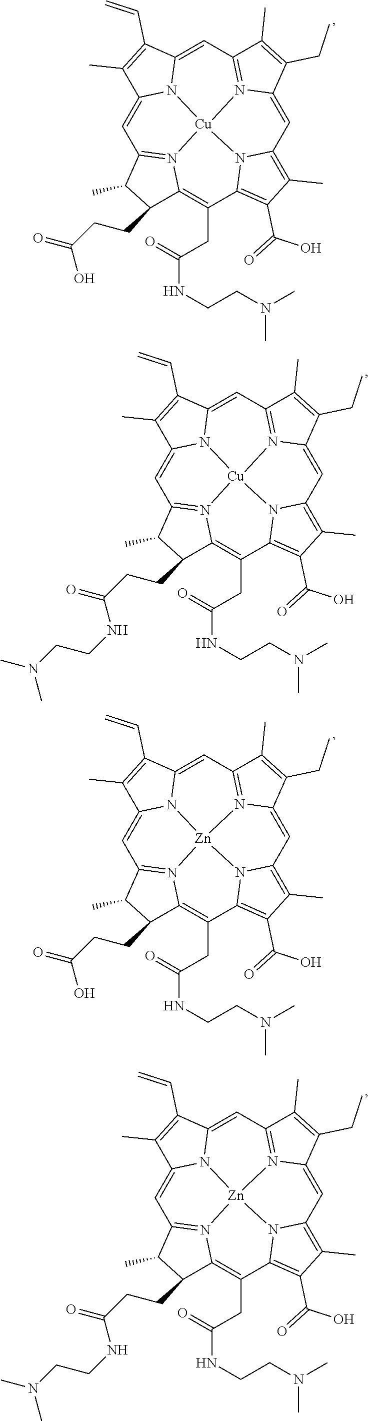

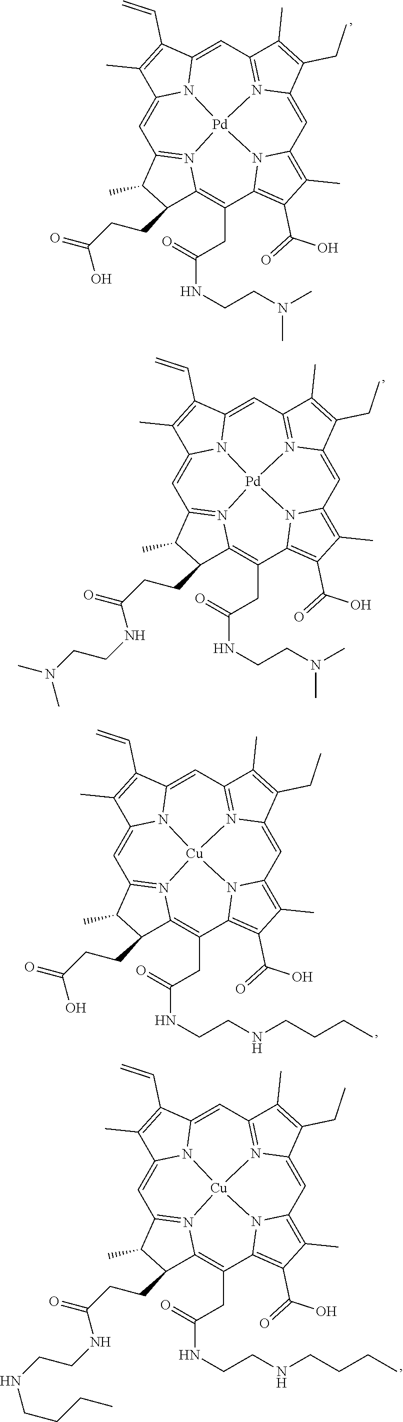

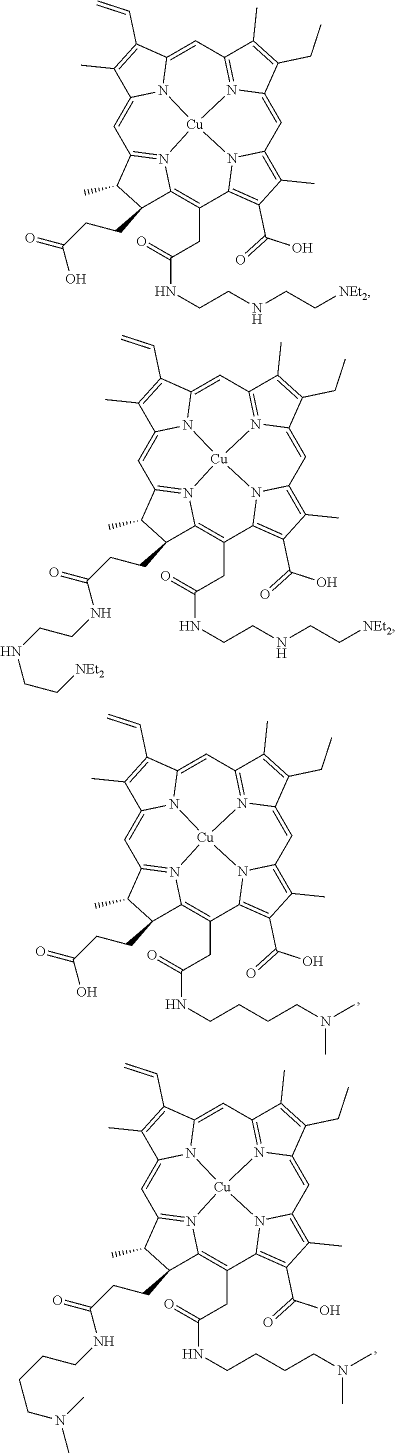

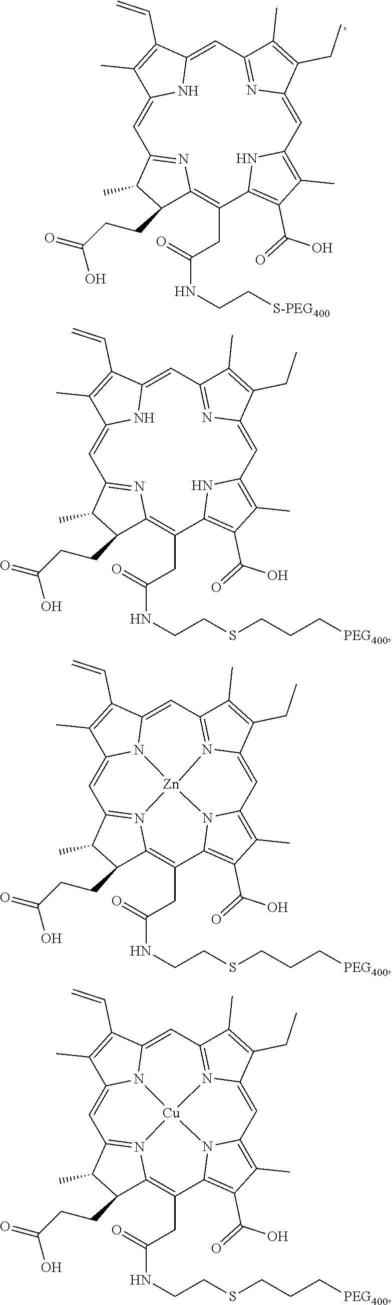

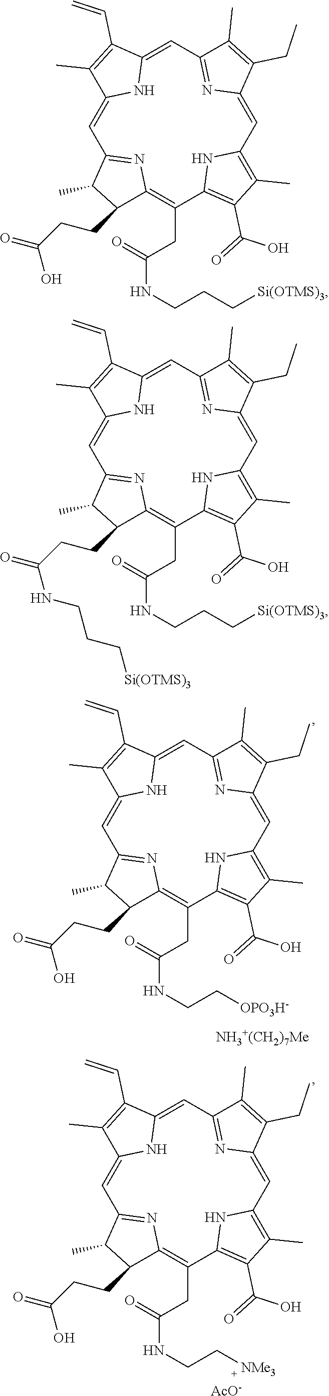

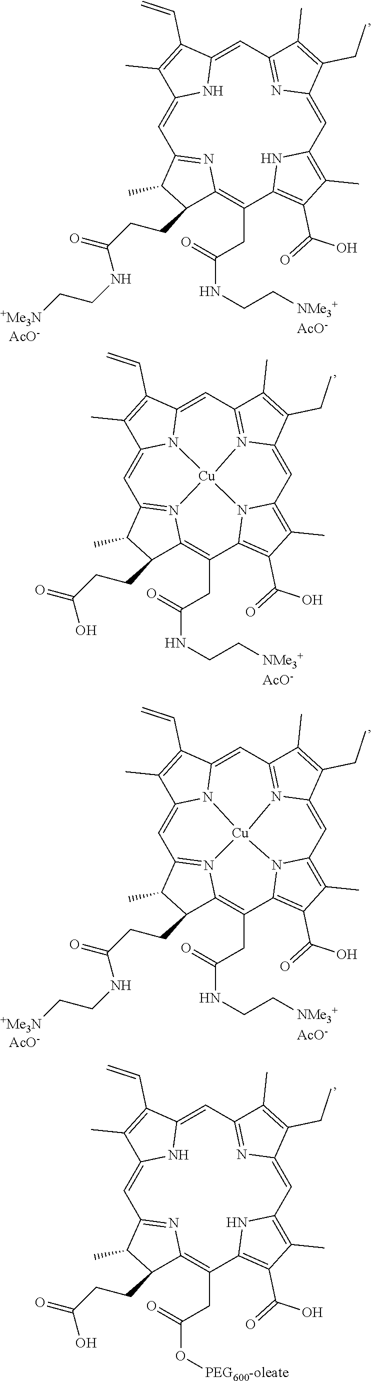

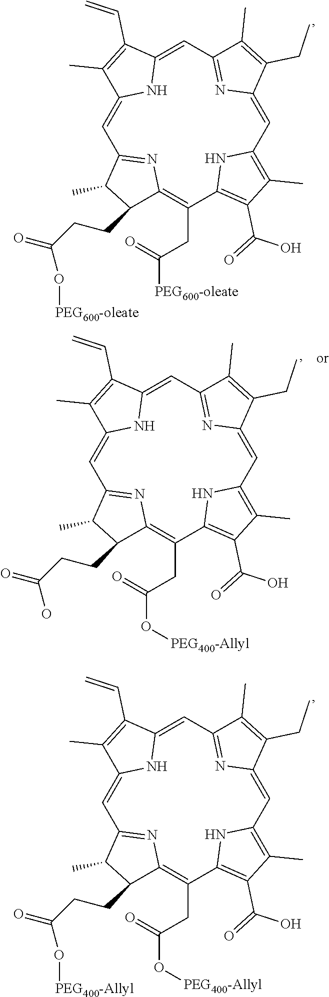

or an agriculturally acceptable salt thereof.

### Modified PP IX Photosensitizers

One of the compounds mentioned above, protoporphyrin IX (PP IX), is one of the most common porphyrins in nature. PP IX is a deeply colored pigment that is encountered in nature in the form of its iron complexes. When complexed with ferrous iron, the molecule is called heme. Other iron complexes have also been synthesized, for example with Fe(III) or Fe(IV). PP IX is a largely planar tetrapyrrole having a 20-carbon atom macrocyclic ring, each pyrrole being linked to two other pyrroles of the macrocyclic ring by a one-carbon bridge. In the depiction of PP IX below, the carbons of the macrocyclic ring are numbered from 1 to 20. In the chemical structure of PP IX, two carboxylic acid-bearing moieties are provided at the C13 (CH₂CH₂COOH) and C17 (CH₂CH₂COOH) positions.

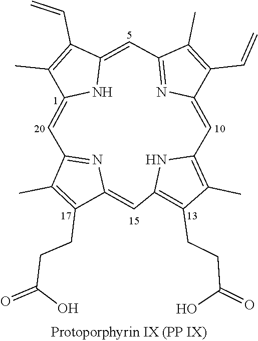 [SMILES: C=CC1=C(C)c2cc3[nH]c(cc4nc(cc5[nH]c(cc1n2)c(C)c5CCC(=O)O)C(CCC(=O)O)=C4C)c(C)c3C=C]

The photosensitizer compounds of the present description can be based on the PP IX scaffold above, where at least one of the C13 and C17 carboxylic acids can be functionalized. The modified PP IX compounds can be metallated or non-metallated. Examples of such modified PP IX, their activity and methods of manufacture are described in PCT patent application No. PCT/CA2020/050197 which is incorporated herein by reference in its entirety.

In some implementations, the modified PP IX can be a compound of Formula II:

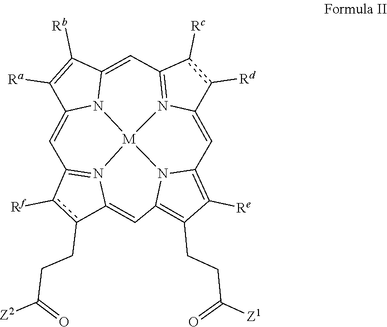

or an agriculturally acceptable salt thereof, wherein:
   Z¹ and Z² are each independently OR¹ or NR²R³;
   each R¹, R² and R³ is independently H, alkyl, substituted alkyl, aryl, substituted aryl, alkenyl, substituted alkenyl, alkynyl, or substituted alkynyl, wherein:
      if Z¹ and Z² are both OR¹ then at least one R¹ is not H,
      if Z¹ and Z² are both NR²R³ then at least one R³ is not H, and
      if one of Z¹ and Z² is OR¹ and the other one of Z¹ and Z² is NR²R³, then at least one of R¹ and R³ is not H;
   each R^{a}, R^{b}, R^{c}, R^{d}, R^{e} and R^{f} is, independently, H, alkyl, substituted alkyl, aryl, substituted aryl, alkenyl, substituted alkenyl, alkynyl or substituted alkynyl;
[symbol] is a single bond or a double bond;
[symbol] is a single bond or a double bond; and
M is 2H or a metal species,
wherein the substituted alkyl, substituted aryl, substituted alkenyl and substituted alkynyl groups are, independently, substituted with one or more —X, —R^{B}, —O⁻, ═O, —OR^{B}, —SR^{B}, —S⁻, —NR^{B}₂, Si(R^{C})₃, —N⁺R^{B}₃, —NR_{B}-(Alk)-NR^{B}₂, —NR^{B}-(Alk)-N⁺R^{B}₃, —NR^{B}-(Alk)-OR^{B}, —NR^{B}-(Alk)-OP(═O)(OR^{B})(O⁻), —NR^{B}-(Alk)-OP(═O)(OR^{B})₂, —NR^{B}-(AlK)-Si(R^{C})₃, —NR^{B}-(Alk)-SR^{B}, —O-(Alk)-NR^{B}₂, —O-(Alk)-N⁺R^{B}₃, —O-(Alk)-OR^{B}, —O-(Alk)-OP(═O)(OR^{B})(O⁻), —O-(Alk)-OP(═O)(OR^{B})₂, —O-(Alk)-Si(R^{C})₃, —O-(Alk)-SR^{B}, ═NR^{B}, —CX₃, —CN, —OCN, —SCN, —N═C═O, —NCS, —NO, —NO₂, ═N₂, —N₃, —NHC(═O)R^{B}, —OC(═O)R^{B}, —NHC(═O)NR^{B}₂, —S(═O)₂—, —S(═O)₂OH, —S(═O)₂R^{B}, —OS(═O)₂OR^{B}, —S(═O)₂NR^{B}₂, —S(═O)R^{B}, —OP(═O)(OR^{B})(O⁻), —OP(═O)(OR^{B})₂, —P(═O) (OR^{B})₂, —P(═O)(O⁻)₂, —P(═O)(OH)₂, —P(O)(OR^{B})(O⁻), —C(═O)R^{B}, —C(═O)X, —C(S)R^{B}, —C(O)OR^{B}, —C(O)O⁻, —C(S)OR^{B}, —C(O)SR^{B}, —C(S)SR^{B}, —C(O)NR^{B}₂, —C(S)NR^{B}₂ or —C(═NR^{B})NR^{B}₂;
each X is independently a halogen: F, Cl, Br or I;
each R^{B} is independently H, alkyl, aryl, arylalkyl, a heterocycle, an alkyloxy group such as poly(ethyleneoxy), PEG or poly(methyleneoxy), a capped poly(ethyleneoxy), capped PEG or capped polymethyleneoxy, or a protecting group;
the capped poly(ethyleneoxy), capped PEG and capped poly(methyleneoxy) groups being each independently capped with alkyl, aryl, arylalkyl, alkenyl, alkynyl, CO(alkyl), CO(aryl), CO(arylalkyl), CO(alkenyl) or CO(alkynyl);
each R^{C} is independently alkyl, aryl, arylalkyl, O(alkyl), O(aryl), O(arylalkyl), or O(tri-substituted silyl);
each tri-substituted silyl is independently substituted with three functional groups selected from alkyl, alkenyl, alkynyl, aryl and arylalkyl; and
each Alk is independently alkylene, alkenylene, or alkynylene.

In some implementations, the compound of Formula II is such that:
one of Z¹ and Z² is OR¹; and
the other one of Z¹ and Z² is NR²R³, NR²—(CH₂)ₙ—NR⁴R⁵, NR²—(CH₂)ₙ—N⁺R⁴R⁵R⁶ Y⁻, NR²—(CH₂)ₙ—O(PO₃H)⁻ W⁺, NR²—(CH₂)ₙ—Si(R⁷)₃, NR²—(CH₂)ₙ—SR⁸, NR²—(CH₂)ₙ—NR⁴—(CH₂)ₚ—NR⁹R¹⁰, NR²—(CH₂)ₙ—NR⁴—(CH₂)ₚ—N⁺R⁹R¹⁰R¹¹ Y⁻, NR²—(CH₂)ₙ—NR⁴—(CH₂)ₚ—O(PO₃H)⁻ W⁺, NR²—(CH₂)ₙ—NR⁴—(CH₂)ₚ—Si(R⁷)₃, NR²—(CH₂)ₙ—NR⁴—(CH₂)ₚ—SR⁸, O(CH₂)ₙ—NR⁴R⁵, O(CH₂)ₙ—N⁺R⁴R⁵R⁶ Y⁻, O(CH₂)ₙ—O(PO₃H)⁻ W⁺, O(CH₂)ₙ—Si(R⁷)₃, O(CH₂)ₙ—SR⁸, O(CH₂)ₙ—NR⁴—(CH₂)ₚ—NR⁹R¹⁰, O(CH₂)ₙ—NR⁴—(CH₂)ₚ—N⁺R⁹R¹⁰R¹¹ Y, O(CH₂)ₙ—NR⁴—(CH₂)ₚ—O(PO₃H)⁻ W⁺ or O(CH₂)ₙ—NR⁴—(CH₂)ₚ—Si(R⁷)₃;
or
Z¹ is NR²R³, NR²—(CH₂)ₙ—NR⁴R⁵, NR²—(CH₂)ₙ—N⁺R⁴R⁵R⁶ Y⁻, NR²—(CH₂)ₙ—O(PO₃H)⁻ W⁺, NR²—(CH₂)ₙ—Si(R⁷)₃, NR²—(CH₂)ₙ—SR⁸, NR²—(CH₂)ₙ—NR⁴—(CH₂)ₚ—NR⁹R¹⁰, NR²—(CH₂)ₙ—NR⁴—(CH₂)ₚ—N⁺R⁹R¹⁰R¹¹ Y⁻, NR²—(CH₂)ₙ—NR⁴—(CH₂)ₚ—O(PO₃H)⁻ W⁺, NR²—(CH₂)ₙ—NR⁴—(CH₂)ₚ—Si(R⁷)₃, NR²—(CH₂)ₙ—NR⁴—(CH₂)ₚ—SR⁸, O(CH₂)ₙ—NR⁴R⁵, O(CH₂)ₙ—N⁺R⁴R⁵R⁶ Y⁻, O(CH₂)ₙ—O(PO₃H)⁻ W⁺, O(CH₂)ₙ—Si(R⁷)₃, O(CH₂)ₙ—SR⁸, O(CH₂)ₙ—NR⁴—(CH₂)ₚ—NR⁹R¹⁰, O(CH₂)ₙ—NR⁴—(CH₂)ₚ—N⁺R⁹R¹⁰R¹¹ Y⁻, O(CH₂)ₙ—NR⁴—(CH₂)ₚ—O(PO₃H)⁻ W⁺ or O(CH₂)ₙ—NR⁴—(CH₂)ₚ—Si(R⁷)₃; and
Z²=Z¹;
each R¹ and R² is, independently, H, alkyl, substituted alkyl, aryl, substituted aryl, alkenyl, substituted alkenyl, alkynyl or substituted alkynyl;
R³ is alkyl, substituted alkyl, aryl, substituted aryl, alkenyl, substituted alkenyl, alkynyl or substituted alkynyl;
each R⁴, R⁶, R⁸, R⁹, R¹⁰ and R¹¹ is, independently, H, alkyl, substituted alkyl, aryl, substituted aryl, alkenyl, substituted alkenyl, alkynyl, substituted alkynyl or —(CH₂)_{q}—(CH₂CH₂O)ₘ—R¹³;
R⁵ is alkyl, substituted alkyl, aryl, substituted aryl, alkenyl, substituted alkenyl, alkynyl, substituted alkynyl or —(CH₂)_{q}—(CH₂CH₂O)ₘ—R¹³;
R⁷ is alkyl, O(alkyl) or O(tri-substituted silyl);
R¹³ is H, alkyl, substituted alkyl, aryl, substituted aryl, alkenyl, substituted alkenyl, alkynyl, substituted alkynyl, CO(alkyl), CO(substituted alkyl), CO(alkenyl), CO(substituted alkenyl), CO(alkynyl) or CO(substituted alkynyl);
W⁺ is an agriculturally acceptable cation;
Y⁻ is an agriculturally acceptable anion;
n is an integer selected from 1 to 16;
p is an integer selected from 1 to 16;
m is an integer selected from 1 to 100;
q is an integer selected from 0 to 16;
each R^{a}, R^{b}, R^{c}, R^{d}, R^{e} and R^{f} is, independently, H, alkyl, substituted alkyl, aryl, substituted aryl, alkenyl, substituted alkenyl, alkynyl or substituted alkynyl;
[symbol] is a single bond or a double bond;
[symbol] is a single bond or a double bond; and
M is 2H or a metal species,
wherein each substituted alkyl, substituted aryl, substituted alkenyl and substituted alkynyl groups are, independently, substituted with one or more OH, F, Cl, Br, I, CN and N₃.

In some implementations, Z¹=Z²=NR²R³. In other implementations, Z¹ is NR²R³ and Z² is OH, or Z¹ is OH and Z² is NR²R³. R³ can for example be alkyl or substituted alkyl.

In some implementations, [symbol] is a double bond and/or [symbol] is a double bond. More specifically: in some scenarios, [symbol] is a double bond and [symbol] is a double bond. In other scenarios, [symbol] is a double bond and [symbol] is a single bond. In yet other scenarios, [symbol] is a single bond and [symbol] is a double bond. In yet other scenarios, [symbol] is a single bond and [symbol] is a single bond.

In some implementations, each R^{a}, R^{b}, R^{c}, R^{d}, R^{e} and R^{f} is, independently, alkyl or alkenyl. In a non-limiting example, R^{a}, R^{c}, R^{e} and R^{f} are methyl while R^{b} and R^{d} are vinyl.

In some implementations, M is 2H. In some implementations, M is a metal species selected from the group consisting of Mg, Zn, Pd, Sn, Al, Pt, Si, Ge, Ga, In, Cu, Co, Fe and Mn. It should be understood that when a metal species is mentioned without its degree of oxidation, all suitable oxidation states of the metal species are to be considered, as would be understood by a person skilled in the art. In other implementations, M is a metal species selected from the group consisting of Mg(II), Zn(II), Pd(II), Sn(IV), Al(III), Pt(II), Si(IV), Ge(IV), Ga(III) and In(III). In yet other implementations, M is a metal species selected from the group consisting of Cu(II), Co(II), Fe(II) and Mn(II). In yet other implementations, M is a metal species selected from the group consisting of Cu(II), Co(III), Fe(III) and Mn(III).

In some implementations, each R¹, R², R⁴, R⁶, R⁸, R⁹, R¹⁰ and R¹¹ is, independently, H, alkyl or substituted alkyl. In some implementations, each R³ and R⁵ is, independently, alkyl or substituted alkyl. In some implementations, R¹³ is H, alkyl, substituted alkyl, CO(alkyl) or CO(substituted alkyl).

In some implementations, the compound of Formula II is selected such that at least one of the following is true: R¹ is H, R² is H, R³ is alkyl, R⁴ is H or alkyl, R⁵ is alkyl, R⁶ is alkyl, R⁷ is O(tri-substituted silyl), R⁸ is H or alkyl, R⁹ is alkyl, R¹⁰ is alkyl, R¹¹ is alkyl and R¹³ is H, alkyl, alkenyl, CO(alkyl) or CO(alkenyl).

In some implementations, W⁺ is selected from the group consisting of sodium, potassium, magnesium and ammonium cations. In some implementations, Y⁻ is selected from the group consisting of chloride, bromide, phosphate, dimethylphosphate, methylsulfate, ethylsulfate, acetate and lactate.

In some implementations, n is an integer selected from 1 to 16, or from 1 to 12, or from 1 to 8, or from 1 to 6, or from 1 to 4, or from 2 to 4. Similarly, in some implementations, p is an integer selected from 1 to 16, or from 1 to 12, or from 1 to 8, or from 1 to 6, or from 1 to 4, or from 2 to 4. Regarding the PEG moieties, m is an integer that can be selected from 1 to 100, or from 1 to 80, or from 1 to 60, or from 1 to 50, or from 1 to 30, or from 1 to 20, or from 1 to 10, or from 5 to 30, or from 5 to 20, or from 5 to 10. Still regarding PEG moieties, q is an integer that can be selected from 0 to 16, or from 0 to 8, or from 0 to 4, or from 0 to 2. In some implementations, q=1. In other implementations, 1=0.

In some implementations, Z¹ is NR²R³, NR²—(CH₂)ₙ—NR⁴R⁵, NR²—(CH₂)ₙ—N⁺R⁴R⁵R⁶ Y⁻, NR²—(CH₂)ₙ—O(PO₃H)⁻ W⁺, NR²—(CH₂)ₙ—Si(R⁷)₃, NR²—(CH₂)ₙ—SR⁸, NR²—(CH₂)ₙ—NR⁴—(CH₂)ₚ—NR⁹R¹⁰, NR²—(CH₂)ₙ—NR⁴—(CH₂)ₚ—N⁺R⁹R¹⁰R¹¹ Y NR²—(CH₂)ₙ—NR⁴—(CH₂)ₚ—O(PO₃H)⁻ W⁺, NR²—(CH₂)ₙ—NR⁴—(CH₂)ₚ—Si(R⁷)₃, NR²—(CH₂)ₙ—NR⁴—(CH₂)—SR⁸, O(CH₂)ₙ—NR⁴R⁵, O(CH₂)ₙ—N⁺R⁴R⁵R⁶ Y⁻, O(CH₂)ₙ—O(PO₃H)⁻ W⁺, O(CH₂)ₙ—Si(R⁷)₃, O(CH₂)ₙ—SR⁸, O(CH₂)ₙ—NR⁴—(CH₂)ₚ—NR⁹R¹⁰, O(CH₂)ₙ—NR⁴—(CH₂)ₚ—N⁺R⁹R¹⁰R¹¹ Y⁻, O(CH₂)ₙ—NR⁴—(CH₂)ₚ—O(PO₃H)⁻ W⁺ or O(CH₂)ₙ—NR⁴—(CH₂)ₚ—Si(R⁷)₃; and Z²=Z¹.

In some implementations, one of Z¹ and Z² is NR²R³, NR²—(CH₂)ₙ—NR⁴R⁵, NR²—(CH₂)ₙ—N⁺R⁴R⁵R⁶ Y⁻, NR²—(CH₂)ₙ—O(PO₃H)⁻ W⁺, NR²—(CH₂)ₙ—Si(R⁷)₃, NR²—(CH₂)ₙ—SR⁸ or NR²—(CH₂)ₙ—NR⁴—(CH₂)ₚ—NR⁹R¹⁰; and the other one of Z¹ and Z² is OR¹; or Z¹ is NR²R³, NR²—(CH₂)ₙ—NR⁴R⁵, NR²—(CH₂)ₙ—N⁺R⁴R⁵R⁶ Y⁻, NR²—(CH₂)ₙ—O(PO₃H)⁻ W⁺, NR²—(CH₂)ₙ—Si(R⁷)₃, NR²—(CH₂)ₙ—SR⁸ or NR²—(CH₂)ₙ—NR⁴—(CH₂)ₚ—NR⁹R¹⁰; and Z²=Z¹.

In some implementations, one of Z¹ and Z² is NR²R³, NR²—(CH₂)ₙ—NR⁴R⁵, NR²—(CH₂)ₙ—N⁺R⁴R⁵R⁶ Y⁻, NR²—(CH₂)ₙ—O(PO₃H)⁻ W⁺, NR²—(CH₂)ₙ—Si(R⁷)₃, NR²—(CH₂)ₙ—SR⁸ or NR²—(CH₂)ₙ—NR⁴—(CH₂)ₚ—NR⁹R¹⁰; and the other one of Z¹ and Z² is OR¹.

In some implementations, Z¹ is NR²R³, NR²—(CH₂)ₙ—NR⁴R⁵, NR²—(CH₂)ₙ—N⁺R⁴R⁵R⁶ Y⁻, NR²—(CH₂)ₙ—O(PO₃H)⁻ W⁺, NR²—(CH₂)ₙ—Si(R⁷)₃, NR²—(CH₂)ₙ—SR⁸ or NR²—(CH₂)ₙ—NR⁴—(CH₂)ₚ—NR⁹R¹⁰; and Z²=Z¹.

In some implementations, the modified PP IX can be a compound of Formula II-B1:

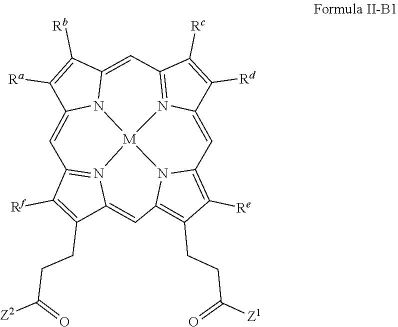

or an agriculturally acceptable salt thereof.

In some implementations:
one of Z¹ and Z² is NR²R³; and
the other one of Z¹ and Z² is OR¹;
or
Z¹=NR²R³; and
Z²=Z¹;
each R¹ and R² is, independently, H, alkyl or substituted alkyl;
R³ is alkyl or substituted alkyl;
each R^{a}, R^{b}, R^{c}, R^{d}, R^{e} and R^{f} is, independently, H, alkyl, substituted alkyl, alkenyl, substituted alkenyl, alkynyl or substituted alkynyl; and
M is 2H or a metal species,
wherein the substituted alkyl, substituted alkenyl and substituted alkynyl groups are, independently, substituted with one or more OH, F, Cl, Br, I, CN and N₃.

In some implementations, R¹ is H, R² is H and/or R³ is alkyl. R³ can for example be a (C₁-C₁₂)alkyl, a (C₁-C₈)alkyl or a (C₁-C₄)alkyl. In some implementations, one of Z¹ and Z² is NR²R³; and the other one of Z¹ and Z² is OR¹. In other implementations, Z¹=NR²R³; and Z²=Z¹.

In some implementations:
one of Z¹ and Z² is NR²—(CH₂)ₙ—NR⁴R⁵ or O—(CH₂)ₙ—NR⁴R⁵; and
the other one of Z¹ and Z² is OR¹;
or
Z¹=NR²—(CH₂)ₙ—NR⁴R⁵ or O—(CH₂)ₙ—NR⁴R⁵; and
Z²=Z¹;
R⁵ is alkyl, substituted alkyl or —(CH₂)ₚ—NR⁹R¹⁰;
each R¹, R², R⁴, R⁹ and R¹⁰ is, independently, H, alkyl or substituted alkyl;
n is an integer selected from 1 to 16;
p is an integer selected from 1 to 16;
each R^{a}, R^{b}, R^{c}, R^{d}, R^{e} and R^{f} is, independently, H, alkyl, substituted alkyl, alkenyl, substituted alkenyl, alkynyl or substituted alkynyl; and
M is 2H or a metal species,
wherein the substituted alkyl, substituted alkenyl and substituted alkynyl groups are, independently, substituted with one or more OH, F, Cl, Br, I, CN and N₃.

In some implementations, R¹ is H, R² is H and/or R⁴ is H or alkyl. In some implementations, R⁴ is H and R⁵ is alkyl. In some implementations, R⁴ and R⁵ are alkyl. R⁴ and/or R⁵ can for example each independently be a (C₁-C₁₂)alkyl, a (C₁-C₈)alkyl or a (C₁-C₄)alkyl. In some implementations, R⁵ is —(CH₂)ₚ—NR⁹R¹⁰. In some implementations, R⁹ and R¹⁰ are alkyl, or R⁹ is H and R¹⁰ is alkyl. R⁹ and/or R¹⁰ can for example each independently be a (C₁-C₁₂)alkyl, a (C₁-C₈)alkyl or a (C₁-C₄)alkyl.

In some implementations, n is an integer selected from 1 to 16, or from 1 to 12, or from 1 to 8, or from 1 to 6, or from 1 to 4, or from 2 to 4. In some implementations, p is an integer selected from 1 to 16, or from 1 to 12, or from 1 to 8, or from 1 to 6, or from 1 to 4, or from 2 to 4.

In some implementations, one of Z¹ and Z² is NR²—(CH₂)ₙ—NR⁴R⁵; and the other one of Z¹ and Z² is OR¹. In other implementations, Z¹=NR²—(CH₂)ₙ—NR⁴R⁵; and Z²=Z¹.

In some implementations:
one of Z¹ and Z² is NR²—(CH₂)ₙ—Si(R⁷)₃, O—(CH₂)ₙ—Si(R⁷)₃, NR²—(CH₂)ₙ—SR⁸ or 0-(CH₂)ₙ—SR⁸; and
the other one of Z¹ and Z² is OR¹;
or
Z¹=NR²—(CH₂)ₙ—Si(R⁷)₃, O—(CH₂)ₙ—Si(R⁷)₃, NR²—(CH₂)ₙ—SR⁸ or O—(CH₂)ₙ—SR⁸; and
Z²=Z¹;
each R¹ and R² is, independently, H, alkyl or substituted alkyl;
R⁷ is alkyl, O(alkyl) or O(trisubstituted silyl);
R⁸ is H, alkyl, substituted alkyl or —(CH₂)_{q}—(CH₂CH₂O)ₘ—R¹³
R¹³ is H, alkyl, substituted alkyl, alkenyl, substituted alkenyl, alkynyl, substituted alkynyl, CO(alkyl), CO(substituted alkyl), CO(alkenyl), CO(substituted alkenyl), CO(alkynyl) or CO(substituted alkynyl);
n is an integer selected from 1 to 16;
m is an integer selected from 1 to 100;
q is an integer selected from 0 to 16;
each R^{a}, R^{b}, R^{c}, R^{d}, R^{e} and R^{f} is, independently, H, alkyl, substituted alkyl, alkenyl, substituted alkenyl, alkynyl or substituted alkynyl; and
M is 2H or a metal species,
wherein the substituted alkyl, substituted alkenyl and substituted alkynyl groups are, independently, substituted with one or more OH, F, Cl, Br, I, CN and N₃.

In some implementations, R¹ is H and/or R² is H. In some implementations, R⁷ is alkyl, O(alkyl) or O(tri-substituted silyl). The alkyl groups for R¹, R² and R⁷ can each independently be a (C₁-C₁₂)alkyl, a (C₁-C₈)alkyl or a (C₁-C₄)alkyl. In some implementations, R⁸ is —(CH₂)_{q}—(CH₂CH₂O)ₘ—R¹³. R¹³ can be H and m can be an integer selected from 1 to 20. In some implementations, n is an integer selected from 1 to 16, or from 1 to 12, or from 1 to 8, or from 1 to 6, or from 1 to 4, or from 2 to 4. In some implementations, q is an integer selected from 0 to 16, or from 1 to 8, or from 0 to 4, or from 0 to 2. In some implementations, q=1. In other implementations, q=0.

In some implementations, one of Z¹ and Z² is NR²—(CH₂)ₙ—Si(R⁷)₃, O—(CH₂)ₙ—Si(R⁷)₃, NR²—(CH₂)ₙ—SR⁸ or O—(CH₂)ₙ—SR⁸; and the other one of Z¹ and Z² is OR¹. In other implementations, Z¹=NR²—(CH₂)ₙ—Si(R⁷)₃, O—(CH₂)ₙ—Si(R⁷)₃, NR²—(CH₂)ₙ—SR⁸ or O—(CH₂)ₙ—SR⁸; and Z²=Z¹.

In some implementations:
one of Z¹ and Z² is NR₂—(CH₂)ₙ—OP═O(OH)₂ or O—(CH₂)ₙ—OP═O(OH)₂, NR₂—(CH₂)ₙ—OP═O(OH)O⁻ W⁺ or O—(CH₂)ₙ—OP═O(OH)O⁻ W⁺; and
the other one of Z¹ and Z² is OR¹;
or
Z¹=NR₂—(CH₂)ₙ—OP═O(OH)₂ or O—(CH₂)ₙ—OP═O(OH)₂, NR₂—(CH₂)ₙ—OP═O(OH)O⁻ W⁺ or O—(CH₂)ₙ—OP═O(OH)O⁻ W⁺; and
Z²=Z¹;
each R¹ and R² is, independently, H, alkyl or substituted alkyl;
n is an integer selected from 1 to 16;
W⁺ is an agriculturally acceptable cation;
each R^{a}, R^{b}, R^{c}, R^{d}, R^{e} and R^{f} is, independently, H, alkyl, substituted alkyl, alkenyl, substituted alkenyl, alkynyl or substituted alkynyl; and
M is 2H or a metal species,
wherein the substituted alkyl, substituted alkenyl and substituted alkynyl groups are, independently, substituted with one or more OH, F, Cl, Br, I, CN and N₃.

In some implementations, R¹ is H and/or R² is H. In some implementations, n is an integer selected from 1 to 16, or from 1 to 12, or from 1 to 8, or from 1 to 6, or from 1 to 4, or from 2 to 4. W⁺ can be selected from the group consisting of sodium, potassium, magnesium and ammonium cations.

In some implementations, one of Z¹ and Z² is NR₂—(CH₂)ₙ—OP═O(OH)₂ or O—(CH₂)ₙ—OP═O(OH)₂, NR₂—(CH₂)ₙ—OP═O(OH)O⁻ W⁺ or O—(CH₂)ₙ—OP═O(OH)O⁻ W⁺; and the other one of Z¹ and Z² is OR¹. In other implementations, Z¹=NR₂—(CH₂)ₙ—OP═O(OH)₂ or O—(CH₂)ₙ—OP═O(OH)₂, NR₂—(CH₂)ₙ—OP═O(OH)O⁻ W⁺ or O—(CH₂)ₙ—OP═O(OH)O⁻ W⁺; and Z²=Z¹.

In some implementations:
one of Z¹ and Z² is NR²—(CH₂)ₙ—NR⁴R⁵R⁶⁺ Y⁻ or O—(CH₂)ₙ—NR⁴R⁵R⁶⁺ Y⁻; and
the other one of Z¹ and Z² is OR¹;
or
Z¹=NR²—(CH₂)ₙ—NR⁴R⁵R⁶⁺ Y⁻ or O—(CH₂)ₙ—NR⁴R⁵R⁶⁺ Y⁻; and
Z²=Z¹;
each R¹ and R² is, independently, H, alkyl or substituted alkyl;
each R⁴, R⁵ and R⁶ is, independently, alkyl or substituted alkyl;
n is an integer selected from 1 to 16;
Y⁻ is an agriculturally acceptable anion;
each R^{a}, R^{b}, R^{c}, R^{d}, R^{e} and R^{f} is, independently, H, alkyl, substituted alkyl, alkenyl, substituted alkenyl, alkynyl or substituted alkynyl; and
M is 2H or a metal species,
wherein the substituted alkyl, substituted alkenyl and substituted alkynyl groups are, independently, substituted with one or more OH, F, Cl, Br, I, CN and N₃.

In some implementations, R¹ is H and/or R² is H. In some implementations, n is an integer selected from 1 to 16, or from 1 to 12, or from 1 to 8, or from 1 to 6, or from 1 to 4, or from 2 to 4. In some implementations, R⁴, R⁵ and R⁶ are alkyl and optionally R⁴=R⁵=R⁶. In some implementations, Y⁻ is selected from the group consisting of chloride, bromide, phosphate, dimethylphosphate, methylsulfate, ethylsulfate, acetate and lactate.

In some implementations, one of Z¹ and Z² is NR²—(CH₂)ₙ—NR⁴R⁵R⁶⁺ Y⁻ or O—(CH₂)ₙ—NR⁴R⁵R⁶⁺ Y⁻; and the other one of Z¹ and Z² is OR¹. In other implementations, Z¹=NR²—(CH₂)ₙ—NR⁴R⁵R⁶⁺ Y⁻ or O—(CH₂)ₙ—NR⁴R⁵R⁶⁺ Y⁻; and Z²=Z¹.

In some implementations:
one of Z¹ and Z² is NR²—(CH₂CH₂O)ₘ—R¹³ or O—(CH₂CH₂O)ₘ—R¹³; and
the other one of Z¹ and Z² is OR¹;
or
Z¹=NR²—(CH₂CH₂O)ₘ—R¹³ or O—(CH₂CH₂O)ₘ—R¹³; and
Z²=Z¹;
each R¹ and R² is, independently, H, alkyl or substituted alkyl;
R¹³ is H, alkyl, substituted alkyl, alkenyl, substituted alkenyl, alkynyl, substituted alkynyl, CO(alkyl), CO(substituted alkyl), CO(alkenyl), CO(substituted alkenyl), CO(alkynyl) or CO(substituted alkynyl);
m is an integer selected from 1 to 100;
each R^{a}, R^{b}, R^{c}, R^{d}, R^{e} and R^{f} is, independently, H, alkyl, substituted alkyl, alkenyl, substituted alkenyl, alkynyl or substituted alkynyl; and
M is 2H or a metal species,
wherein the substituted alkyl, substituted alkenyl and substituted alkynyl groups are, independently, substituted with one or more OH, F, Cl, Br, I, CN and N₃.

In some implementations, R¹ is H and/or R¹² is H. In some implementations, m is an integer selected from 5 to 100, or from 5 to 80, or from 5 to 50, or from 5 to 20, or from 5 to 10. In some implementations, R¹³ is H, alkyl, alkenyl, CO(alkyl) or CO(alkenyl).

In some implementations, one of Z¹ and Z² is NR²—(CH₂CH₂O)ₘ—R¹³ or O—(CH₂CH₂O)ₘ—R¹³; and the other one of Z¹ and Z² is OR¹. In other implementations, Z¹=NR²—(CH₂CH₂O)ₘ—R¹³ or O—(CH₂CH₂O)ₘ—R¹³; and Z²=Z¹.

In some implementations:
one of Z¹ and Z² is a natural amino acid attached to the compound by its amino group bonded to the alpha carbon; and
the other one of Z¹ and Z² is OR¹;
or
Z¹ is a natural amino acid attached to the compound by its amino group bonded to the alpha carbon; and
Z²=Z¹;
each R¹ and R² is, independently, H, alkyl or substituted alkyl;
each R^{a}, R^{b}, R^{c}, R^{d}, R^{e} and R^{f} is, independently, H, alkyl, substituted alkyl, alkenyl, substituted alkenyl, alkynyl or substituted alkynyl; and
M is 2H or a metal species,
wherein the substituted alkyl, substituted alkenyl and substituted alkynyl groups are, independently, substituted with one or more OH, F, Cl, Br, I, CN and N₃.

In some implementations, one of Z¹ and Z² is a natural amino acid attached to the compound by its amino group bonded to the alpha carbon; and the other one of Z¹ and Z² is OR¹.

In other implementations, Z¹ is a natural amino acid attached to the compound by its amino group bonded to the alpha carbon; and Z²=Z¹.

In some implementations, Z¹ is one of the natural amino acids and Z² is OH; Z² is one of the natural amino acids and Z¹ is OH; or Z¹ is one of the natural amino acids and Z²=Z¹.

In some implementations, Z¹ is Glycine or L-Valine and Z² is OH; Z² is Glycine or L-Valine and Z¹ is OH; or Z¹ is Glycine or L-Valine and Z²=Z¹.

Non-limiting examples of modified PP IX photosensitizers include:

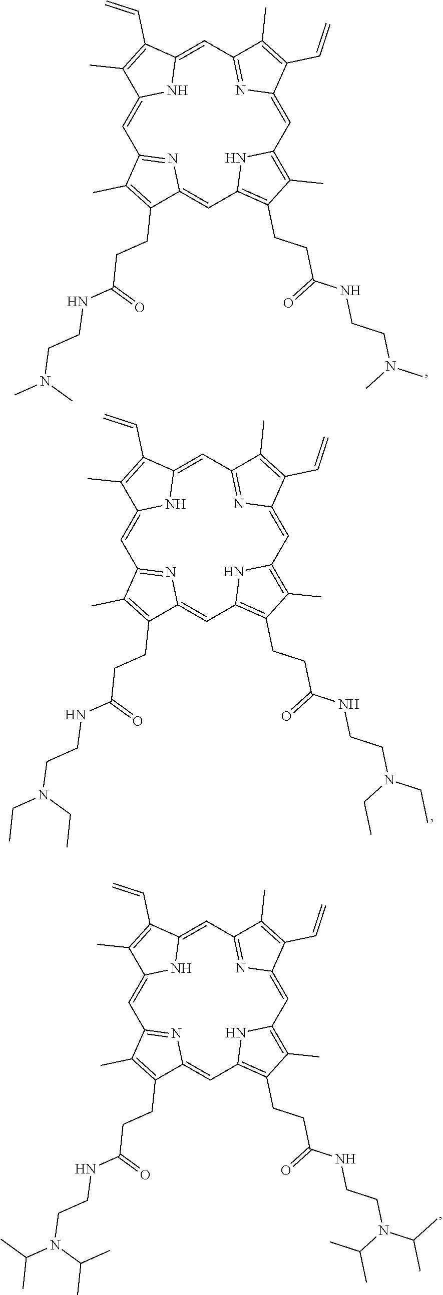

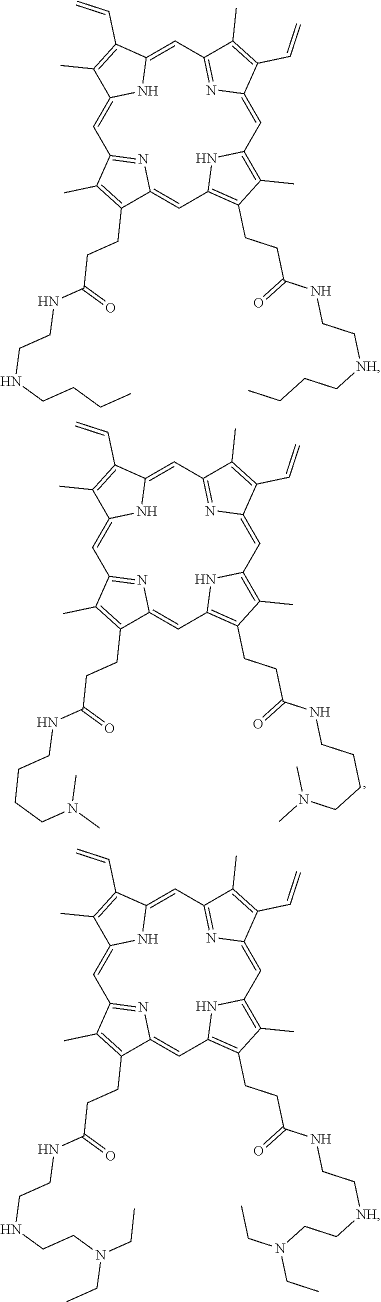

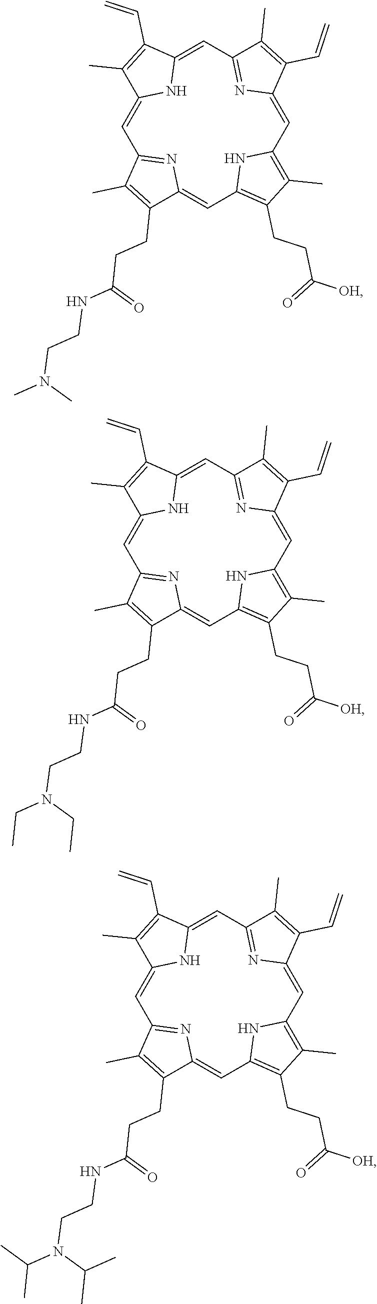

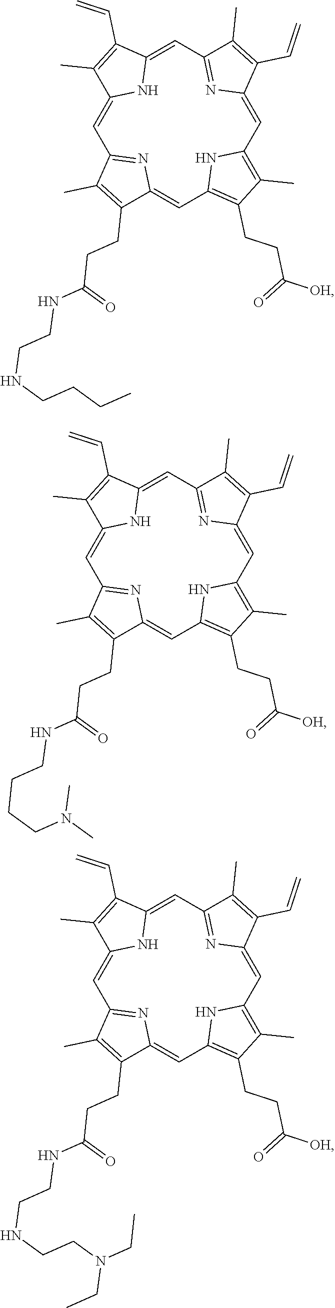

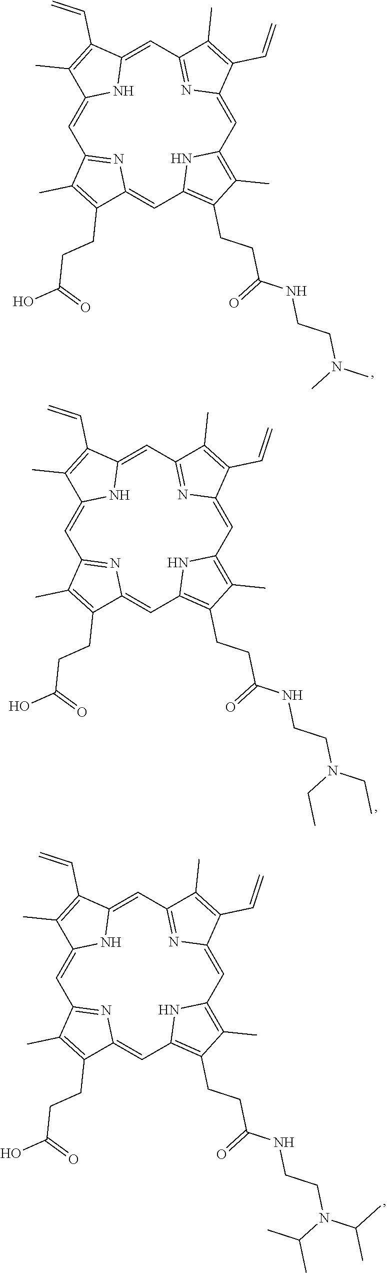 [SMILES: C=CC1=C(C)c2cc3[nH]c(cc4nc(cc5[nH]c(cc1n2)c(C)c5CCC(=O)NCCN(C)C)C(CCC(=O)O)=C4C)c(C)c3C=C ; C=CC1=C(C)c2cc3[nH]c(cc4nc(cc5[nH]c(cc1n2)c(C)c5CCC(=O)NCCN(CC)CC)C(CCC(=O)O)=C4C)c(C)c3C=C ; C=CC1=C(C)c2cc3[nH]c(cc4nc(cc5[nH]c(cc1n2)c(C)c5CCC(=O)NCCN(C(C)C)C(C)C)C(CCC(=O)O)=C4C)c(C)c3C=C]

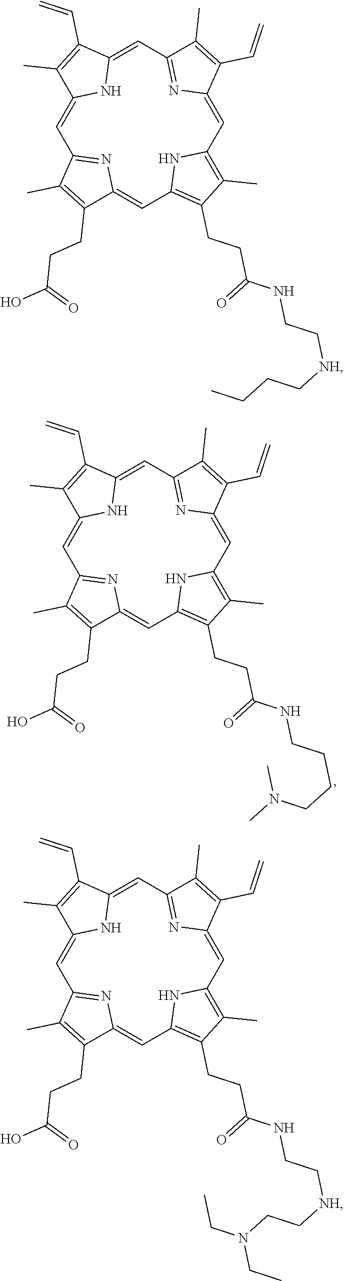

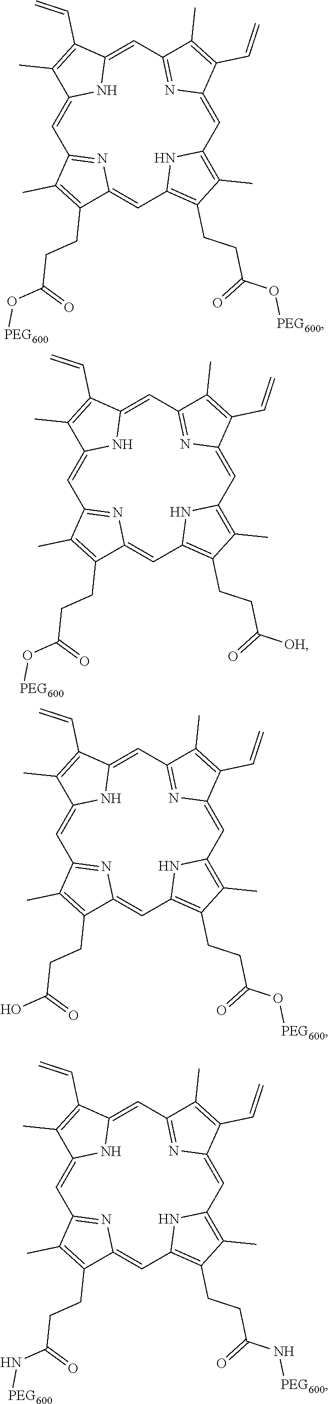

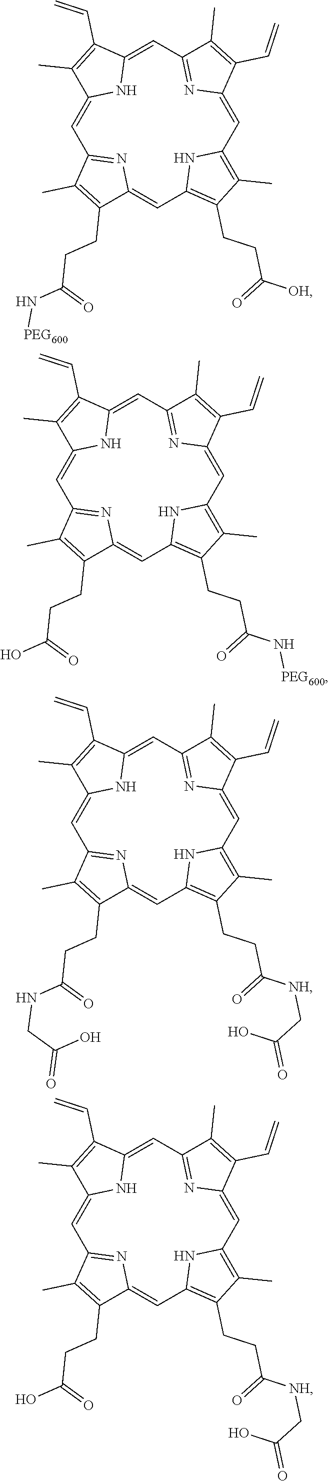

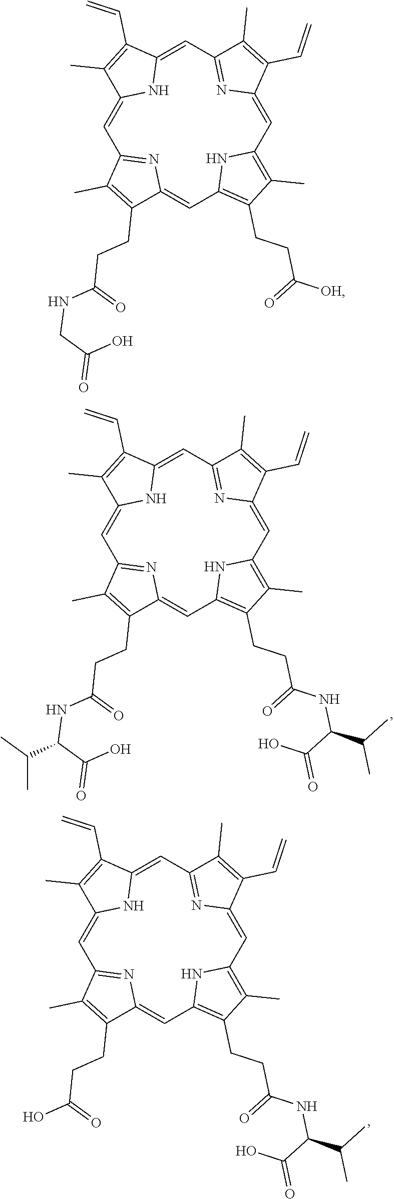

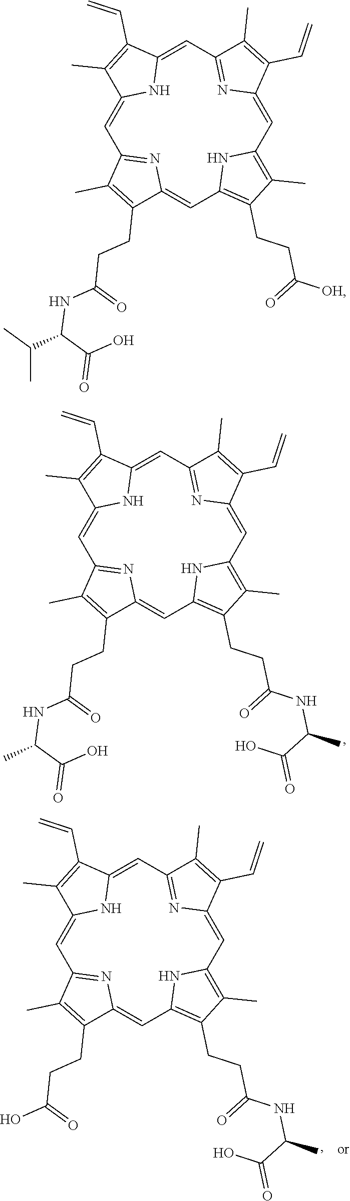

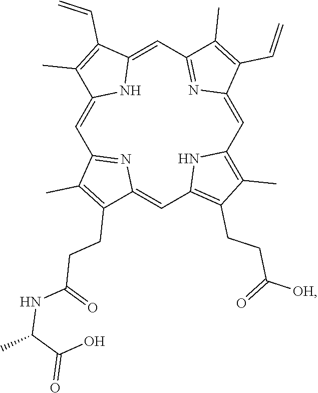 [SMILES: C=CC1=C(C)c2cc3[nH]c(cc4nc(cc5[nH]c(cc1n2)c(C)c5CCC(=O)O)C(CCC(=O)N[C@@H](C)C(=O)O)=C4C)c(C)c3C=C]

or an agriculturally accentuable salt thereof.

### Film-Forming Agent

The film-forming compositions of the present description include a film-forming agent that can form a film that is substantially impermeable to oxygen when at least a portion of the liquid carrier is removed after application to the plant. The film-forming agent can be any chemical compound that can form a film that is impermeable to oxygen when in a dry or non-hydrated state and that becomes permeable to oxygen when in a hydrated state. The film-forming agent can be a polymer. When the film-forming agent forms a film on the plant, all the other components of the composition can be present within the film (i.e., the photosensitizer, the antioxidant and any other component of the composition). The film formed by the film-forming agent can slow down the degradation of the photosensitizer by limiting the contact between the photosensitizer and oxygen molecules from ambient air. In some implementations, the film can slow down the degradation of the photosensitizer when in a dry or non-hydrated state by slowing down the transmission of oxygen and can let the oxygen molecules through at a higher rate when in a hydrated state.

The term “film”, as used herein, refers to a layer of material (e.g., a layer of polymeric material) that can be deposited, formed or otherwise present on a surface (e.g., the surface of a plant). The film-forming agent can be a hydrogel-forming polymer and the film formed can in such case be a hydrogel. The term “hydrogel”, as used herein, refers to a film formed by a network of polymer chains that are hydrophilic and highly water-absorbent. Polyvinyl alcohol is one example of a polymer that can form hydrogel-type films.

In some implementations, the film-forming agent is selected from the group consisting of ethylcellulose, methylcellulose, carboxymethyl cellulose, hydroxymethylcellulose, hydroxypropylcellulose, hydroxymethylpropylcellulose, hydroxylpropyl cellulose polyvinylpyrrolidone, guar gum, nanocellulose, soy protein isolate, whey protein, collagen, starch, hydroxypropylated amylomaize starch, amylomaize starch, xylan, polyvinylidene chloride, polyvinyl alcohol (PVOH), ethylene vinyl alcohol (EVA), polyvinyl alcohol copolymer, and combinations thereof.

In some implementations, the film-forming agent is a film-forming protein that forms a film which is substantially impermeable to oxygen when in a non-hydrated state. Non-limiting examples of such film-forming agents include soy protein isolate, whey protein and collagen.

In some implementations, the film-forming agent is a film-forming polysaccharide that forms a film which is substantially impermeable to oxygen when in a non-hydrated state. Non-limiting examples of such film-forming agents include guar gum and carboxymethyl cellulose.

In some implementations, the film-forming agent is polyvinyl alcohol. The term “polyvinyl alcohol” is meant to cover the thermoplastic polymer derived from polyvinyl acetate through partial or complete hydroxylation (or hydrolysis). The degree of hydrolysis typically determines the physical, chemical and mechanical properties of the polyvinyl alcohol. The degree of hydrolysis typically also affects the maximal moisture (water) uptake. Polyvinyl alcohol is quite hydrophilic and thus has a good solubility in water. Films made from polyvinyl alcohol tend to have heat-sealing properties, oxygen, nitrogen and carbon dioxide barrier properties when in a non-hydrated state, and good adhesion to other hydrophilic surfaces. Polyvinyl alcohol films are biocompatible, biodegradable and non-phytotoxic, making polyvinyl alcohol films well suited for application to plants.

The polyvinyl alcohol can have an average molecular weight from about 10 kDa to about 200 kDa or from about 50 kDa to about 100 kDa. For example, the polyvinyl alcohol can have an average molecular from about 13 kDa to about 23 kDa, or from about 31 kDa to about 50 kDa, or from about 89 kDa to about 98 kDa, or from about 146 kDa to about 186 kDa. The polyvinyl alcohol can have a degree of hydrolysis equal to or greater than 70%, or equal to or greater than 80%, or equal to or greater than 87%, or between 87% and 89%, or equal to or greater than 89%, or between 89% and 99%, or equal to or greater than 99%.

In some implementations, the polyvinyl alcohol has an average molecular weight from about 50 kDa to about 100 kDa and a degree of hydrolysis equal to or greater than 99%. In some implementations, the polyvinyl alcohol has an average molecular weight from about 13 kDa to about 23 kDa and a degree of hydrolysis equal to or greater than 98%. In some implementations, the polyvinyl alcohol has an average molecular weight from about 31 kDa to about 50 kDa and a degree of hydrolysis between 98% and 99%. In some implementations, the polyvinyl alcohol has an average molecular weight from about 89 kDa to about 98 kDa and a degree of hydrolysis equal to or greater than 99%. In some implementations, the polyvinyl alcohol has an average molecular weight from about 146 kDa to about 186 kDa and a degree of hydrolysis equal to or greater than 99%. In some implementations, the polyvinyl alcohol has an average molecular weight from about 31 kDa to about 50 kDa and a degree of hydrolysis between 87% and 89%. In some implementations, the polyvinyl alcohol has an average molecular weight from about 89 kDa to about 98 kDa and a degree of hydrolysis between 87% and 89%. In some implementations, the polyvinyl alcohol has an average molecular weight from about 146 kDa to about 186 kDa and a degree of hydrolysis between 87% and 89%.

In some implementations, the polyvinyl alcohol can be selected from the group consisting of Kuraray Poval™, Kuraray Exceval™, Sekisui Selvol™ and combinations thereof.

When the film-forming agent comprises a film-forming polymer, the film-forming polymer can be formulated with or without a plasticizer. It is understood that a plasticizer is an additive that increases the plasticity of a material. Plasticizers are typically liquids with low volatility, or solids. Plasticizers typically decrease the attraction between polymer chains to make the polymer chains more flexible. It is understood that a person skilled in the art would know what type of plasticizer can be used with any given film-forming polymer. For example, and without being limiting, commonly used plasticizers for the film-forming agent polyvinyl alcohol include glycerol, ethylene glycol, propylene glycol, polyglycerol, low molecular weight polyethylene glycols, ethanol acetamide, ethanol formamide, and ethanolamine salts such as triethanolammonium acetate.

### Antioxidant Agent

The film-forming compositions of the present description can include an antioxidant agent that can be included in the film formed by the film-forming agent. The antioxidant agent is more reactive than the photosensitizer towards ROS when in solution, in a dispersion, in a hydrogel-like environment and/or in a film that is in a hydrated state. The function of the antioxidant is to slow down the degradation of the photosensitizer in solution, prior to formation of the film and/or when the film is in a hydrated state after application of the film-forming composition to the plant. In some scenarios, the antioxidant agent does not slow down the degradation of the photosensitizer when the film is in a dry state or a non-hydrated state.

The antioxidant agent can be selected from the group consisting of a phenolic antioxidant, a chain terminating antioxidant, a physical quencher of singlet oxygen, a flavonoid, a tocopherol, a carotenoid and an antioxidant enzyme.

In some implementations, the antioxidant agent is selected from the group consisting of vanillin (4-hydroxy-3-methoxybenzaldehyde), o-vanillin (2-hydroxy-3-methoxybenzaldehyde), vanillyl alcohol, tannic acid, gallic acid, propyl gallate, lauryl gallate, carvacrol, eugenol, thymol, lignosulfonate sodium, t-butyl-hydroxyquinone, butylated hydroxytoluene, butylated hydroxyanisole, alpha-tocopherol, D-alpha-tocopheryl polyethylene glycol succinate, retinyl palmitate, beta-carotene, erythorbic acid, sodium erythorbate, sodium ascorbate, ascorbic acid, gluthatione, superoxide dismutase, catalase, sodium azide, 1,4-diazabicyclo[2.2.2]octane (DABCO), and combinations thereof.

In some implementations, the antioxidant agent is a phenolic antioxidant that can be selected from the group consisting of a gallate compound or a derivative thereof, a vanillin compound or a derivative thereof, a tannin compound or a derivative thereof, a lignin compound or derivative thereof, and combinations thereof. Without being limiting, the phenolic antioxidant can be selected from the group consisting of vanillin (4-hydroxy-3-methoxybenzaldehyde), o-vanillin (2-hydroxy-3-methoxybenzaldehyde), vanillyl alcohol, tannic acid, gallic acid, propyl gallate, lauryl gallate, carvacrol, eugenol, thymol, lignosulfonate sodium, and combinations thereof.

In some implementations, the antioxidant agent is a chain terminating antioxidant that can be selected from the group consisting of a thiol-bearing compound (e.g., gluthatione), ascorbic acid or a derivative thereof, and combinations thereof.

In some implementations, the antioxidant agent is a physical quencher of singlet oxygen that can be selected from the group consisting of sodium azide, 1,4-diazabicyclo[2.2.2]octane (DABCO) and a combination thereof.

In some implementations, the antioxidant agent is a flavonoid such as an anthocyanin compound or a derivative thereof.

In some implementations, the antioxidant agent is a tocopherol that can be selected from the group consisting of vitamin E (alpha-tocopherol) or a derivative thereof (e.g., vitamin E TPGS (D-alpha-tocopheryl polyethylene glycol succinate).

In some implementations, the antioxidant agent is a carotenoid that can be selected from the group consisting of beta-carotene, lutein and a combination thereof.

In some implementations, the antioxidant agent is an antioxidant enzyme that can be selected from the group consisting of catalase, superoxide dismutase and a combination thereof.

### Chelating Agent

In some implementations, the compositions of the present description can include a chelating agent (also referred to herein as a permeabilizing agent). In some scenarios, the photosensitizer compound reacts to light by generating ROS, while the chelating agent can increase the overall impact of suppression of the growth of the microbial pathogen, for example by increasing the permeability of the outer membrane of the microbial pathogen to the photosensitizer. It should be understood that the term “chelating agent”, as used herein, refers generally to a compound that can form several chelating bonds to one or several metals or ions.

In some implementations, the chelating agent can include at least one carboxylic group, at least one hydroxyl group, at least one phenol group and/or at least one amino group or an agriculturally acceptable salt thereof. In some implementations, the chelating agent can include an aminocarboxylic acid compound or an agriculturally acceptable salt thereof. The aminocarboxylic acid or agriculturally acceptable salt thereof can include an amino polycarboxylic acid or an agriculturally acceptable salt thereof. For example, the amino polycarboxylic acid can include two amino groups and two alkylcarboxyl groups bound to each amino group. The alkylcarboxyl groups can be methylcarboxyl groups.

In some implementations, the chelating agent is selected from the group consisting of: an aminopolycarboxylic acid, an aromatic or aliphatic carboxylic acid, an amino acid, a phosphonic acid, and a hydroxycarboxylic acid or an agriculturally acceptable salt thereof.

In some implementations, the compositions of the present description include one or more aminopolycarboxylic acid chelating agents. Examples of aminopolycarboxylic acid chelating agents include, without limitation, ethylenediaminetetraacetic acid (EDTA), diethylenetriaminepentaacetic acid (DTPA), hydroxyethylenediaminetriacetic acid (HEDTA), and ethylenediaminedisuccinate (EDDS), cyclohexanediaminetetraacetic acid (CDTA), N-(2-hydroxyethyl)ethylenediaminetriacetic acid (EDTA-OH) glycol ether diaminetetraacetic acid (GEDTA), alanine diacetic acid (ADA), alkoyl ethylene diamine triacetic acids (e.g., lauroyl ethylene diamine triacetic acids (LED3A)), aspartic acid diacetic acid (ASDA), aspartic acid monoacetic acid, diamino cyclohexane tetraacetic acid (CDTA), 1,2-diaminopropanetetraacetic acid (DPTA-OH), I,3-diamino-2-propanoltetraacetic acid (DTPA), diethylene triamine pentam ethylene phosphonic acid (DTPMP), diglycolic acid, dipicolinic acid (DPA), ethanolamine diacetic acid, ethanol diglycine (EDG), ethylenediaminediglutaric acid (EDDG), ethylenediaminedi(hydroxyphenylacetic acid (EDDHA), ethylenediaminedipropionic acid (EDDP), ethylenediaminedisuccinate (EDDS), ethylenediaminemonosuccinic acid (EDMS), ethylenediaminetetraacetic acid (EDTA), ethylenediaminetetrapropionic acid (EDTP), and ethyleneglycolaminoethylestertetraacetic acid (EGTA) and agriculturally acceptable salts (for example, the sodium salts, calcium salts and/or potassium salts) thereof.

One non-limiting example of chelating agent is ethylenediaminetetraacetic acid (EDTA) or an agriculturally acceptable salt thereof. The aminocarboxylate salt can for example be a sodium or calcium salt.

Another non-limiting example of chelating agent is polyaspartic acid or an agriculturally acceptable salt thereof (i.e., a polyaspartate), such as sodium polyaspartate. The molecular weight of the polyaspartate salt can for example be between 2,000 and 3,000.

The chelating agent can thus be a polymeric compound, which can include aspartate units, carboxylic groups, and other features found in polyaspartates. The polyaspartate can be a co-polymer that has alpha and beta linkages, which may be in various proportions (e.g., 30% alpha, 70% beta, randomly distributed along the polymer chain). One non-limiting example of a sodium polyaspartate is Baypure® DS 100.

Other non-limiting examples of chelating agents include EDDS (ethylenediamine-N,N′-disuccinic acid), IDS (iminodisuccinic acid (N-1,2-dicarboxyethyl)-D,L-aspartic acid), isopropylamine, triethanolamine, triethylamine, ammonium hydroxide, tetrabutylammonium hydroxide, hexamine, GLDA (L-glutamic acid N,N-diacetic acid), or agriculturally acceptable salts thereof. The chelating agent can be metallated or non-metallated. In some implementations, IDS can be used as a tetrasodium salt of IDS (e.g., tetrasodium iminodisuccinate), which can be Baypure® CX100. In some implementations, EDDS can be used as a trisodium salt of EDDS. In some implementations, GLDA can be used as a tetrasodium salt of GLDA.

In some implementations, the chelating agent can include one or more amino acid chelating agents. Examples of amino acid chelating agents include, without limitation, alanine, arginine, asparagine, aspartic acid, glutamic acid, glutamine, glycine, histidine, isoleucine, leucine, lysine, methionine, proline, serine, threonine, tyrosine, valine, or salts (for example, the sodium salts, calcium salts and/or potassium salts) and combinations thereof.

In some implementations, the chelating agent can include one or more aromatic or aliphatic carboxylic acid chelating agents. Examples of aromatic or aliphatic carboxylic acid chelating agents include, without limitation, oxalic acid, succinic acid, pyruvic acid malic, acid, malonic acid, salicylic acid, and anthranilic acid, and salts (for example, the sodium salts, calcium salts and/or potassium salts) thereof.

In some implementations, the chelating agent can include one or more hydroxycarboxylic acid chelating agents. Examples of the hydroxycarboxylic acid type chelating agents include, without limitation, malic acid, citric acid, glycolic acid, heptonic acid, tartaric acid and salts (for example, the sodium salts, calcium salts and/or potassium salts) thereof.

It will be understood that the one or more chelating agents can be provided as the free acid, as an agriculturally acceptable salt, or as combinations thereof. In some implementations, each of one or more the chelating agent(s) is applied as the free acid. In other implementations, the chelating agent(s) can be applied as a salt. Exemplary salts include sodium salts, potassium salts, calcium salts, ammonium salts, amine salts, amide salts, and combinations thereof. In still other implementations, when more than one chelating agent is present, at least one of the chelating agents is applied as a free acid, and at least one of the chelating agents is applied as a salt.

### Liquid Carrier

The film-forming compositions of the present description include a liquid carrier that can be present in an amount between 5 wt % and 99.9 wt %, based on the weight of the film-forming composition to be applied to the plant. In some implementations, the liquid carrier can be an aqueous carrier.

It is understood that the term “liquid carrier”, as used herein, refers to a liquid that can solubilize and/or disperse the components of the combinations and compositions of the present description. In some scenarios, the liquid carrier can include water. In other scenarios, the liquid carrier can be free of water. In some implementations, the liquid carrier can include organic solvents that are partially or fully water-soluble, such as methanol, ethanol, propanol or butanol, or polyols such as glycols (e.g., glycerol, propylene glycol, polypropylene glycol). In some implementations, the liquid carrier includes a nontoxic and biodegradable compound that can solubilize and/or disperse the components of the combinations and compositions described herein.

It is understood that the term “aqueous carrier” means a composition including greater than or equal to 50 wt % of water and optionally one or more water-soluble compounds, and/or non-water soluble solvents that can form an emulsion with water and/or that can be dispersed in water. The aqueous carrier is able to solubilize and/or disperse the film-forming agent, photosensitizer and other components of the film-forming composition. When at least a portion of the aqueous carrier is removed, the film-forming agent forms a film that is substantially impermeable to oxygen and that includes the photosensitizer and the other components.

Suitable water-soluble compounds (including partially water-soluble compounds) can include, for example, methanol, ethanol, acetone, methyl acetate, dimethyl sulfoxide or a combination thereof. In some implementations, the aqueous carrier includes equal to or greater than 80 wt % of water, or equal to or greater than 90 wt % of water, or equal to or greater than 95 wt % of water, or equal to or greater than 99 wt % of water, based on the total amount of the aqueous carrier. In some scenarios and depending on the components of the film-forming composition, making use of a water-soluble compound can help solubilize or disperse the photosensitizer compound in the aqueous carrier.

In some implementations, the aqueous carrier can include a compound that is non water-soluble such as an oil. The oil can be dispersed in the water or can form an oil-in-water emulsion. The oil can be selected from the group consisting of a mineral oil (e.g., paraffinic oil), a vegetable oil, an essential oil, and a mixture thereof. In some scenarios and depending on the components of the film-forming composition, making use of an oil can help solubilize or disperse the photosensitizer compound in the aqueous carrier. In other implementations, the aqueous carrier is free of oil.

Non-limiting examples of vegetable oils include oils that contain medium chain triglycerides (MCT), or oil extracted from nuts. Other non-limiting examples of vegetable oils include coconut oil, canola oil, soybean oil, rapeseed oil, sunflower oil, safflower oil, peanut oil, cottonseed oil, palm oil, rice bran oil or mixtures thereof. Non-limiting examples of mineral oils include paraffinic oils, branched paraffinic oils, naphthenic oils, aromatic oils or mixtures thereof.

Non-limiting examples of paraffinic oils include various grades of poly-alpha-olefin (PAO). For example, the paraffinic oil can include HT60™, HT100™, High Flash Jet, LSRD™ and N65DW™. The paraffinic oil can include a paraffin having a number of carbon atoms ranging from about 12 to about 50, or from about 16 to 35. In some scenarios, the paraffin can have an average number of carbon atoms of 23. In some implementations, the oil can have a paraffin content of at least 80 wt %, or at least 90 wt %, or at least 99 wt %.

As used herein, the term “oil-in-water emulsion” refers to a mixture in which the oil is dispersed as droplets in the water. In some implementations, an oil-in-water emulsion is prepared by a process that includes combining the oil, water, and any other components and the oil and applying shear until the emulsion is obtained.

It should be understood that the liquid carrier typically allows obtaining a stable solution, suspension and/or emulsion of the components of the film-forming composition.

### Additives and Adjuvants

In some implementations, the compositions of the present description can include one or more agriculturally suitable adjuvants. Each of the one or more agriculturally suitable adjuvants can be independently selected from the group consisting of one or more activator adjuvants (e.g., one or more surfactants; e.g., one or more oil adjuvants, e.g., one or more penetrants) and one or more utility adjuvants (e.g., one or more wetting or spreading agents; one or more humectants; one or more emulsifiers; one or more drift control agents; one or more thickening agents; one or more deposition agents; one or more water conditioners; one or more buffers; one or more anti-foaming agents; one or more UV blockers; one or more antioxidants; one or more fertilizers, nutrients, and/or micronutrients; and/or one or more herbicide safeners). Exemplary adjuvants are provided in Hazen, J. L. Weed Technology 14: 773-784 (2000), which is incorporated by reference in its entirety.

In some implementations, the composition can also include a surfactant (also referred to as an emulsifier or a dispersing agent). The surfactant can be selected from the group consisting of an ethoxylated alcohol, a polymeric surfactant, a fatty acid ester, a poly(ethylene glycol), an ethoxylated alkyl alcohol, a monoglyceride, an alkyl monoglyceride, an amphipathic glycoside, and a mixture thereof. For example, the fatty acid ester can be a sorbitan fatty acid ester. The surfactant can include a plant derived glycoside such as a saponin. The surfactant can be present as an adjuvant to aid coverage of plant foliage. The surfactant can be an acceptable polysorbate type surfactant (e.g., Tween 80), a nonionic surfactant blend (e.g., Altox™ 3273), or another suitable surfactant. In other implementations, the liquid carrier is free of surfactant.

In some implementations, the poly(ethylene glycol) can include a poly(ethylene glycol) of Formula R¹⁵—O—(CH₂CH₂O)ᵣ—R¹⁶, wherein: each R¹⁵ and R¹⁶ is each, independently, H, alkyl, substituted alkyl, aryl, substituted aryl, CO(alkyl) or CO(substituted alkyl); and f is an integer selected from 1 to 100; wherein the substituted alkyl groups are, independently, substituted with one or more F, Cl, Br, I, hydroxy, alkenyl, CN and N₃.

In some implementations, the composition can include an anti-foaming agent. Non-limiting examples of anti-foaming agents include silicone oils, mineral oils, polydialkylsiloxanes, fatty acids or salts thereof (e.g., salts with polyvalent cations such as calcium, magnesium and aluminum), alkyne diols, fluoroaliphatic esters, perfluoroalkylphosphonic acids or salts thereof, perfluoroalkylphosphinic acids or salts thereof.

In some implementations, the composition can include an antifreeze agent. Non-limiting examples of anti-freeze agents include glycols such as ethylene glycol, diethylene glycol, propylene glycol, dipropylene glycol, glycerol, 1,3-propanediol, 1,2-propanediol and polyethylene glycol.

In some implementations, the composition can include a UV protectant, that can stabilize at least some of the components of the composition from UV light. Non-limiting examples of UV protectants include hindered amine light stabilizers, titanium dioxide, zing oxide, nano titanium dioxide, nano zinc oxide, benzophenones, or a combination thereof.

### Film-Forming Compositions and Combinations

### Single Composition

In some implementations, the film-forming agent, photosensitizer, antioxidant agent and/or other optional components can be formulated as a single composition. In some scenarios, all components can be contained within a storage pack or a vessel suitable for applying the composition to a plant. In some scenarios, the single composition can be a concentrate that is diluted (e.g., with water or additional liquid carrier) prior to application to the plant.

In some implementations, the film-forming composition can include about 0.001 wt % or more, or about 0.01 wt % or more, or about 0.05 wt % or more, or about 0.1 wt % or more, or about 0.25 wt % or more, or about 0.5 wt % or more antioxidant agent, based on a total weight of the film-forming composition. In some implementations, the film-forming composition can include about 0.01 wt % to about 5 wt %, or about 0.01 wt % to about 1 wt %, or about 0.05 wt % to about 0.5 wt %, or about 0.1 wt % to about 0.25 wt %, or about 0.1 wt % to about 0.2 wt % antioxidant agent, based on a total weight of the film-forming composition.

In some implementations, the film-forming composition can include about 0.01 wt % or more, or about 0.05 wt % or more, or about 0.1 wt % or more, or about 0.25 wt % or more, or about 0.5 wt % or more, or about 1 wt % or more, or about 5 wt % or more film-forming agent, based on a total weight of the film-forming composition. In some implementations, the film-forming composition can include about 0.01 wt % to about 20 wt %, or about 0.01 wt % to about 10 wt %, or about 0.05 wt % to about 5 wt %, or about 0.1 wt % to about 1 wt %, or about 0.1 wt % to about 0.5 wt % film-forming agent, based on a total weight of the film-forming composition.

In some implementations, the film-forming composition can include about 0.01 wt % or more, or about 0.05 wt % or more, or about 0.1 wt % or more, or about 0.25 wt % or more, or about 0.5 wt % or more, or about 1 wt % or more, or about 5 wt % or more photosensitizer, based on a total weight of the film-forming composition. In some implementations, the film-forming composition can include about 0.01 wt % to about 10 wt %, or about 0.01 wt % to about 2 wt %, or about 0.05 wt % to about 2 wt %, or about 0.1 wt % to about 1 wt %, or about 0.1 wt % to about 0.5 wt % photosensitizer, based on a total weight of the film-forming composition.

In some implementations, the liquid carrier is present in an amount between 5 wt % and 99.9 wt %, based on a total weight of the film-forming composition. The liquid carrier is able to solubilize and/or disperse the film-forming agent, photosensitizer and other components of the film-forming composition. When at least a portion of the liquid carrier is removed (e.g., by air drying), the film-forming agent forms a film that is substantially impermeable to oxygen and that includes the photosensitizer and the other components.

In some implementations, the film-forming agent and the antioxidant agent can be present in the composition in a weight ratio film-forming agent:antioxidant agent of about 1:1, or about 10:1, or about 20:1, or about 50:1, or about 500:1.

In some implementations, the film-forming agent and the photosensitizer can be present in the composition in a weight ratio film-forming agent:photosensitizer of about 1:1, or about 5:1, or about 10:1, or about 50:1, or about 100:1, or about 1000:1.

In some implementations, the photosensitizer and the film-forming agent can be present in the composition in a weight ratio photosensitizer:antioxidant agent of about 0.1:1, or about 0.2:1, or about 1:1, or about 2:1, or about 10:1, or about 100:1.

### Multiple-Pack Formulations

Alternatively, the film-forming combination of the photosensitizer, film-forming agent, antioxidant, liquid carrier and/or any other suitable component, can be provided as part of a multiple-pack formulation. In some implementations, the components of the film-forming composition that is ultimately present on the plant can be separately packaged and/or stored prior to application to the plant, and the combination can be assembled prior to application to the plant. In other implementations, the components of the film-forming composition that is ultimately present on the plant can be separately packaged and/or stored prior to application to the plant, and can be applied to the plant simultaneously or sequentially, so as to form the film-forming composition upon application to the plant.

For example, the film-forming agent can be packaged on its own, in a dry state or in solution and/or dispersion in an liquid carrier and the photosensitizer and the antioxidant agent can be packaged together, in a dry state or in solution and/or dispersion in a liquid carrier. Any suitable additive and/or adjuvant can be added to either one or both of the packages.

In some implementations, the antioxidant agent and the film-forming agent can be provided in a first pack and the photosensitizer can be provided in a second pack. In other implementations, the antioxidant agent and the photosensitizer can be provided in a first pack and the film-forming agent can be provided in a second pack. In yet other implementations, the film-forming agent and the photosensitizer can be provided in a first pack and the antioxidant agent can be provided in a second pack. It is understood that a liquid carrier can be present in either one of or both of the first pack and the second pack. Water or additional liquid carrier can be added upon combining the first pack and the second pack when forming the composition.

In yet other implementations, the photosensitizer, film-forming agent and antioxidant agent can each be provided in a separate pack. It is understood that a liquid carrier can be present in either one of or all of the separate packs. Water or additional liquid carrier can be added in either one of or all of the packs when forming the composition.

### Mode of Application

The combinations and compositions of the present description can be applied to plants in various ways. For example, and without being limiting, the combinations and compositions of the present description can be applied by spraying, misting, sprinkling, pouring, dipping or any other suitable method. The combinations and compositions can be applied to the foliage, roots and/or stem of the plant.

The plants on which the combinations and compositions are applied can be outdoors or indoors (e.g., greenhouse) where they are exposed to natural sunlight, or in an indoor location where they are exposed to artificial light.

In some scenarios, the combinations and compositions of the present description can be applied directly to the plant, before infestation of the plant by a pest, as a preventative measure. In other scenarios, the combinations and compositions of the present description can be applied at or after infestation of the plant by a pest.

### Stability of the Photosensitizer

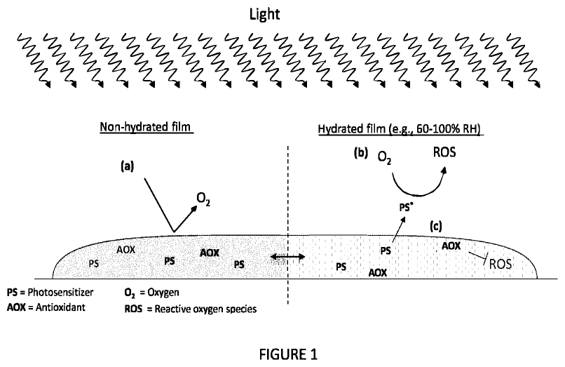

Now referring to FIG. 1, and without being bound to theory, a schematic representation of a film obtained from a film-forming combination or composition of the present description is shown. At (a), a film in a non-hydrated state stabilizes the photosensitizer towards light degradation by minimizing interaction between the photosensitizer and oxygen. The photosensitizer generates less reactive oxygen species when the film is in a non-hydrated state because of the oxygen barrier properties of the film. At (b), a film in a hydrated state (or a film under high relative humidity) results in oxygen penetration and generation of reactive oxygen species. The reactive oxygen species can then protect the plant from various biotic or abiotic stresses. At (c), the antioxidant agent embedded in the film scavenges excess reactive oxygen species in the film to further protect the photosensitizer from being photodegraded when the film is in a hydrated state.

The photosensitizer can therefore be protected in two ways: by the film itself when the film is in a non-hydrated state—the film-forming material is selected such that the film is substantially impermeable to oxygen when in a non-hydrated state; and by the antioxidant when the film is in a hydrated state—the film-forming material is selected such that the film is permeable to oxygen when in a hydrated state (or when the film is under high relative humidity).

It should be understood that the meanings of the terms “hydrated state” and “non-hydrated state” are tied to the nature of the film-forming agent and the properties of the film obtained from the film-forming agent. Indeed, a first film obtained from a first film-forming agent will typically have oxygen barrier properties that are different than a second film obtained from a second film-forming agent. For example, films obtained from certain grades of polyvinyl alcohol typically are substantially impermeable to oxygen when the relative humidity is lower than about 50% RH or 60% RH. Therefore, for films made of certain grades of polyvinyl alcohol, the expression “the film is in a hydrated state” can mean “the film is in an environment of relative humidity between 50% RH and 100% RH”, or “the film is in an environment of relative humidity between 60% RH and 100% RH”. Similarly, the expression “the film is in a non-hydrated state” can mean “the film is in an environment of relative humidity lower than 50% RH” or “the film is in an environment of relative humidity lower than 60% RH. It is understood that each film-forming agent can be provided in a variety of grades, and that each given grade can have a given “hydrated state”/“non-hydrated state” threshold that is specific to said grade. A person skilled in the art would know how to measure the oxygen permeability at different relative humidity levels for a given film-forming agent, and determine the relative humidity at which each film obtained by a given film-forming agent can be considered in a “hydrated state” or in a “non-hydrated state”. One non-limiting example showing how to measure the influence of moisture content on polyvinyl alcohol polymer structures is available in Journal of Coatings Technology and Research, 14, 1345-1355, 2017, which is herein incorporated by reference in its entirety.

It should be understood that the meaning of the term “substantially impermeable to oxygen”, as used herein, refers to the ability of a material (e.g., a film) to block or slow the transmission of oxygen. In the context of the present description, a film can be considered “substantially impermeable to oxygen” when the transmission rate of oxygen through the film is blocked or reduced. In instances where a film includes a photosensitizer, the film can be considered “substantially impermeable to oxygen” when the rate of oxygen-mediated photodegradation of the photosensitizer present in the film is lower than the rate of oxygen-mediated photodegradation of the same photosensitizer that is not present in a film, under otherwise the same conditions (temperature, % RH, pressure etc.). Alternatively, the film can be considered “substantially impermeable to oxygen” when the rate of oxygen-mediated photodegradation of the photosensitizer present in the film is lower than the rate of oxygen-mediated photodegradation of the same photosensitizer that is present in a film that is known to be highly permeable to oxygen (e.g., silicone-based hydrogels), under otherwise the same conditions (temperature, % RH, pressure etc.). It should be understood that the term “impermeable” is not meant to imply that a film that is “substantially impermeable to oxygen” is above or below any particular standard measurement of impermeability.

It should also be understood that the transition between a film in a “hydrated state” and a “non-hydrated state”, and vice-versa, can be a sudden or a continuous transition. For example, when a composition including a film (e.g., in a hydrated state) is applied on a plant and left to air dry at ambient conditions, the film can gradually become less hydrated (i.e., gradually change from a hydrated state to a non-hydrated state) and the oxygen impermeability of the film can gradually increase until reaching an equilibrium value.

When the photosensitizer, film-forming agent, antioxidant agent, liquid carrier and any other component are mixed to form a film-forming composition, the film-forming agent is typically solubilized or dispersed in the liquid carrier. In such case, the antioxidant agent can protect the photosensitizer from being photodegraded in solution or dispersion by reacting with reactive oxygen species formed in the solution or dispersion. When the film-forming composition is applied to a plant, at least a portion of the liquid carrier starts to be removed, for example by air drying. As a portion of the liquid carrier dries, the film-forming agent starts forming a film that includes all the components of the film-forming composition. Prior to obtaining the formed film, the antioxidant agent can protect the photosensitizer from being photodegraded. As the film is formed on the plant and the liquid carrier is at least partially removed, an oxygen barrier is obtained as the film forms and the photosensitizer is protected from being photodegraded as contact between the photosensitizer and oxygen becomes limited.

### Methods for Improving the Health of Plants

In some implementations, there is provided a method for promoting the health of a plant. The method includes applying to the plant a combination or a composition including: a photosensitizer that generates reactive oxygen species in the presence of light and oxygen, the photosensitizer being selected from the group consisting of a porphyrin, a reduced porphyrin and a combination thereof; a film-forming agent; an optional antioxidant; and a liquid carrier in which the photosensitizer, the film-forming agent and the optional antioxidant agent are solubilized and/or dispersed.

The method can further include removing at least a portion of the liquid carrier from the applied composition (i.e., after application to the plant) to form a film that is substantially impermeable to oxygen. Removing at least a portion of the liquid carrier from the applied composition can be performed by any known technique. For example, exposing the plant to a low humidity environment, exposing the plant to heat and/or exposing the plant to a stream of air, inert gas or nitrogen, without damaging the plant. In some implementations, the plant is air dried at ambient conditions. For example, removing at least a portion of the liquid carrier from the applied composition can include allowing the composition to naturally dry on the plant (e.g., naturally dry on the leaves). As the liquid carrier is removed from the applied composition, the film-forming agent forms a film on the plant. For example, the film-forming agent forms a film that is substantially impermeable to oxygen when the liquid carrier (e.g., an aqueous carrier) dries after the composition is applied on the plant.

### Microbial Pathogens

The microbial pathogens to which the composition including the photosensitizer compound can be applied include fungal and bacterial pathogens. In such case, the composition can be referred to as an “anti-microbial composition”.

The fungal pathogens to which the anti-microbial composition can be applied include Alternaria solani, which can infect plants such as tomatoes and potatoes; Botrytis cinerea, which can infect grapes, as well as soft fruits and bulb crops; or Sclerotinia homoeocarpa, which can commonly infect turfgrasses. Other fungal pathogens in the Alternaria, Botrytis or Sclerotinia genera can also receive application of the anti-microbial composition. The anti-microbial composition can be applied to plants that are affected or susceptible to pathogens that cause various plant diseases, e.g., Colletotrichum, Fusarium, Puccinia, Erysiphaceae, Cercospora, Rhizoctonia, Bipolaris, Microdochium, Venturia inaequalis, Monilinia fructicola, Gymnosporangium juniperi-virginianae, Plasmodiophora brassicae, Ustilago zeae, Phytophthora, Pythium, Fusarium oxysporum, Phytophthora infestans, Taphrina deformans, Powdery Mildew, Phragmidium spp., or other fungal pathogens.

The bacterial pathogens to which the anti-microbial composition can be applied include gram-negative bacteria, such as Erwinia amylovara, or other bacterial pathogens in the genus Erwinia that can infect woody plants. E. amylovara causes fire blight on various plants, including pears, apples, and other Rosaceae crops. The anti-microbial composition can be applied to plants that are affected or susceptible to pathogens that cause various plant diseases, e.g., Pseudomonas, Xanthomonas, Agrobacterium, Curtobacterium, Streptomyces, E. Coli, Xylella fastidiosa (which causes Olive Quick Decline Syndrome (OQDS) disease), or other bacterial pathogens.

It is also noted that the anti-microbial compositions described herein can have various inhibitory effects on the microbial pathogens depending on the type of plant and pathogen as well as the state of microbial infection. While herein it is described that the anti-microbial composition can inhibit microbial pathogen growth on a plant, such expressions should not be limiting but should be understood to include suppression of microbial pathogens, prevention against microbial pathogens, killing of microbial pathogens or generally increase toxicity toward microbial pathogens.

### Abiotic Stresses

As mentioned above, in some implementations, the photosensitizer compounds and compositions of the present description can be used to increase tolerance of plants to one or more abiotic stresses such as photooxidative conditions, drought (water deficit), excessive watering (flooding, and submergence), extreme temperatures (chilling, freezing and heat), extreme levels of light (high and low), radiation (UV-B and UV-A), salinity due to excessive Na⁺ (sodicity), chemical factors (e.g., pH), mineral (metal and metalloid) toxicity, deficiency or excess of essential nutrients, gaseous pollutants (ozone, sulfur dioxide), wind, mechanical factors, and other stressors.

### Cold Hardiness

When the abiotic stress is cold stress, application of the photosensitizer compound, alone or in combination with additives such as an oil, a surfactant and/or a chelating agent, can improve cold hardiness of the plant. That is, application of the photosensitizer compound can allow the plant to withstand temperature conditions that are colder than would typically be experienced in the plant's optimal or native growing conditions. Various types of cold stress are possible, such as unexpected frost (for example an early fall frost when healthy crop, fruit, grain, seeds or leaves are still present on the plant, or a late spring frost that occurs after spring plant growth has begun), a cooler than average growing season, colder than native winter conditions, minimal winter snow cover, ice accumulation, etc.

It should be noted that what constitutes a cold stress condition for one plant may not be a cold stress condition for another plant. With reference to the USDA zone map, a cold stress condition for a zone 9 plant may in fact be a native growing condition for a zone 8 plant. Likewise, the depth of snow cover required for survival of one type of plant may not be required for a second type of plant. It is therefore understood that various types of cold stress are possible, depending on the type of plant in question.

The photosensitizer compound, compositions or combinations described herein may be used to protect plants, including woody plants, non-woody plants and turfgrasses, from frost injury. The frost can be an early frost, for example before harvest, after harvest and before dormancy. The frost can be a late frost, for example after budding. The cold damage can also be winter kill induced by winter temperatures, which may result in a loss of viable branches or shoots and lead to plant mortality. Plants treated by the photosensitizer compound, compositions or combinations described herein can be frost or cold sensitive plants, in that they are naturally susceptible to frost, freezing or cold damage or injury in economically or aesthetically significant amounts.

Increasing resistance to cold stress can be exemplified by a delayed onset of dormancy. Plant dormancy can be triggered by a drop in temperature, e.g., the onset of cold stress. By increasing resistance of the plant to cold stress, dormancy of the plant can be delayed until triggered by a further drop in temperature.

The photosensitizer compound, compositions or combinations described herein can be used periodically (e.g., at 2 or 3-week intervals starting with spring at breaking the dormancy) and/or by applying one or more treatments (e.g., 2 in the fall), to provide a response in reducing or delaying the dormancy period of certain plants.

As used herein, the term “reducing dormancy period” refers to a plant that has a reduced dormancy period or extended growing period relative to a control, e.g., a non-treated plant.

In some implementations, the harvesting step may be carried out one week, one month, two months or more after the last application of the photosensitizer compound, compositions or combinations described herein, with the active agent still being effective to reduce the effects of cold stress on the plant during the intervening period.

In some scenarios, resistance to cold stress includes resistance to early or late frost, or winter damage. In some scenarios, the photosensitizer compound, compositions or combinations described herein can be used to protect early growth from cold during fluctuations in temperature (e.g., in early spring). In some scenarios, the photosensitizer compound, compositions or combinations described herein can be used to protect plants from cold during the cold months (e.g., in winter).

In some scenarios, the photosensitizer compound, compositions or combinations described herein can be applied by soil drenching and/or foliar application (e.g., sprayed until run-off) at the onset or prior to exposure to the low temperature (e.g., fall when the trees have full healthy and vigorous foliage). In some scenarios, the photosensitizer compound, compositions or combinations described herein can be applied by soil drenching and/or foliar application (e.g., sprayed until run-off) during late fall and winter (e.g., for warm climates). In some scenarios, the photosensitizer compound, compositions or combinations described herein can be applied by soil drenching in the late fall following by a foliar application (e.g., sprayed until run-off) in the winter in order to reach maximum hardiness.

In some scenarios, the photosensitizer compound, compositions or combinations described herein can be applied 1-4 times at a 1 to 6-month interval (e.g., every 2 to 3 months). Further treatments may be applied in the spring and/or during the growing season to improve resistance to subsequent cold stress conditions.

### Heat Hardiness

When the abiotic stress is heat stress, application of the photosensitizer compound, compositions or combinations described herein can improve tolerance to high temperatures during the growing season. That is, application of the photosensitizer compound, compositions or combinations described herein can allow the plant to withstand temperature conditions that are higher than would typically be experienced in the plant's optimal or native growing conditions. Heat stress can have various causes, such as lack of shade for plants that typically require shaded growing conditions, or higher than normal soil and air temperatures.

It should be noted that what constitutes a heat stress condition for one plant may not be a heat stress condition for another plant.

### Photooxidative Hardiness

When the abiotic stress is photooxidative stress, application of the photosensitizer compound, compositions or combinations described herein can improve tolerance to stressful light condition during periods of increased generation of reactive oxygen species. That is, application of the photosensitizer compound, compositions or combinations described herein can allow the plant to withstand light exposure conditions (e.g., ultraviolet irradiation conditions) that are higher than would typically be experienced in the plant's optimal or native growing conditions. Photooxidative stress can have various causes, such as high light conditions or certain types of lighting that induce formation of free radicals.

It should be noted that what constitutes a photooxidative stress condition for one plant may not be a photooxidative stress condition for another plant.

### Shade Hardiness

Shade stress, or “low light (LL) stress” can be a problem that influences plant growth and quality. When the abiotic stress is shade stress, application of the photosensitizer compound, compositions or combinations described herein can improve shade hardiness of the plant. That is, application of the photosensitizer compound, compositions or combinations described herein can allow the plant to withstand shady conditions for plants whose optimal or native growing conditions typically require partial or full sun exposure. Various types of shade stress are possible, such as a prolonged period of cloudy weather, excessive growth of adjacent plants or trees that cast shade onto the plant, or lack of availability of a sunny planting location.

Shade can be a periodic problem. For example, during certain months of the year, a structure situated near a plant may cast a shadow on the plant, causing a shade stress. As the earth moves over the course of a year, the structure may no longer cast the shadow on the plant for another series of months and then the situation can be repeated during the next annual cycle. In such instances, the photosensitizer compound, compositions or combinations described herein can be applied to the plant prior to onset of the period of shade stress and can also be applied during the period of shade stress. The damage to the plant that would typically result on account of the period of shade stress can be prevented or reduced.

Shade conditions are not considered to be an abiotic stress condition for many types of plants, as some plants have a requirement for shade as part of their optimal growing conditions. It should also be noted that what constitutes a shade stress condition for one plant may not be a shade stress condition for another plant.

### Drought Hardiness

Drought can be defined as the absence of rainfall or irrigation for a period of time sufficient to deplete soil moisture and injure plants. Drought stress results when water loss from the plant exceeds the ability of the plant's roots to absorb water and/or when the plant's water content is reduced enough to interfere with normal plant processes. The severity of the effect of a drought condition may vary between plants, as the plant's need for water may vary by plant type, plant phenological stage, plant age, root depth, soil quality, etc.

The photosensitizer compound, compositions or combinations described herein can be applied to a plant prior to onset of a drought and/or during a drought. Application of the photosensitizer compound, compositions or combinations described herein can increase the resistance of the plant to the drought stress. Increasing resistance can include maintaining or increasing a quality of the plant as compared to an untreated plant subjected to the same drought stress. Increasing resistance can include reducing the degradation in quality of the plant, as compared to an untreated plant subjected to the same drought stress. If plants do not receive adequate rainfall or irrigation, the resulting drought stress can reduce growth more than all other environmental stresses combined.

It should also be noted that what constitutes a drought stress condition for one plant may not be a drought stress condition for another plant.

### Prevention of Salt Damage

Salts can be naturally present in the growing environment of a plant. Salinity stress refers to osmotic forces exerted on a plant when the plant is growing in a saline soil or under other excessively saline conditions. For example, plants growing near a body of salt water can be exposed to salt present in the air or in water used to water the plants. In another example, salt applied to road, sidewalk and driveway surfaces during the winter for improved driving conditions can be transferred and/or leach into the soil of plants growing in the proximity. Such increased salt content in a growing environment of the plant can result in salinity stress, which can damage the plant.

Application of the photosensitizer compound, compositions or combinations described herein to the plant can increase the plant's resistance to the salinity stress and prevent or reduce a deterioration in quality of the plant which would occur if untreated. The combination can be applied prior to or during the period of salinity stress.

It should also be noted that what constitutes a salt stress condition for one plant may not be a salt stress condition for another plant.

### Transplant Shock Hardiness

A plant that is subjected to transplanting from one growing environment to another, e.g., from a pot to flower bed or garden, can be subjected to transplant shock stress as a result of exposure to new environmental conditions such as wind, direct sun, or new soil conditions. Application of the photosensitizer compound, compositions or combinations described herein to the roots of the plant can reduce the impact to the plant caused by the transplanting. In some scenarios, stunting of plant growth and/or development of a transplanted plant can be reduced or prevented by application of the photosensitizer compound, compositions or combinations described herein.

It should be noted that what constitutes a transplant shock stress condition for one plant may not be a transplant shock stress condition for another plant.

### Excess Water or Flooding Hardiness

Although plants require a certain volume of water for healthy plant growth and development, the exposure of a plant to excess volumes of water (“water stress”) can damage the plant. Application of the photosensitizer compound, compositions or combinations described herein to a plant prior to the onset of an excess water condition can increase the plant's resistance to the water stress. The photosensitizer compound, compositions or combinations described herein can be applied during the water stress, however, dilution of the photosensitizer compound, compositions or combinations described herein may occur on account of the excess water. Accordingly, pre-treatment in advance of a period of excess water can be more effective.

It should be noted that what constitutes an excess water stress condition for one plant may not be an excess water stress condition for another plant.

### Insecticide Activity

In some implementations, the compounds and combinations of the present description can be used to protect the plant from an insect plant pest. In should be understood that the term “insect plant pest” or “insect pest”, as used herein, refers to insects and/or their larvae, which are known to or have the potential to cause damage to the plant. In some implementations, the compounds and combinations of the present description can induce photoinduced mortality in insect pest.

In some implementations, the insect pests are selected from the order of Hemiptera (groups of aphids, whiteflies, scales, mealybugs, stink bugs), Coleoptera (groups of beetles), Lepidoptera (groups of butterflies, moths), Diptera (groups of flies), Thysanoptera (group of thrips), Orthoptera (group of grasshoppers, locusts), Hymenoptera (groups of wasps, ants), Blattodea (groups of cockroaches and termites) and mite pests (spider mites).

Non-limiting examples of insect pests include: larvae of the order Lepidoptera, such as armyworms, (e.g., beet armyworm (Spodoptera exigua)), cutworms, loopers, (e.g., cabbage looper (Trichoplusia ni)) and heliothines, in the family Noctuidae (e.g., fall armyworm (Spodoptera fugiperda J. E. Smith)), beet armyworm (Spodoptera exigua Hubner), black cutworm (Agrotis ipsilon Hufnagel), and tobacco budworm (Heliothis virescens Fabricius); borers, casebearers, webworms, coneworms, cabbageworms and skeletonizers from the family Pyralidae (e.g., European corn borer (Ostrinia nubilalis Hubner)), navel orangeworm (Amyelois transitella Walker), corn root webworm (Crambus caliginosellus Clemens), and sod webworms (Pyralidae: Crambinae) such as sod webworm (Herpetogramma licarsisalis Walker), leafrollers, budworms, seed worms, and fruit worms in the family Tortricidae (e.g., codling moth (Cydia pomonella Linnaeus)), grape berry moth (Endopiza viteana Clemens), oriental fruit moth (Grapholita molesta Busck) and many other economically important Lepidoptera (e.g., diamondback moth (Plutella xylostella Linnaeus)), pink bollworm (Pectinophora gossypiella Saunders), and gypsy moth (Lymantria dispar Linnaeus); foliar feeding larvae and adults of the order Coleoptera including weevils from the families Anthribidae, Bruchidae, and Curculionidae (e.g., boll weevil (Anthonomus grandis Boheman)), rice water weevil (Lissorhoptrus oryzophilus Kuschel), granary weevil (Sitophilus granarius Linnaeus), rice weevil (Sitophilus oryzae Linnaeus), annual bluegrass weevil (Listronotus maculicollis Dietz), bluegrass billbug (Sphenophorus parvulus Gyllenhal), hunting billbug (Sphenophorus venatus vestitus), Denver billbug (Sphenophorus cicatristriatus Fahraeus), flea beetles, cucumber beetles, rootworms, leaf beetles, Colorado potato beetles (Leptinotarsa decemlineata), and leafminers in the family Chrysomelidae, western corn rootworm (Diabrotica virgifera virgifera LeConte); chafers and other beetles from the family Scaribaeidae (e.g., Japanese beetle (Popillia japonica Newman)), oriental beetle (Anomala orientalis Waterhouse), northern masked chafer (Cyclocephala borealis Arrow), southern masked chafer (Cyclocephala immaculate Olivier), black turfgrass ataenius (Ataenius spretulus Haldeman), green June beetle (Cotinis nitida Linnaeus), Asiatic garden beetle (Maladera castanea Arrow), May/June beetles (Phyllophaga spp.) and European chafer (Rhizotrogus majalis Razoumowsky)); carpet beetles from the family Dermestidae; wireworms from the family Elateridae; bark beetles from the family Scolytidae; flour beetles from the family Tenebrionidae; adults and nymphs of the order Orthoptera including grasshoppers, locusts, and crickets (e.g., migratory grasshoppers (e.g., Melanoplus sanguinipes Fabricius, M. differentialis Thomas)), American grasshoppers (e.g., Schistocerca americana Drury), desert locust (Schistocerca gregaria Forskal), migratory locust (Locusta migratoria Linnaeus), bush locust (Zonocerus spp.); adults and larvae of the order Diptera including leafminers, midges, fruit flies (Tephritidae), fruit flies (e.g., Oscinella frit Linnaeus), soil maggots; adults and nymphs of the orders Hemiptera and Homoptera such as plant bugs from the family Miridae, leafhoppers (e.g., Empoasca spp.) from the family Cicadellidae; planthoppers from the families Fulgoroidae and Delphacidae (e.g., corn plant hopper (Peregrinus maidis)); treehoppers from the family Membracidae; chinch bugs (e.g., hairy chinch bug (Blissusleucopterus hirtus Montandon) and southern chinch bug (Blissus insularis Barber) and other seed bugs from the family Lygaeidae; spittlebugs from the family Cercopidae; squash bugs from the family Coreidae; red bugs and cotton stainers from the family Pyrrhocoridae; mealybugs from the family Pseudococcidae (e.g. Planicoccus citri Risso), cicadas from the family Cicadidae; psyllids from the family Psyllidae(e.g. Citrus psyllid Diaphorina citri)), whiteflies from the family Aleyrodidae (silverleaf whitefly (Bemisia argentifolil)); aphids from the family Aphididae, such as cotton melon aphid (Aphis gossypii), pea aphid (Acyrthisiphon pisum Harris), cowpea aphid (Aphis craccivora Koch), black bean aphid (Aphis fabae Scopoli), melon or cotton aphid (Aphis gossypii Glover), apple aphid (Aphis pomi De Geer), spirea aphid (Aphis spiraecola Patch), foxglove aphid (Aulacorthum solani Kaltenbach), strawberry aphid Chaetosiphon fragaefolii Cockerell), Russian wheat aphid (Diuraphis noxia Kurdjumov/Mordvilko), rosy apple aphid (Dysaphis plantaginea Paaserini), woolly apple aphid (Eriosoma lanigerum Hausmann), mealy plum aphid (Hyalopterus pruni Geoffroy), turnip aphid (Lipaphis erysimi Kaltenbach), cereal aphid (Metopolophium dirrhodum Walker), potato aphid (Macrosipum euphorbiae Thomas), peach-potato and green peach aphid (Myzus persicae Sulzer), lettuce aphid (Nasonovia ribisnigri Mosley), root aphids and gall aphids, corn leaf aphid (Rhopalosiphum maidis Fitch), bird cherry-oat aphid (Rhopalosiphum padi Linnaeus), greenbug (Schizaphis graminum Rondani), English grain aphid (Sitobion avenae Fabricius), spotted alfalfa aphid (Therioaphis maculata Buckton), black citrus aphid (Toxoptera aurantii Boyer de Fonscolombe), brown citrus aphid (Toxoptera citricida Kirkaldy) and green peach aphid (Myzus persicae); phylloxera from the family Phylloxeridae; mealybugs from the family Pseudococcidae; scales from the families Coccidae, Diaspididae, and Margarodidae; lace bugs from the family Tingidae; stink bugs from the family Pentatomidae; adults and immatures of the order Thysanoptera including onion thrips (Thrips tabaci Lindeman), flower thrips (Frankliniella spp.), and other foliar feeding thrips. Agronomic pests also include invertebrate arthropods such as mites from the family Tetranychidae: twospotted spider mite (e.g. Tetranychus urticae Koch), flat mite from family Rutacea (e.g., citrus flat mite (Brevipalpus lewisi McGregor); rust and bud mites from the family Eriophyidae and other foliar feeding mites. Economically important agricultural pests nematodes (e.g., root knot nematodes in the genus Meloidogyne, lesion nematodes in the genus Pratylenchus, and stubby root nematodes in the genus Trichodorus) and members of the classes Nematoda, Cestoda, Trematoda, and Acanthocephala from orders of Strongylida, Ascaridida, Oxyurida, Rhabditida, Spirurida, and Enoplida.

### Types of Plants

The photosensitizer compounds and compositions of the present description can be used for various types of plants. The plant can be a non-woody crop plant, a woody plant or a turfgrass. The plant can be selected from the group consisting of a crop plant, a fruit plant, a vegetable plant, a legume plant, a cereal plant, a fodder plant, an oil seed plant, a field plant, a garden plant, a green-house plant, a house plant, a flower plant, a lawn plant, a turfgrass, a tree such as a fruit-bearing tree, and other plants that may be affected by microbial pathogens and/or one or more abiotic stress. Some of the compounds of the present description can display a certain degree of toxicity against a variety of noxious plant pests, in the absence or presence of light.

In some implementations, the plant is a crop plant selected from the group consisting of sugar cane, wheat, rice, corn (maize), potatoes, sugar beets, barley, sweet potatoes, cassava, soybeans, tomatoes, and legumes (beans and peas).

In other implementations, the plant is a tree selected from the group consisting of deciduous trees and evergreen trees. Examples of trees include, without limitation, maple trees, fruit trees such as citrus trees, apple trees, and pear trees, an oak tree, an ash tree, a pine tree, and a spruce tree.

In yet other implementations, the plant is a shrub.

In yet other implementations, the plant is a fruit or nut plant. Non-limiting examples of such plants include: acerola (barbados cherry), atemoya, carambola (star fruit), rambutan, almonds, apricots, cherries, nectarines, peaches, pistachio, apples, avocados, bananas, plantains, figs, grapes, mango, olives, papaya, pears, pineapple, plums, strawberries, grapefruit, lemons, limes, oranges (e.g., navel and Valencia), tangelos, tangerines, mandarins and plants from the berry and small fruits plant group.

In other implementations, the plant is a vegetable plant. Non-limiting examples of such plants include: asparagus, bean, beets, broccoli, Chinese broccoli, broccoli raab, brussels sprouts, cabbage, cauliflower, Chinese cabbage (e.g., bok choy and mapa), Chinese mustard cabbage (gai choy), cavalo broccoli, collards, kale, kohlrabi, mizuna, mustard greens, mustard spinach, rape greens, celery, chayote, Chinese waxgourd, citron melon, cucumber, gherkin, hyotan, cucuzza, hechima, Chinese okra, balsam apple, balsam pear, bitter melon, Chinese cucumber, true cantaloupe, cantaloupe, casaba, crenshaw melon, golden pershaw melon, honeydew melon, honey galls, mango melon, Persian melon, pumpkin, summer squash, winter squash, watermelon, dasheen (taro), eggplant, ginger, ginseng, herbs and spices (e.g., curly leaf basil, lemon balm, cilantro, Mexican oregano, mint), Japanese radish (daikon), lettuce, okra, peppers, potatoes, radishes, sweet potatoes, Chinese artichoke (Japanese artichoke), corn and tomatoes.

In other implementations, the plant is a flowering plant, such as roses, flowering shrubs or ornamentals. Non-limiting examples of such plants include: flowering and foliage plants including roses and other flowering shrubs, foliage ornamentals & bedding plants, fruit-bearing trees such as apple, cherry, peach, and pear trees, non-fruit-bearing trees, shade trees, ornamental trees, and shrubs (e.g., conifers, deciduous and broadleaf evergreens & woody ornamentals).

In some implementations, the plant is a houseplant. Non-limiting examples of such plants include: chrysanthemum, dieffenbachia, dracaena, ferns, gardenias, geranium, jade plant, palms, philodendron, and schefflera.

In some implementations, the plant is a plant grown in a greenhouse. Non-limiting examples of such plants include: ageratum, crown of thorns, dieffenbachia, dogwood, dracaena, ferns, ficus, holly, lisianthus, magnolia, orchid, palms, petunia, poinsettia, schefflera, sunflower, aglaonema, aster, azaleas, begonias, browallia, camellias, carnation, celosia, chrysanthemum, coleus, cosmos, crepe myrtle, dusty miller, easter lilies, fuchsia, gardenias, gerbera, hellichrysum, hibiscus foliage, hydrangea, impatiens, jade plant, marigold, new guinea, impatiens, nicotonia, philodendron, portulaca, reiger begonias, snapdragon, and zinnias.

In some implementations, the plant can be a seed or a seedling. In such case, the composition can be a seed-coating composition. In other implementations, the plant is a grown plant and the composition is applied directly to the grown plant. It is understood that a grown plant is a plant that has grown beyond the seed or seedling stage.

In some implementations, the compositions of the present description are applied to a non-regenerable part of the plant. It is understood that the term “non-regenerable part of the plant” refers to a part of a plant from which a whole plant cannot be grown or regenerated when the part of the plant is placed in a growing medium. In some implementations, the compositions of the present description can be applied to a non-regenerable part of a grown plant (e.g., the foliage of a grown plant).

### Synergistic Effect of the Combinations

In some scenarios, the combinations can exhibit a synergistic response for inhibiting growth of microbial pathogens in plants. It should be understood that the terms “synergy” or “synergistic”, as used herein, refer to the interaction of two or more components of a combination (or composition) so that their combined effect is greater than the sum of their individual effects. This may include, in the context of the present description, the action of two or more of the photosensitizer, film-forming agent, antioxidant agent, the oil, and the chelating agent. In some scenarios, the nitrogen-bearing macrocyclic compound and the film-forming agent can be present in synergistically effective amounts. In some scenarios, the photosensitizer and the antioxidant agent can be present in synergistically effective amounts. In some scenarios, the film-forming agent and the antioxidant agent can be present in synergistically effective amounts. In some scenarios, the photosensitizer, the film-forming agent and the antioxidant agent can be present in synergistically effective amounts.

In some scenarios, the approach as set out in S. R. Colby, “Calculating synergistic and antagonistic responses of herbicide combinations”, Weeds 15, 20-22 (1967), can be used to evaluate synergy. Expected efficacy, E, may be expressed as: E=X+Y(100−X)/100, where X is the efficacy, expressed in % of the untreated control, of a first component of a combination, and Y is the efficacy, expressed in % of the untreated control, of a second component of the combination. The two components are said to be present in synergistically effective amounts when the observed efficacy is higher than the expected efficacy.

### EXAMPLES

### General Procedures and Formulations

### Chlorophyllin—PVOH—Tannic Acid Formulations

The preparation of a formulation which exhibits photostabilization of a light-activated photosensitizer is described through the following example method: This example describes the preparation of a (0.1% magnesium chlorophyllin+0.5% polyvinylalcohol (89 kDa; 99%+hydrolysis, PVOH89-h)+0.05% Tannic acid) formulation. Firstly, a 5 wt % PVOH89-h solution was prepared by slowly adding 5 g of PVOH89-h solid to a beaker filled with 95 g deionized water (dH₂O) with mixing. This beaker was heated to a temperature of 95° C. and mechanically stirred for 1 h. The dissolved solution was cooled and transferred to a clean glass bottle for use. Secondly, a 1 wt % tannic acid solution was prepared by dissolving 1 g of tannic acid (Sigma-Aldrich, St. Louis, MO) in 99 g dH₂O and used without further processing. Thirdly, a 1 wt % magnesium chlorophyllin, sodium salt stock solution was prepared by adding 1 g of magnesium chlorophyllin to 99 g of dH₂O. To a 10 g glass vial, 1 g of 1% magnesium chlorophyllin was added to 8 g dH₂O, followed by the addition of 0.5 g of 5% PVOH89-h and 0.5 g of 1% tannic acid solution. The vial was capped, mixed and used within 1 week of preparation.

It is understood that other (photosensitizer+water-absorbing polymer+optional antioxidant+optional additional components) solutions can be formulated with the above-described method. The following formulations were prepared using the above method. All percentage values before a component of the formulation indicate wt % values, based on the total weight of the formulation. The percentage values 99% h, 89% h indicate a hydrolysis % for the PVOH. MgChln means Magnesium chlorin e6; AlChln means Aluminum chlorin e6.

$$0.1 \% MgChln + 0.05 \% PVOH ( 89 kDa 99 \% h ) ; \\ 0.1 \% MgChln + 0 \text{.1} \% PVOH ( 89 kDa 99 \% h ) ; \\ 0 \text{.1} \% MgChln + 0.25 \% PVOH ( 89 kDa 99 \% h ) ; \\ 0.1 \% MgChln + 0 \text{.5} \% PVOH ( 89 kDa 99 \% h ) ; \\ 0 \text{.1} \% MgChln + 0 \text{.5} \% PVOH ( 89 kDa 99 \% h ) + 0.01 \% Tannic acid ; \\ 0.1 \% MgChln + 0 \text{.5} \% PVOH ( 89 kDa 99 \% h ) + 0.05 \% Tannic acid ; \\ 0.1 \% MgChln + 0 \text{.5} \% PVOH ( 13 kDa 99 \% h ) ; \\ 0.1 \% MgChln + 0 \text{.5} \% PVOH ( 31 kDa 99 \% h ) ; \\ 0 \text{.1} \% MgChln + 0 \text{.5} \% PVOH ( 146 kDa 99 \% h ) ; \\ 0.1 \% MgChln + 0 \text{.5} \% PVOH ( 13 kDa 89 \% h ) ; \\ 0.1 \% MgChln + 0 \text{.5} \% PVOH ( 31 kDa 89 \% h ) ; \\ 0.1 \% MgChln + 0 \text{.5} \% PVOH ( 89 kDa 89 \% h ) ; \\ 0.1 \% MgChln + 0 \text{.5} \% PVOH ( 146 kDa 89 \% h ) ;$$

$$0 \text{.1} \% MgChln + 0 \text{.5} \% PVOH ( 13 kDa 99 \% h ) + 0.05 \% Tannic acid ; \\ 0.1 \% MgChln + 0 \text{.5} \% PVOH ( 31 kDa 99 \% h ) + 0.05 \% Tannic acid ; \\ 0.1 \% MgChln + 0 \text{.5} \% PVOH ( 89 kDa 99 \% h ) + 0.05 \% Tannic acid ; \\ 0.1 \% MgChln + 0 \text{.5} \% PVOH ( 146 kDa 99 \% h ) + 0.05 \% Tannic acid ; \\ 0.1 \% MgChln + 0 \text{.5} \% PVOH ( 13 kDa 89 \% h ) + 0.05 \% Tannic acid ; \\ 0 \text{.1} \% MgChln + 0 \text{.5} \% PVOH ( 31 kDa 89 \% h ) + 0.05 \% Tannic acid ; \\ 0 \text{.1} \% MgChln + 0 \text{.5} \% PVOH ( 89 kDa 89 \% h ) + 0.05 \% Tannic acid ; \\ 0.1 \% MgChln + 0 \text{.5} \% PVOH ( 146 kDa 99 \% h ) + 0.05 \% Tannic acid ;$$

$$0 \text{.1} \% MgChln + 0 \text{.5} \% PVOH ( 146 kDa 99 \% h ) + 0.05 \% Tannic acid + 0.05 \% Glycerol ; \\ 0 \text{.1} \% MgChln + 0 \text{.5} \% PVOH ( 146 kDa 89 \% h ) + 0.05 \% Tannic acid + 0.1 \% Glycerol ; \\ 0 \text{.1} \% MgChln + 0 \text{.5} \% PVOH ( 146 kDa 99 \% h ) + 0.05 \% Tannic acid + 0.05 \% Propylene glycol ; \\ 0 \text{.1} \% MgChln + 0 \text{.5} \% PVOH ( 146 kDa 89 \% h ) + 0.05 \% Tannic acid + 0.1 \% Propylene glycol ; \\ 0 \text{.03} \% MgChln + 0 \text{.5} \% PVOH ( 89 kDa 99 \% h ) ; \\ 0 \text{.03} \% MgChln + 0.1 \% PVOH ( 89 kDa 99 \% h ) ; \\ 0 \text{.03} \% MgChln + 0.1 \% Vanillin ; \\ 0.03 \% MgChln + 0 \text{.5} \% PVOH ( 89 kDa 99 \% h ) + 0.1 \% Vanillin ;$$

$$0 \text{.03} \% MgChln + 0.25 \% PVOH ( 89 kDa 99 \% h ) + 0.05 \% Tannic acid ; \\ 0 \text{.75} \% MgChln + 0.5 \% Vanillin ; \\ 0 \text{.1} \% MgChln + 0.5 \% PVOH ( 89 kDa 89 \% h ) + 0.05 \% Tannic acid + 0.05 \% NaEDTA ; \\ 0 \text{.1} \% MgChln + 0.5 \% PVOH ( 89 kDa 89 \% h ) + 0.05 \% Tannic acid + 0.1 \% NaEDTA ; \\ 0 \text{.1} \% MgChln + 0.5 \% PVOH ( 89 kDa 89 \% h ) + 0.05 \% Tannic acid + 0.1 \% {Pluronics ™}^{} F - 127 ; \\ 0 \text{.1} \% MgChln + 0.5 \% PVOH ( 89 kDa 89 \% h ) + 0.05 \% Tannic acid + 0.1 \% Breakthru ™ SD260$$

$$0.1 \% MgChln + 0.5 \% PVOH ( 89 kDa 89 \% h ) + 0.05 \% Tannic acid + 0.1 \% + Xiameter ™ OFX - 309 ;$$

$$0 \text{.1} \% MgChln + 0.5 \% PVOH ( 89 kDa 89 \% h ) + 0.05 \% Tannic acid + 0.1 \% Saponin \\ 0 \text{.1} \% MgChln + 0.5 \% PVOH ( 89 kDa 89 \% h ) + 0.05 \% Tannic acid + 0.1 \% Morwet ™ D - 400 ; \\ 0 \text{.1} \% MgChln + 0.5 \% PVOH ( 89 kDa 89 \% h ) + 0.05 \% Tannic acid + 0.1 \% Brij ™ O 10 ;$$

$$0 \text{.1} \% MgChln + 0.5 \% Galactasol 40 HFDS + 0.05 \% Tannic acid ; \\ 0 \text{.1} \% MgChln + 0.5 \% Carboxymethylcellulose + 0.05 \% Tannic acid ; \\ 0.1 \% MgChln + 0.5 \% ( Poly ( vinyl alcohol - co - ethylene ) ( 27 mol \% ethylene ) + 0.05 \% Tannic acid ; \\ 0.1 \% MgChln + 0.5 \% Solubon ™ PT401 + 0.05 \% Tannic acid ; \\ 0 \text{.1} \% Chlorin e6 sodium salt + 0.25 \% PVOH ( 89 kDa 89 \% h ) + 0.05 \% Tannic acid ; \\ 0 \text{.1} \% Chlorin e6 dimethylaminoethyl + 0.25 \% PVOH ( 89 kDa 89 \% h ) + 0.05 \% Tannic acid ; \\ 0 \text{.1} \% AlChln + 0.25 \% PVOH ( 89 kDa 99 \% h ) + 0.05 \% Tannic acid ; \\ 0 \text{.1} \% MgChln + 0.25 \% PVOH ( 89 kDa 99 \% h ) + 0.05 \% Gall ic acid ; 0.1 \% MgChln + 0.25 \% PVOH ( 89 kDa 99 \% h ) + 0.05 \% propyl gallate ; 0 \text{.1} \% MgChln + 0.25 \% PVOH ( 89 kDa 99 \% h ) + 0.05 \% vanillin ; 0 \text{.1} \% MgChln + 0.25 \% PVOH ( 89 kDa 99 \% h ) + 0.05 \% vinyl alcohol ; and \\ 0 \text{.1} \% MgChln + 0.25 \% PVOH ( 89 kDa 99 \% h ) + 0.05 \% Borresperse ™ NA .$$

### Method A: Evaluating Photostability in a Non-Hydrated State (Also Referred to as “Solid State”)

Fifty microlitres of each formulation was pipetted into 12 wells of a 96-well clear-bottom black microplate (Thomas Scientific, Swedesboro, NJ) and dried into thin films using a dehydrator (Gourmia GFD1680) at a temperature of 45° C. for 3 h. At the beginning of the experiment, the microplate was placed under a Heliospectra RX30 LED light array (Heliospectra, San Raphael, CA). The LED array was adjusted such that the microplates received on average 1300 μmol/m²/s of light intensity. The microplate was tightly covered with aluminum foil and at select intervals peeled back to irradiate films with either Oh, 24 h, 48 h or 72 h of light. Upon completion of light irradiation, contents in each well were redissolved with 100 μL of boiling dH₂O and mixed until complete rehydration. An absorbance spectral scan was conducted on the microplate (350-750 nm) using a plate reader (Spectramax M2E, Molecular Devices, San Jose, CA) and the peak intensity was monitored at 24 h, 48 h and/or 72 h timepoints and compared with the corresponding Oh timepoint to determine the degree of photodegradation. The % photosensitizer remaining after irradiation was calculated using the following equation:

$$\% Photosensitizer remaining = ( \frac{A b {s}_{t}}{A b {s}_{0}} ) \times 100$$

where Absₜ is the absorbance peak of the sample receiving t hours of light exposure; Abs₀ is the absorbance peak of the sample receiving no light exposure. All data is expressed as mean±standard deviation.

### Method B: Evaluating Photostability in Solution (Also Referred to as “Liquid State”)

Fifty microlitres of each formulation was pipetted into 12 wells of a 96-well clear-bottom black microplate (Thomas Scientific, Swedesboro, NJ), followed by the addition of 50 μL dH₂0. The sample was sealed with a microplate clear adhesive film to minimize water evaporation. At the beginning of experiment, the microplate was placed under a Heliospectra RX30 LED light array (Heliospectra, San Raphael, CA). The LED array was adjusted such that the microplates received on average 1300 μmol/m²/s of light intensity. The microplate was tightly covered with aluminum foil and at select intervals peeled back to irradiate films with either Oh, 2 h, 4 h or 6 h of light. Upon completion of light irradiation, the adhesive film was removed and sample absorbance were determined using a plate reader (Spectramax M2E, Molecular Devices, San Jose, CA) in each well were redissolved with 100 μL of boiling deionized water (dH₂O) and mixed until complete rehydration. An absorbance spectral scan was conducted on the microplate (350-750 nm) and the peak intensity was monitored at 2 h, 4 h and 8 h timepoints and compared with the corresponding Oh timepoint to determine the degree of photodegradation. The % photosensitizer remaining after irradiation was calculated using the following equation:

$$\% Photosensitizer remaining = ( \frac{A b {s}_{t}}{A b {s}_{0}} ) \times 100$$

where Absₜ is the absorbance peak of the sample receiving t hours of light exposure; Abs₀ is the absorbance peak of the sample receiving no light exposure. All data is expressed as mean±standard deviation.

### Example 1

Solid state photostability of several formulations with varying PVOH (89kDA; >99% hydrolysis), contents were evaluated using Method A. The results are summarized in Table 1 below:

TABLE 1
Effect of polyvinyl alcohol (89 kDa; >99% hydrolysis) (PVOH)
on photostabilization of MgChln after 72 h of light irradiation

| | Polyvinyl alcohol | % photosensitizer |
|---|---|---|
| | 89 kDa (99% + | remaining at 72 h |
| Treatment | hydrolysis) | (solid state) |
| 0.1% MgChln | — | 46.0 ± 1.8 |
| 0.1% MgChln + 0.05% PVOH | 0.05% | 51.0 ± 2.4 |
| 0.1% MgChln + 0.1% PVOH | 0.10% | 62.0 ± 5.0 |
| 0.1% MgChln + 0.25% PVOH | 0.25% | 76.7 ± 5.5 |
| 0.1% MgChln + 0.5% PVOH | 0.50% | 78.8 ± 3.5 |

### Example 2

Solid state and liquid state photostability of several formulations with PVOH (146 kDa; >99% hydrolysis) and varying antioxidant content (phenolic antioxidant Tannic acid) were evaluated using Method A and Method B. The results are summarized in Table 2 below.

TABLE 2
Effect of polyvinyl alcohol (146 kDa; >99% hydrolysis)
(PVOH) and phenolic antioxidant, Tannic acid, on the photostabilization
of MgChln in the solid and liquid states after 72 h and
6 h simulated sunlight irradiation, respectively

| | % photosensitizer | % photosensitizer |
|---|---|---|
| | remaining at 72 h | remaining at 6 h |
| Treatment | (solid state) | (liquid state) |
| 0.1% MgChln | 29.1 ± 2 | 35.2 ± 2.1 |
| 0.1% MgChln + 0.5% PVOH | 97.2 ± 4.1 | 34.5 ± 2.2 |
| 0.1% MgChln + 0.5% PVOH + | 86.5 ± 8.1 | 45.2 ± 2.8 |
| 0.01% Tannic acid | | |
| 0.1% MgChln + 0.5% PVOH + | 90.7 ± 7.4 | 76.3 ± 7.5 |
| 0.05% Tannic acid | | |

### Example 3

Solid and liquid state photostability of several formulations with PVOH having varied molecular weight and degree of hydrolysis were evaluated using Method A and Method B. The results are summarized in Table 3 below.

TABLE 3
Effect of polyvinyl alcohol (PVOH) molecular weight, degree of hydrolysis and addition
of phenolic antioxidant, tannic acid on the photostabilization of MgChln in the solid
and liquid state after 72 h and 6 h simulated sunlight irradiation, respectively.

| | Molecular | Degree of | % photosensitizer | % photosensitizer |
|---|---|---|---|---|
| | weight | hydrolysis | remaining at 72 h | remaining at 6 h |
| Treatment | ( kDa) | (%) | (solid state) | (liquid state) |
| 0.1% Mgchln | — | — | 45.2 ± 7.1 | 44.6 ± 9.6 |
| 0.1% MgChln + 0.5% PVOH | 13-23 | 98 | 97.6 ± 4.4 | 30.4 ± 2.6 |
| 13 kDa 99% | | | | |
| 0.1% MgChln + 0.5% PVOH | 31-50 | 98-99 | 94.9 ± 5.7 | 29.6 ± 2 |
| 31 kDa 99% | | | | |
| 0.1% MgChln + 0.5% PVOH | 89-98 | >99 | 83.1 ± 11.7 | 30.0 ± 2.4 |
| 89 kDa 99% | | | | |
| 0.1% MgChln + 0.5% PVOH | 146-186 | >99 | 103.4 ± 5.1 | 27.5 ± 1.3 |
| 146 kDa 99% | | | | |
| 0.1% MgChln + 0.5% PVOH | 13-23 | 87-89 | 59.9 ± 5.1 | 30.2 ± 1.7 |
| 13 kDa 89% | | | | |
| 0.1% MgChln + 0.5% PVOH | 31-50 | 87-89 | 58 ± 4.4 | 30.9 ± 1.6 |
| 31 kDa 89% | | | | |
| 0.1% MgChln + 0.5% PVOH | 85-124 | 87-89 | 65.2 ± 2.5 | 31.3 ± 3.3 |
| 89 kDa 89% | | | | |
| 0.1% MgChln + 0.5% PVOH | 146-186 | 87-89 | 72.9 ± 5.8 | 32.7 ± 2.3 |
| 146 kDa 89% | | | | |
| 0.1% MgChln + 0.5% PVOH | 13-23 | 98 | 75.4 ± 4.7 | 88.6 ± 16.3 |
| 13 kDa 99% + 0.05% Tannic | | | | |
| Acid | | | | |
| 0.1% MgChln + 0.5% PVOH | 31-50 | 98-99 | 73.2 ± 1.6 | 81.1 ± 13.9 |
| 31 kDa 99% + 0.05% Tannic | | | | |
| Acid | | | | |
| 0.1% MgChln + 0.5% PVOH | 89-98 | >99 | 73.4 ± 4.4 | 80.5 ± 3 |
| 89 kDa 99% + 0.05% Tannic | | | | |
| Acid | | | | |
| 0.1% MgChln + 0.5% PVOH | 146-186 | >99 | 76.6 ± 2.9 | 63.5 ± 3.7 |
| 146 kDa 99% + 0.05% Tannic | | | | |
| Acid | | | | |
| 0.1% MgChln + 0.5% PVOH | 13-23 | 87-89 | 77.5 ± 6.7 | 66.8 ± 2.9 |
| 13 kDa 89% + 0.05% Tannic | | | | |
| Acid | | | | |
| 0.1% MgChln + 0.5% PVOH | 31-50 | 87-89 | 67.1 ± 9.9 | 61.1 ± 5.5 |
| 31 kDa 89% + 0.05% Tannic | | | | |
| Acid | | | | |
| 0.1% MgChln + 0.5% PVOH | 85-124 | 87-89 | 71.1 ± 6.4 | 55.4 ± 7.8 |
| 89 kDa 89% + 0.05% Tannic | | | | |
| Acid | | | | |
| 0.1% MgChln + 0.5% PVOH | 146-186 | 87-89 | 41.2 ± 4.8 | 52.8 ± 4.9 |
| 146 kDa 89% + 0.05% Tannic | | | | |
| Acid | | | | |

### Example 4

Solid and liquid state photostability of several formulations with PVOH (146 kDa; >99% hydrolysis) and tannic acid with varying plasticizer content were evaluated using Method A and Method B. The results are summarized in Table 4 below.

TABLE 4
Effect of polymer plasticizers on the photostablization of Magnesium Chlorophyllin (Mgchln)
in polyvinyl alcohol (146 kDa; >99% hydrolysis) (PVOH) and tannic acid formulations
in the solid and liquid states. Samples in the solid state received 72 h simulated sunlight
exposure, while liquid state samples received 6 h of simulated light exposure.

| | | % photosensitizer | % photosensitizer |
|---|---|---|---|
| | | remaining at 72 h | remaining at 6 h |
| Treatment | Plasticizer | (solid state) | (liquid state) |
| 0.1% MgChln + 0.5% PVOH + | — | 90.7 ± 7.4 | 76.3 ± 7.5 |
| 0.05% Tannic acid | | | |
| 0.1% MgChln + 0.5% PVOH + | 0.05% glycerol | 88.7 ± 8 | 75.6 ± 3.8 |
| 0.05% Tannic acid + 0.05% Glycerol | | | |
| 0.1% MgChln + 0.5% PVOH + | 0.1% glycerol | 84.5 ± 5.9 | 77.3 ± 5.2 |
| 0.05% Tannic acid + 0.1% Glycerol | | | |
| 0.1% MgChln + 0.5% PVOH + 0.05% | 0.05% propylene | 85.8 ± 5.7 | 71.6 ± 4.7 |
| Tannic acid + 0.05% Propylene glycol | glycol | | |
| 0.1% MgChln + 0.5% PVOH + 0.05% | 0.1% propylene | 90.8 ± 9.2 | 71.4 ± 1.3 |
| Tannic acid + 0.1% Propylene glycol | glycol | | |

Commercially available PVOH is often formulated with a plasticizer. This experiment shows that plasticizers do not particularly affect the solid state and liquid state stability of the photosensitizer.

### Example 5

Control of the fungal plant pathogen Colletotrichum orbiculare ATC20767 (Cgm) on the host plant Nicotiana benthamiana following treatment with formulations containing Magnesium chlorophyllin, sodium salt with hydrogel polymer, polyvinylalcohol 89 kDa (99%+hydrolysis) and phenolic antioxidant vanillin were assessed. Treatments were applied to N. benthamiana plants approximately 48 h prior to inoculation to simulate photodegradation on a leaf surface. Subsequently, with a spore suspension of Cgm was applied to the leaves. Plants were then exposed to light for a 24-hour period followed by dark incubation until disease symptoms were evident on the water-treated control plants. Once disease symptoms were evident, lesions were counted, and leaf area measured in order to determine the number of lesions/cm² leaf area. Four replicate plants were used per treatment and plants were randomized under the light source. Illumination is provided by LED lights emitting approximately 450 μmol/m²/s photosynthetically active radiation (PAR). The results are summarized in Table 5.

TABLE 5
Effect of polyvinyl alcohol (89 kDa; >99% hydrolysis) (PVOH)
and phenolic antioxidant, vanillin, on the activity of Magnesium
Chlorophyllin (MgChln) against Colletotrichum orbiculare in
Nicotiana benthamiana. Sprayed films were irradiated with fluorescent
lights for 48 h prior to inoculation with fungal spores.

| | % Disease |
|---|---|
| Treatment | Inhibition |
| Control | 0.0 |
| 0.03% MgChln | 95.1 |
| 0.03% MgChln + 0.5% PVOH 89 kda | 96.9 |
| 0.03% MgChln + 0.1% PVOH 89 kda | 95.6 |
| 0.03% MgChln + 0.1% Vanillin | 99.2 |
| 0.03% MgChln + 0.5% PVOH 89 kda + 0.1% Vanillin | 95.9 |
| 0.5% PVOH 89 kda | −55.8 |

### Example 6

Control of the fungal plant pathogen Colletotrichum orbiculare ATC20767 (Cgm) on the host plant Nicotiana benthamiana following treatment with formulations containing Magnesium chlorophyllin, sodium salt with hydrogel polymer, polyvinylalcohol 89 kDa (99%+hydrolysis) and phenolic antioxidant tannic acid were assessed. Treatments were applied to N. benthamiana plants approximately 48 h prior to inoculation to simulate photodegradation on a leaf surface. Subsequently, with a spore suspension of Cgm was applied to the leaves.

Plants were then exposed to light for a 24-hour period followed by dark incubation until disease symptoms were evident on the water-treated control plants. Once disease symptoms were evident, lesions were counted, and leaf area measured in order to determine the number of lesions/cm² leaf area. Four replicate plants were used per treatment and plants were randomized under the light source. Illumination is provided by LED lights emitting approximately 450 μmol/m²/s photosynthetically active radiation (PAR). The results are summarized in Table 6.

TABLE 6
Effect of polyvinyl alcohol (89 kDa; >99% hydrolysis) (PVOH) and
phenolic antioxidant, tannic acid, on the activity of Magnesium
Chlorophyllin (MgChln) against Colletotrichum orbiculare
in Nicotiana benthamiana.

| Treatment | % inhibition |
|---|---|
| Control | 0 |
| 0.03% MgChln | 76 |
| 0.03% MgChln + 0.25% PVOH + 0.05% Tannic acid | 92 |

### Example 7

An experiment on the effect of the film-forming compositions on the inhibition of the plant pathogen P. syringae in the host plant N. benthamiana was conducted in a Growth Room at 24° C. and 16/8 h light/dark photoperiod. Two days prior to inoculation, chemical treatments were applied to N. benthamiana plants at the 5-6 leaf stage until run off using a handheld spray bottle delivering a fine spray. Plants sprayed with water were used for Control. Immediately after treatment, plants were randomly placed on a shelf and exposed to LED lights emitting approximately 450 μmol/m2/s photo-synthetically active radiation (PAR) for a 12 h light/12 h dark photoperiod. For inoculation, Pst from a glycerol stock was cultured on Tryptic Soy Agar (TSA) and incubated overnight at 30° C. Bacterial cells were collected from the overnight culture, suspended in de-ionized water and diluted to 1×10\hat{ }8 CFU/ml followed by the addition of 0.02% (v/v) Silwet L-77. Inoculum was then applied to plants until runoff and the plants covered with transparent plastic domes to maintain 100% relative humidity. Inoculated plants were randomly placed on a shelf in the Growth room which was maintained at 24° C., and were exposed to a combination of fluorescent and LED lights emitting approximately 250 μmol/m²/s PAR for an 16 h light/8 h dark photoperiod for 7 days. Entire plants were assessed for disease severity using rating scale of 0-100%. Disease symptoms included yellow lesions, discoloration on foliage, leaf deformation and stunted growth. Four replications per treatment were used in the experiment.

TABLE 7
Effect of polyvinyl alcohol (89 kDa; >99% hydrolysis) (PVOH)
and phenolic antioxidant, vanillin, on the enhanced activity
of Magnesium Chlorophyllin (MgChln) against Pseudomonas syringae
v. tabacii in Nicotiana benthamiana.

| | Disease severity, % | |
|---|---|---|
| | | % Disease |
| Treatment | Mean | inhibition |
| Control | 80 | 0 |
| 0.03% MgChln | 43.8 | 45.3 |
| 0.03% MgChln + 0.5% PVOH | 33.8 | 57.8 |
| 0.03% MgChln + 0.1% Vanillin | 38.8 | 51.6 |
| 0.03% MgChln + 0.5% PVOH + 0.1% Vanillin | 33.8 | 57.8 |
| 0.5% PVOH | 70 | 12.5 |

### Example 8

One millilitre samples containing either 0.75% MgChln or 0.75% MgChln with 0.5% vanillin in dH₂O were prepared in 1.5 mL centrifuge tubes. These samples were wrapped in aluminum foil and stored in a 54° C. oven for a period of 2 weeks. After the 2-week period, the samples were taken out of the 54° C. oven or −20° C. freezer and assayed using the UV-Visible plate reader (Spectramax M2E, Molecular Devices, San Jose, CA) with 12 technical replicates per sample. The degradation of MgChln as a result of storage at elevated temperature was determined by calculating the % photosensitizer remaining using the following equation:

$$\% Photosensitizer remaining = ( \frac{A b {s}_{t}}{A b {s}_{0}} ) \times 100$$

where Absₜ is the absorbance peak of the sample after incubation for 2 weeks at 54° C.; Abs₀ is the absorbance peak of the sample at the start of experiment without being stored at 54° C. All data is expressed as mean±standard deviation. The results are summarized in Table 8.

TABLE 8
Thermal stability (2 weeks at 54° C.) of Magnesium chlorophyllin
(MgChln) in the presence and absence of vanillin.

| | % Photosensitizer |
|---|---|
| Treatment | remaining |
| 0.75% MgChln | 62 ± 7 |
| 0.75% MgChln + 0.5% Vanillin | 87 ± 6 |

### Example 9

Solid and liquid state photostability of several formulations with PVOH (89 kDa; >99% hydrolysis) and various antioxidant agents were evaluated using Method A and Method B. The results are summarized in Table 9 below.

TABLE 9
Effect of antioxidants and polyvinylalcohol (89 kDa; >99%
hydrolysis) on the photostablization of MgChln formulations
in the solid and liquid states. Samples in the solid state
received 72 h simulated sunlight exposure, while liquid state
samples received 6 h of simulated light exposure.

| | % photosensitizer | % photosensitizer |
|---|---|---|
| | remaining at 72 h | remaining at 6 h |
| Treatment | (solid state) | (liquid state) |
| 0.1% Mgchln | 31.6 ± 2.3 | 20.6 ± 3.9 |
| 0.1% Mgchln + 0.25% PVOH | 66 ± 5.4 | 22.1 ± 2 |
| 0.1% Mgchln + 0.25% PVOH + | 65.4 ± 8.2 | 75.8 ± 6.2 |
| 0.05% Tannic acid | | |
| 0.1% Mgchln + 0.25% PVOH + | 67.9 ± 3.6 | 55 ± 3.6 |
| 0.05% Gallic acid | | |
| 0.1% Mgchln + 0.25% PVOH + | 61.6 ± 3.2 | 85.3 ± 4.4 |
| 0.05% Propyl gallate | | |
| 0.1% Mgchln + 0.25% PVOH + | 62.1 ± 7.9 | 75.1 ± 6 |
| 0.05% Vanillin | | |
| 0.1% Mgchln + 0.25% PVOH + | 63.6 ± 10.7 | 52.1 ± 5.4 |
| 0.05% Vanillyl alcohol | | |
| 0.1% Mgchln + 0.25% PVOH + | 67.2 ± 7.5 | 74 ± 7.4 |
| 0.1% Borresperse NA¹ | | |

¹Lignosulfonate

### Example 10

Solid and liquid state photostability of several formulations with PVOH (189 kDa; >99% hydrolysis), tannic acid and various adjuvants were evaluated using Method A and Method B. The results are summarized in Table 10 below.

TABLE 10
Effect of adjuvants on the photostablization of Magnesium chlorophyllin
(Mgchln) in polyvinyl alcohol (89 kDa; >99% hydrolysis) (PVOH)
and tannic acid formulations in the solid and liquid states. Samples
in the solid state received 72 h simulated sunlight exposure, while
liquid state samples received 6 h of simulated light exposure.

| | % photosensitizer | % photosensitizer |
|---|---|---|
| | remaining at 72 h | remaining at 6 h |
| Treatment | (solid state) | (liquid state) |
| 0.1% MgChln | 41.2 ± 2.9 | 31.5 ± 5.3 |
| 0.1% MgChln + 0.05% Tannic | 90.4 ± 1.7 | 70.4 ± 10.3 |
| acid + 0.5% PVOH | | |
| 0.1% MgChln + 0.05% Tannic | 87.5 ± 4.3 | 77.5 ± 4.1 |
| acid + 0.5% PVOH + 0.05% | | |
| NaEDTA | | |
| 0.1% MgChln + 0.05% Tannic | 82.5 ± 5.8 | 80.6 ± 6.3 |
| acid + 0.5% PVOH + 0.1% | | |
| NaEDTA | | |
| 0.1% MgChln + 0.05% Tannic | 64.1 ± 4.6 | 62.6 ± 4.5 |
| acid + 0.5% PVOH + 0.1% | | |
| Pluronics F-127¹ | | |
| 0.1% MgChln + 0.05% Tannic | 70.3 ± 6 | 68.2 ± 3.3 |
| acid + 0.5% PVOH + 0.1% | | |
| Breakthru SD260² | | |
| 0.1% MgChln + 0.05% Tannic | 78.2 ± 5 | 49.2 ± 3.3 |
| acid + 0.5% PVOH + 0.1% | | |
| Xiameter OFX-309³ | | |
| 0.1% MgChln + 0.05% Tannic | 71.3 ± 10.9 | 83.3 ± 4.1 |
| acid + 0.5% PVOH + 0.1% | | |
| Saponin | | |
| 0.1% MgChln + 0.05% Tannic | 98.4 ± 6.5 | 74.1 ± 3.5 |
| acid + 0.5% PVOH + 0.1% | | |
| Morwet D-400⁴ | | |
| 0.1% MgChln + 0.05% Tannic | 70.4 ± 23.2 | 69.8 ± 1.7 |
| acid + 0.5% PVOH + 0.1% | | |
| Brij O10⁵ | | |

¹triblock copolymer (EO-PO-EO) (BASF)
²trisiloxane-based nonionic surfactant (EVONIK)
³3-(3-Hydroxypropyl) -heptamethyltrisiloxane, ethoxylated, acetate (Dow)
⁴Alkylnaphthalene sulfonate condensate (Nouryon)
⁵Polyoxyethylene (10) oleyl ether (Croda)

### Example 11

Solid and liquid state photostability of several formulations with various film-forming agents, tannic acid MgChln were evaluated using Method A and Method B. The results are summarized in Table 11 below.

TABLE 11
Effect of polymeric materials and tannic acid on photostability of MgChln in the solid
state. Samples in the solid state received 72 h simulated sunlight exposure.

| | % photosensitizer | % photosensitizer |
|---|---|---|
| | remaining at 72 h | remaining at 6 h |
| Treatment | (solid state) | (liquid state) |
| 0.1% MgChln | 42.4 ± 2.5 | 27.5 ± 1.8 |
| 0.1% MgChln + 0.5% PVOH (89 kDa; >99%) + | 88.7 ± 6.1 | 69.2 ± 2.8 |
| 0.05% Tannic acid | | |
| 0.1% MgChln + 0.5% | 56.5 ± 8.8 | 64.9 ± 13.5 |
| Galactasol 40H4FDS1¹ + 0.05% Tannic acid | | |
| 0.1% MgChln + 0.5% Carboxymethylcellulose + | 79.9 ± 2.6 | 61.1 ± 6.4 |
| 0.05% Tannic acid | | |
| 0.1% MgChln + 0.5% Poly(vinyl alcohol-co-ethylene) | 62.9 ± 9.9 | 20.4 ± 7.9 |
| (27 mol % ethylene) + 0.05% Tannic acid | | |
| 0.1% MgChln + 0.5% Solubon PT401² + 0.05% | 63.3 ± 5.5 | 71.8 ± 2.8 |
| Tannic acid | | |

¹Guar Gum (Ashland)
²Polyvinyl alcohol water soluble film (Aicello)

All film-forming agents tested greatly improve the photostability of the photosensitizer in the solid state. The photostability of the photosensitizer in the liquid state is also improved with Tannic acid and most of the film-forming agents. The treatment with MgChln, Poly(vinyl alcohol-co-ethylene) and Tannic acid appears to provide a similar liquid state photostability compared to MgChln alone (within the margin of error).

### Example 12

Solid and liquid state photostability of several formulations various photosensitizers with PVOH (189 kDa; >99% hydrolysis) and tannic acid were evaluated using Method A and Method B. The results are summarized in Table 12 below.

TABLE 12
Effect of polyvinyl alcohol (89 kDa; >99% hydrolysis) (PVOH) and tannic
acid on the photostabilization of various tetrapyrroles in the solid and
liquid states. Samples in the solid state received 72 h simulated sunlight
exposure, while liquid state samples received 6 h of simulated light exposure.

| | % photosensitizer | % photosensitizer |
|---|---|---|
| | remaining at 72 h | remaining at 6 h |
| Treatment | (solid state) | (liquid state) |
| 0.1% Chlorin e6, trisodium salt | 84.2 ± 7 | 19.4 ± 0.5 |
| (Ce6Na3) | | |
| 0.1% Chlorin e6-Dimethylaminoethyl (Ce₆- | 48.1 ± 14.1 | 23.9 ± 1 |
| mix-DMAE^{15,17} amide) | | |
| 0.1% Aluminum Ce6Na3 | 91.4 ± 5.5 | 3.9 ± 0.2 |
| 0.1% Ce6Na3 + 0.25% PVOH + 0.05% | 99.2 ± 1.1 | 48 ± 4.4 |
| Tannic acid | | |
| 0.1% Ce₆-mix-DMAE^{15,17} amide + 0.25% | 100.3 ± 1 | 49.9 ± 10.3 |
| PVOH + 0.05% Tannic acid | | |
| 0.1% Aluminum Ce6Na3 + 0.25% PVOH + | 89.9 ± 5.1 | 75 ± 7.4 |
| 0.05% Tannic acid | | |

Where Ce₆-mix-DMAE^{15,17} amide is a mixture of the following two compounds:

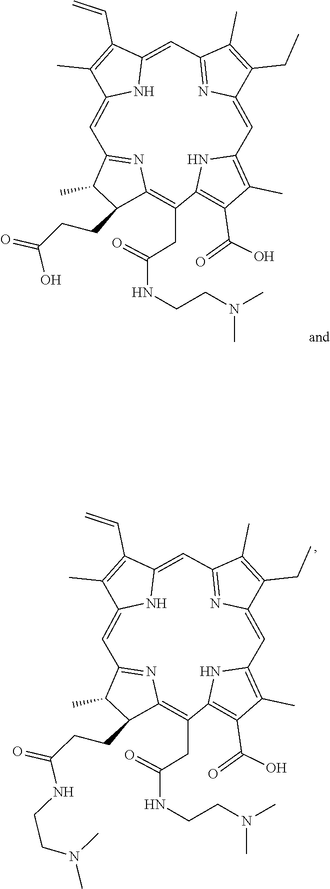 [SMILES: C=Cc1c(C)c2cc3nc(c(CC(=O)NCCN(C)C)c4[nH]c(cc5nc(cc1[nH]2)C(C)=C5CC)c(C)c4C(=O)O)[C@@H](CCC(=O)O)[C@@H]3C ; C=Cc1c(C)c2cc3nc(c(CC(=O)NCCN(C)C)c4[nH]c(cc5nc(cc1[nH]2)C(C)=C5CC)c(C)c4C(=O)O)[C@@H](CCC(=O)NCCN(C)C)[C@@H]3C]

in a molar ratio of about 1.5 (Ce₆-mono-DMAE¹⁵ amide):1 (Ce₆-bis-DMAE^{15,17} amide).

Examples 13-27 show that various Ce6 and PP IX compounds can improve the health of plants, by inhibiting growth of fungal pathogens, bacterial pathogens and/or a virus, by protecting the plant against abiotic stress, and/or by exhibiting insecticide activity. These Ce6 and PP IX compounds can be used in the film-forming combinations and compositions of the present description.

### Example 13

### Anti-Fungal Activity of Modified Ce6 Photosensitizers

Experiments were conducted to evaluate anti-fungal activity of several Ce6 derivatives synthesized herein. The following methods were used, and the results are summarized in Tables 13A and 13B.

Agar protocol: control of dollar spot fungus (Sclerotinia homoeocarpa) with modified Ce6 was assessed. Treatments were amended into Potato Dextrose Agar (PDA) at desired concentrations. Then, a 5 mm diameter plug of a Sclerotinia homoeocarpa isolate (3 isolates total tested) was inoculated into the center of the amended Petri-dish and incubated at 21° C. in the dark for 24 hours. After 24 hours, one set of Petri-dishes (in triplicate) was left in the dark and one set was placed under illumination for the remainder of the experiment (all at 21° C.). Radial growth of the fungus was monitored daily until the growth of S. homoeocarpa on non-amended PDA reaches the edge of the Petri-dish. Illumination was provided by fluorescent lights emitting about 180 μmol/m2/s photosynthetically active radiation (PAR).

Broth protocol: control of dollar spot fungus (Sclerotinia homoeocarpa) with modified chlorins was assessed. Treatments were prepared in Phosphate Buffered Saline (PBS) in 24 well plates (in duplicates for light vs. dark incubation) at desired concentrations. Then, a 5 mm diameter plug of a Sclerotinia homoeocarpa isolate (3 isolates total tested) was inoculated into the PBS and incubated at 21° C. in the dark for 2 hours. After 2 hours, one of the 24 well plates (with isolates in triplicate) was left in the dark and one 24 well plate was placed under illumination for 1 hour (all at 21° C.). Following illumination, fungal plugs were removed from PBS, blotted dry on sterile filter paper and transferred to non-amended Potato Dextrose Agar (PDA). Radial growth of the fungus was monitored daily until the growth of S. homoeocarpa reached the edge of the Petri-dish. Illumination was provided by LED lights emitting about 1000 μmol/m2/s photosynthetically active radiation (PAR).

TABLE 13A
Effect of modified Ce6 derivatives on dollar spot fungus

Inhibition, %
10 uM

| Agar data | Dark | Light |
|---|---|---|
| Ce6 Na₃ | 26 | 74 |
| Ce6-mix-DEAEAE^{15,17} amide | 15 | 100 |
| Ce6-mono-BAE¹⁵ amide | 49 | 99 |

TABLE 13B
Effect of modified Ce6 derivatives on dollar spot fungus

| | Inhibition, % | | | |
|---|---|---|---|---|
| | 10 uM | | 100 uM | |
| Broth data | Dark | Light | Dark | Light |
| Ce6Na3 | −4 | 53 | 16 | 66 |
| Ce6-mix-DMAB^{15,17} amide | | | | |
| Ce6-mono-EP¹⁵ amide | 3 | 58 | — | — |
| octylammonium salt | — | — | −5 | 71 |
| Ce6-mix-C4 | 13 | 86 | — | — |
| Ce6-T(TMS)SP^{15,17} amide | 1 | 60 | — | — |
| Ce6-mix-PEG₄₀₀^{15,17} allyl ester | — | — | 13 | 96 |
| Ce6-mix-PEG₆₀₀^{15,17} oleate ester | — | — | 26 | 92 |

The modified Ce6 compounds of Tables 13A and 13B can be used in the film-forming combinations and composition of the present description.

### Example 14

### Anti-Bacterial Activity of Modified Ce6 Photosensitizers

Experiments were conducted to evaluate control of the gram-negative bacterial plant pathogen Pseudomonas syringae pv. tabaci with modified Ce6. Treatments were prepared in Phosphate Buffered Saline (PBS) in 96 well plates at desired concentrations. A bacterial suspension was inoculated into the PBS and incubated at 28° C. in the dark for 30 min. After 30 min, the 96 well plate was placed under illumination for 1 hour (at 21° C.). A separate plate prepared at the same time was kept in the dark without illumination and served as dark control. Following illumination, bacterial suspensions were serially diluted and 10 μL of each dilution was spread uniformly on Tryptic Soy Agar (TSA) plates and placed in the dark in an incubator at 28° C. for 48 hours. After 48 hours, bacterial colonies were counted and results were log transformed (log colony forming units (CFU)/mL). The relative inactivation was determined by taking the difference between log CFU(PBS control) and log CFU (treatments). Sample Illumination was provided by LED lights (Heliospectra RX30) emitting about 1000 μmol/m²/s photosynthetically active radiation (PAR).

The modified Ce6 that were evaluated are the Ce6-mix-DMAE¹⁵¹⁷ amide, Ce6-bis-DMAE^{15,17} amide and Ce6-mono-DMAE¹⁵ amide. The results are presented in Table 14.

TABLE 14
Effect of modified Ce6 derivatives on dollar spot fungus

Relative Inactivation
(log[CFU_{control} mL⁻¹] −
log[CFUₜᵣₑₐₜₘₑₙₜ mL⁻¹])

| Treatments | Light | Dark |
|---|---|---|
| Ce6Na3 | 0.39 ± 0.29 | −0.03 ± 0.13 |
| Ce6-mix-DMAE^{15,17} amide | 7.98 ± 0.65 | 0.76 ± 0.24 |
| Ce6-bis-DMAE^{15,17} amide | 7.98 ± 0.65 | 1.13 ± 0.42 |
| Ce6-mono-DMAE¹⁵ amide | 7.98 ± 0.65 | 0.21 ± 0.33 |

It can be seen that all forms of Ce6 DMAE amide can be used (i.e., Ce6-mix-DMAE^{15,17} amide, Ce6-bis-DMAE^{15,17} amide or Ce6-mono-DMAE¹⁵ amide), with the relative inactivation obtained being the same. This is due to the data being represented as relative inactivation (i.e. log ratio between PBS control and treatment). Since, with all forms of Ce6 DMAE amide, the treatments killed all bacteria leaving no colony forming units, the value was set to 1 CFU/mL so as to not generate a mathematical error. The degree of inactivation is therefore dependent on the control counts and hence the values between the treatments are the same. These experiments nonetheless show that all forms of Ce6 DMAE amide are active against gram-negative bacteria.

The modified Ce6 compounds of Table 14 can be used in the film-forming combinations and compositions of the present description.

### Example 15

Effect of Treatments on Strawberry Plants (Fragaria x ananassa) Tolerance to Salt Stress

In this example, the effects of modified chlorin compounds were tested on strawberry plants (Fragaria x ananassa) cv Delizz. The experiments were carried out in a greenhouse. Tests were designed to determine the activity of compounds on strawberry plants tolerance to salt stress.

In the experiments, seedlings of strawberry plants were grown in 5-inch plastic pots filled with professional soil mix (LC 1 Sunshine, Sungro Horticulture, Canada) and irrigated with fertilized water on a regular basis. The strawberry plants at 4-5 leaf stage were treated with 3 foliar applications of different formulations using hand hold Spray bottle and providing an even coverage. The plants were sprayed with 7 days interval. Twenty-four hours after the first spray, the plants were exposed to salinity stress by soaking plant roots in 15 mM sodium chloride solution. The salinity level was gradually increased to 20 mM NaCl and salt soaking was applied on a 5 to 7 days interval schedule. Plants were harvested 3 weeks after last foliar spray. Surfactant was added to each treatment. The experiment was set out in a completely randomized design with 5 replications for each treatment.

TABLE 15
Effect of treatments on strawberry plants
(Fragaria × ananassa) tolerance to salt stress.

| | | Above-ground fresh |
|---|---|---|
| # | Treatment | biomass, % Increase |
| 1 | Salt Control | 0 |
| 2 | 0.05% Cu—Ce₆-mix-DMAE^{15,17} | 12 |
| | amide + 0.05% surfactant | |
| 3 | 0.05% Ce₆-mono-3TP-PEG₄₀₀¹⁵ | 22 |
| | amide + 0.05% surfactant | |
| 4 | 0.05% Cu—Ce₆-mono-3TP-PEG₄₀₀¹⁵ | 11 |
| | amide + 0.05% surfactant | |

Strawberry plants treated with tested chlorin compounds enhanced plants tolerance to salinity stress.

The modified Ce6 compounds of Table 15 can be used in the film-forming combinations and compositions of the present description.

### Example 16

### Effect of Treatments on Strawberry Plants (Fragaria x Ananassa) Tolerance to Drought Stress

In this example, the effects of modified chlorin compounds were tested on strawberry plants (Fragaria x ananassa) cv Delizz. The experiments were carried out in a greenhouse. Tests were designed to determine the activity of compounds on strawberry plants tolerance to drought stress.

In the experiments, seedlings of strawberry plants were grown in 5-inch plastic pots filled with professional soil mix (LC 1 Sunshine, Sungro horticulture, Canada) and irrigated with fertilized water on a regular basis. Strawberry plants at 4-5 leaf stage were treated with 3 foliar applications of different Suncor formulations using hand hold Spray bottle and providing an even coverage. The plants were sprayed with 7 days interval. After first foliar treatment and during the experiment duration, strawberry plants were exposed to reduced water regime (drought stress) until the wilting point (20 to 30% soil moisture capacity—SMC) and watered up to 50% SMC. Plants were harvested 3 weeks after the last foliar spray. Surfactant was added to each treatment. The experiment was set out in a completely randomized design with seven replications for each treatment.

TABLE 16
Effect of treatments on strawberry plants tolerance to drought stress

| | | Above-ground fresh |
|---|---|---|
| # | Treatment | biomass, % increase |
| 1 | Drought Control | 0 |
| 2 | 0.05% Ce₆-mix-DMAE^{15,17} | 12 |
| | amide + 0.05% surfactant | |
| 3 | 0.05% Cu—Ce₆-mix-DMAE^{15,17} | 26 |
| | amide + 0.05% surfactant | |
| 4 | 0.05% Ce₆-mono-3TP-PEG₄₀₀¹⁵ | 12 |
| | amide + 0.05% surfactant | |
| 5 | 0.05% Cu—Ce6-mono-3TP-PEG₄₀₀¹⁵ | 14 |
| | amide + 0.05% surfactant | |
| 6 | 0.05% surfactant | 4 |

Strawberry plants treated with tested chlorin compounds enhanced plants tolerance to drought stress.

The modified Ce6 compounds of Table 16 can be used in the film-forming combinations and compositions of the present description.

### Example 17

Effect of Treatments on Tomato Plants (Solanum lycopersicum) Cv. Tiny Tim Tolerance to Heat Stress

The experiments were carried out in a Growth Chamber in controllable conditions. Tests were designed to determine the activity of compounds on tomato plants tolerance to heat stress.

In the experiments, tomato plants cv. Tiny Tim were grown in the greenhouse at the temperature 24-26° C. Tomato seedlings were transplanted into 5″ plastic pots containing industrial soil mix (LC 1 Sunshine, Sungro Horticulture, Canada). At 5 to 6 leaves stage, plants were treated (foliar spray to run-off) with tested solutions using hand hold Spray bottle and providing an even coverage. Forty-eight hours after spray plants were moved into the Growth Chamber and exposed to heat stress for 10 days. Tomato plants were regularly watered to avoid water deficiency. Ten days later, tomato plants were transferred back to the greenhouse and treated with tested solutions for a second time. Forty-eight hours after second spray plants were placed to the Growth chamber and exposed to heat stress for another 10 days. Growth Chamber conditions: 16 h/8 h light/dark photoperiod; temperature during the dark 19° C.; temperatures during the light period—4 h gradual increase in temperature from 19° C. to 37° C., 8 h—37° C., gradual decrease in temperature to 19° C. Foliar treatments (spays) were applied 2 times. Surfactant was added to each treatment. The experiment was set out in a completely randomized design with six replications for each treatment.

TABLE 17
Effect of chlorin formulations on tomato
plants tolerance to heat stress.

| | | Above ground fresh |
|---|---|---|
| # | Treatment | biomass, % increase |
| 1 | Heat Control | 0 |
| 2 | 0.05% Cu—Ce₆-mix-DMAE^{15,17} | 11 |
| | amide + 0.05% surfactant | |
| 3 | 0.05% Ce₆-mono-3TP-PEG₄₀₀¹⁵ | 10 |
| | amide + 0.05% surfactant | |
| 4 | 0.05% Cu—Ce₆-mono-3TP-PEG₄₀₀¹⁵ | 10 |
| | amide + 0.05% surfactant | |
| 5 | 0.05% surfactant | 3 |

Novel chlorin formulations enhanced tomato plants tolerance to heat stress and increased plants biomass in comparison with untreated Control.

The modified Ce6 compounds of Table 17 can be used in the film-forming combinations and compositions of the present description.

### Example 18

Effect of Treatments on Kentucky Bluegrass (Poa pratensis) Tolerance to Salt Stress

Kentucky bluegrass (Poa pratensis) was grown under greenhouse conditions for ~3 weeks. After 3 weeks, plants were sprayed with formulations and allowed to sit for 24 hours, after which the pots were placed in a 170 mM NaCl solution until the soil was saturated. The salt application was repeated again 7 days later for a total of 2 salt applications. Salinity stress was evaluated based on a turf quality scale of 1-9; where 1=dead, brown turf; 6=minimally acceptable turf quality (based on standards for golf courses or sports fields); and 9=dense, dark green turf (healthy). Data are average of 5 replicates.

TABLE 18
Effect of salt stress on turf quality

| Treatment | Turf Quality |
|---|---|
| 0.1% Ce₆Na₃ | 6 |
| 0.1% Zn—Ce₆-mix-DMAE^{15,17} amide | 5.8 |
| 0.1% Cu—Ce₆-mix-DMAE^{15,17} amide | 6 |
| 0.1% Cu—Ce₆-mono-3TP-PEG₄₀₀¹⁵ amide | 6.2 |
| Untreated control | 5 |

The modified Ce6 compounds of Table 18 can be used in the film-forming combinations and compositions of the present description.

### Example 19

### Effect of Treatments on Silkworms

Experiments were conducted to evaluate the toxicity of a photosensitizer compounds to silkworms Bombyx mori (L.) larvae.

Colony of Silkworms (Bombyx mori) third instar larvae was purchased from the distributor Recorp Inc. (Ontario, Canada) and was maintained on fresh mulberry leaves (Morus rubra) for 2 days before the treatment.

Mulberry shoots were harvested from a tree grown outside and had not been treated with any pesticides. Fresh mulberry shoots were washed in tap water and then air-dried.

Small mulberry shoots (8-10 leaves) were excised from the mature healthy brunch and inserted into water-filled 50 ml plastic vials. The vials were covered with the lead and plastic mesh to prevent water evaporation and larvae drowning. Host plant cuttings were sprayed with tested solutions until run-off and vials with sprayed shoots were placed into 1 L transparent plastic containers lined with a filter paper.

Homogenous silkworm larvae (3^{rd} instar) were sprayed separately and released on treated mulberry shoots into containers. Soft fine paintbrush was used to handle the insects. Containers with plant shoots and insects were covered with white mesh leads.

All treatments were applied as a fine spray using a 2 oz hand-held mist sprayer-bottle (ULINE, Canada). Water treatment was used as a Control.

Containers with shoots and insects were placed randomly on a metal rack equipped with LED light and immediately irradiated with light 450 μmol m⁻² s⁻¹. Experiment was conducted in Plant Growth Room at temperature 24-26° C. and photoperiod of 12 h LED light and 12 h dark. Silkworms were allowed to feed on the treated mulberry leaves for 48 h. Food source was replaced once a day. Completely Randomized Design with four replicates for each treatment and 10 insects for each replicate were used in experiment. Larvae were considered dead if no movement was detected after mechanical stimulation with a paintbrush. The number of live and dead insects were recorded. Insect mortality was assessed for up to 72 h hours after treatment (HAT—hours after treatment). Mulberry leaves were assessed for phytotoxicity symptoms.

Zn-Ce₆-mix-DMAE^{15,17} amide and Pd-Ce₆-mix-DMAE^{15,17} amide were formulated with propylene glycol and Pluronic F-127 surfactants to improve solubility in water.

TABLE 19
Effect of photosensitizer on Silkworm larvae Mortality.

| | | Larvae | | Larva weight |
|---|---|---|---|---|
| | | mortality, % | | reduction, % |
| # | Treatment | 48 HAT | 72 HAT | 72 HAT |
| 1 | Control (water) | 0 | 15 | 0 |
| 2 | 0.1% Ce₆-mono-3TP- | 0 | 17.5 | 32 |
| | PEG₄₀₀¹⁵ amide | | | |
| 3 | 0.1% Cu—Ce₆-mix-DMAE^{15,17} | 0 | 12.5 | 14 |
| | amide | | | |
| 4 | 0.1% Ce₆-mix-DMAE^{15,17} amide | 17.5 | 57.5 | 89 |
| 5 | 0.1% Zn—Ce₆-mix-DMAE^{15,17} | 12.5 | 32.5 | 44 |
| | amide + Surfactants | | | |
| 6 | 0.1% Pd—Ce₆-mix-DMAE^{15,17} | 10 | 35 | 59 |
| | amide + Surfactants | | | |
| 7 | Surfactants | 2.5 | 15 | 19 |

* Surfactants (0.5% propylene glycol + 0.1% Pluronics F-127)

Treatments 0.1% Ce₆-mix-DMAE^{15,17} amide and 0.1% Pd-Ce₆-mix-DMAE^{15,17} amide+0.5% Propylene glycol+0.1% Pluronic F127 caused larvae mortality 57.5% and 35% respectively and greatly reduced larvae weight.

Treated mulberry shoots did not display any visible symptoms of phytotoxicity. None of the tested formulations caused phytotoxicity on plant leaves.

The modified Ce6 compounds of Table 19 can be used in the film-forming combinations and compositions of the present description.

### Example 20

Control of Fungal Pathogen Cgm on Nicotiana benthamiana

Control of the fungal plant pathogen Colletotrichum orbiculare ATC20767 (Cgm) on the host plant Nicotiana benthamiana following treatment with modified Chlorin e6 compounds was assessed. Treatments were applied to N. benthamiana plants approximately 2 h prior to inoculation with a spore suspension of Cgm. Plants were then exposed to light for a 24-hour period followed by dark incubation until disease symptoms were evident on the water treated control plants. Once disease symptoms were evident, lesions were counted, and leaf area measured in order to determine the number of lesions/cm² leaf area. Four replicate plants were used per treatment and plants were randomized under the light source. Illumination was provided by LED lights emitting about 180 μmol/m²/s photosynthetically active radiation (PAR). The results are shown in Tables 20A, 20B and 20C.

TABLE 20A
Effect of modified Ce6 compounds on Colletotrichum orbiculare.

| | Disease |
|---|---|
| Treatment | inhibition, % |
| 0.05% Ce₆-mix-DMAE^{15,17} amide | 87 |
| 0.05% Zn—Ce₆-mix-DMAE^{15,17} amide | 35 |
| 0.05% Pd—Ce₆-mix-DMAE^{15,17} amide | 1 |
| 0.05% Cu—Ce₆-mix-DMAE^{15,17} amide | 69 |
| Untreated Control | 0 |

Surfactants can be added into the solution to increase the solubility of the compounds and spreading on the leaf surfaces.

TABLE 20B
Effect of modified Ce6 compounds on Colletotrichum orbiculare.

| | Disease |
|---|---|
| Treatment | inhibition, % |
| Untreated Control | 0 |
| 0.05% Ce₆-mix-DMAE^{15,17} amide + Surfactants | 72 |
| 0.05% Zn—Ce₆-mix-DMAE^{15,17} amide + Surfactants | 97 |
| 0.05% Pd—Ce₆-mix-DMAE^{15,17} amide + Surfactants | 87 |
| 0.05% Cu—Ce₆-mix-DMAE^{15,17} amide + Surfactants | 96 |
| 0.05% Ce₆-mono-DMAE¹⁵ amide + Surfactants | 94 |
| Surfactants | −29 |

* Surfactants (0.5% propylene glycol + 0.1% Pluronics F-127)

In another experiment, PEG modified Ce6 compounds were tested against Cgm.

TABLE 20C
Effect of modified Ce6 compounds on Colletotrichum orbiculare

| | Disease |
|---|---|
| | inhibition, |
| Treatment | % |
| Control | 0 |
| 0.05% Ce₆-mono-3TP-PEG₄₀₀¹⁵ amide + Surfactants | 63 |
| 0.05% Zn—Ce₆-mono-3TP-PEG₄₀₀¹⁵ amide + Surfactants | 26 |
| Surfactant | 12 |

* Surfactants (0.5% propylene glycol + 0.1% Pluronics F-127)

The modified Ce6 compounds of Tables 20A, 20B and 20C can be used in the film-forming combinations and compositions of the present description.

### Example 21

Control of bacterial pathogen Pst on Arabidopsis thaliana

Arabidopsis thaliana plants were grown under 12 hours:12 hours, light:dark photoperiod, under LED lights (PAR 24 μmol m⁻² s⁻¹), at a temperature of 25° C.±3° C. and 65% relative humidity. After 3 weeks, plants were sprayed with formulations (50% dilution in water), allowed to dry for 2 h, after which Pseudomonas syringae pv tabacci (at OD0.08 diluted in 10 mM MgCl2) was sprayed. Plants were kept under plastic domes until symptoms develop. Disease severity was rated by counting the number of yellow leaves/plant. Data are average of 3 replicas.

TABLE 21
Effect of modified Ce6 compounds on bacterial
pathogen Pst on Arabidopsis thaliana

| | Disease |
|---|---|
| | inhibition, |
| Treatment | % |
| Untreated Control | 0 |
| 0.05% Ce₆-mix-DMAE^{15,17} amide + surfactants | 48 |
| 0.05% Zn—Ce₆-mix-DMAE^{15,17} amide + surfactants | 45 |
| 0.05% Pd—Ce₆-mix-DMAE^{15,17} amide + surfactants | 52 |
| 0.05% Cu—Ce₆-mix-DMAE^{15,17} amide + surfactants | 34 |
| 0.05% Ce₆-mono-DMAE¹⁵ amide + surfactants | 56 |
| 0.05% Ce₆-mono-3TP-PEG₄₀₀¹⁵ amide + surfactants | 22 |
| 0.05% Zn—Ce₆-mono-3TP-PEG₄₀₀¹⁵ amide + surfactants | 34 |
| surfactants | 0 |

* Surfactants (0.5% propylene glycol + 0.1% Pluronics F-127)

The modified Ce6 compounds of Table 21 can be used in the film-forming combinations and compositions of the present description.

### Example 22

Control of Pseudomonas syringae pv. tabaci (Pst) on Nicotiana benthamiana

Control of the bacterial plant pathogen Pseudomonas syringae pv. tabaci (Pst) on the host plant Nicotiana benthamiana following treatment with modified Chlorin e6 compounds was assessed. Treatments were applied to N. benthamiana plants approximately 2 h prior to inoculation with a spore suspension of Cgm. Plants were then exposed to light for a 24-hour period followed by dark incubation until disease symptoms were evident on the water treated control plants. Once disease symptoms were evident, lesions were counted, and leaf area measured in order to determine the number of lesions/cm² leaf area. Four replicate plants were used per treatment and plants were randomized under the light source. Illumination was provided by LED lights emitting about 180 μmol/m²/s photosynthetically active radiation (PAR). The results are shown in Table 22.

TABLE 22
Effect of modified Ce6 on Pseudomonas syringae
pv. tabaci (Pst) on Nicotiana benthamiana

| | Disease |
|---|---|
| | inhibition, |
| | % |
| Untreated Control | 0 |
| 0.1% Zn—Ce₆-mono-3TP-PEG₄₀₀¹⁵ amide | 47 |
| 0.1% Ce₆-mono-3TP-PEG₄₀₀¹⁵ amide | 63 |
| 0.1% Pd—Ce₆-mix-DMAE^{15,17} amide + | 65 |
| surfactants | |
| surfactants | 34 |

* Surfactants (0.5% Propylene glycol + 0.1% Pluronics F-127)

The modified Ce6 compounds of Table 22 can be used in the film-forming combinations and compositions of the present description.

### Example 23

Control of Rose Aphids with Modified Ce6 Compounds

Experiment was conducted to evaluate the toxicity of chlorine derivatives for insect pest Rose aphid (Marcosiphum rosae). The experiment was conducted on rosebushes (cv Knockout, Double red) infested with aphids. Experiment was carried out in Plant Nursery (Crop Inspection Service, California, Valley center, USA). Experimental plants were not exposed to pesticide treatments before testing.

Experimental rose plants were grown outdoor in 3-gal black plastic pots filled with Sunshine #4 soil mix. Plants were irrigated every day and soluble fertilizer 20-20-20 at 200 ppm was applied twice weekly.

Newly infested with aphid nymphs tips of rose plant shoots were used in experiment. Numbers of Rose aphids in colonies congregating on the tips of shoots were counted prior to the treatment and treated shoots were covered with white 4×6″ mesh Organza bags (ULINE, USA) to avoid infestation by natural enemies. Bags were kept on shoots during the trial. Upon initiation of the experiment the aphids population (on shoots) was considered uniform with 25-28 aphids per shoot. A completely randomized design was used with 6 replicates plants (one shoot per plant).

Treatments were applied using 2 oz plastic hand-held spray bottle (Natural Cylinder Spray Bottle, ULINE, Canada) delivering uniform fine spay on plant shoots. Rose shoots were thoroughly sprayed with tested treatments and exposed to direct sunlight. A second application of treatments was made 7 days after the first application using the same methodology.

The effect of treatments on insects was determined by live insects count at 7 after 1^{st} treatment and 14 days after 2^{nd} treatment.

Plants were evaluated for phytotoxicity at 6 days after each foliar spray.

TABLE 23
Effect of chlorin derivatives on Rose aphids.

| | | Insects suppression, % | |
|---|---|---|---|
| # | Treatment | 7 DAT1 | 14 DAT2 |
| 1 | Control (water) | 0 | 0 |
| 2 | 0.1% Ce6-mono-3TP-PEG₄₀₀¹⁵ amide | 40 | 65 |
| 3 | 0.1% Cu—Ce6-mix-DMAE^{15,17} amide | 76 | 18 |
| 4 | 0.1% Ce6-mix-DMAE^{15,17} amide | 45 | 66 |

Treatments with 0.1% Ce6-mono-3TP-PEG400¹⁵ amide and 0.1% Ce6-mix-DMAE^{15,17} amide demonstrated good efficacy against Rose aphids and suppressed insect population in comparison with Water Control treatment.

Treated rosebushes shoots did not display any visible symptoms of phytotoxicity.

The modified Ce6 compounds of Table 23 can be used in the film-forming combinations and compositions of the present description.

### Example 24

Control of Cucumber Mosaic Virus on Bell pepper plants

Dwarf type bell pepper ‘Golden baby belle hybrid’ seedlings were transplanted into pots filled with pro-mix at 3-4 leaf stage and placed in a growth chamber with temperature at 26/23° C. (day/night), 70% relative humidity, and light intensity at 270 μmol m⁻² s⁻¹ with 12 hours photoperiod. A formulation comprising 0.1 wt % Ce6-mix-DMAE^{15,17} amide and surfactant was applied as foliar application on day 7, 14, 21, and 28 after transplanting with a hand-held sprayer until the foliage was covered with the solution completely (~2.5 mL/pot). The plants were well-watered by hand irrigation and fertilized at 0.73 g nitrogen m⁻² from 28-8-18 complete fertilizer every 2 weeks. Cucumber Mosaic Virus (CMV) inoculation took place 2 hours after 3^{rd} application. For the inoculation, leaf blades (~1 g) of CMV virus-infected tobacco plant was ground in about 1 mL PBS buffer (50 mM, pH 7) with mortar and pestle, a small amount of carborundum was added to the mixture. Q-tip was used to apply to the upper surface of the top 3 newly developed leaf blades of pepper. A randomized block design with 4 replications were used. The pots were re-arranged randomly in the growth chambers twice a week. Severity of CMV disease development in leaves was measured at day 19, 21, 28, 35, and end of trial. The disease severity was calculated as follows: Disease severity=the number of infected leaves/3 inoculated leaves+number of infected younger leaf/number of total younger leaves.

TABLE 24
Cucumber mosaic virus (CMV) disease severity

| | CMV disease severity | | | | | |
|---|---|---|---|---|---|---|
| | | | | | End of | Ave- |
| Treatment | Day19 | Day21 | Day28 | Day35 | trial | rage |
| 0.1% Ce6-mix- | 0.17 | 0.42 | 0.27 | 0.32 | 0.55 | 0.34 |
| DMAE^{15,17} | | | | | | |
| amide + Surfactant | | | | | | |
| Control | 0.91 | 0.92 | 1.47 | 1.27 | 1.48 | 1.21 |

*Surfactant: 0.1% APG325N

The modified Ce6 compounds of Table 24 can be used in the film-forming combinations and compositions of the present description.

### Example 25

Effect of PP IX and modified PP IX on Pseudomonas syringae pv. tabaci

In this example, control of the gram-negative bacterial plant pathogen Pseudomonas syringae pv. tabaci with PP IX and modified PP IX was assessed, with and without chelating agents. Treatments were prepared in Phosphate Buffered Saline (PBS) in 96 well plates at desired concentrations. A bacterial suspension was inoculated into the PBS and incubated at 28° C. in the dark for 30 minutes. After 30 minutes, the 96 well plate was placed under illumination for 1 hour (at 21° C.). Following illumination, bacterial suspensions were serially diluted and 10 μL of each dilution is spread uniformly on Tryptic Soy Agar (TSA) plates and placed in the dark in an incubator at 28° C. for 48 hours. After 48 hours, bacterial colonies were counted, and the results were log transformed (log colony forming units (CFU)/mL). The relative inactivation was determined by taking the difference between log CFU(PBS control) and log CFU(treatments). Sample Illumination was provided by LED lights (Heliospectra RX30) emitting about 1000 μmol/m²/s photosynthetically active radiation (PAR). The results are summarized in Table 25.

TABLE 25
Effect of 10 μM PP IX and PP IX
derivatives on Pseudomonas syringae

| | log |
|---|---|
| Compound | CFU/ml |
| PBS (control) | 8.7 |
| 10 μM PP IX disodium salt | 7.4 |
| 10 μM (PP IX-mono-DMAE:PP IX-bis-DMAE - 50:50) | 8.7 |
| 10 μM (PP IX-mono-DMAE:PP IX-bis-DMAE - 20:80) | 5.5 |
| 10 μM PP IX disodium salt + 5 mM NaEDTA | 3.8 |
| 10 μM (PP IX-mono-DMAE:PP IX-bis-DMAE - 50:50) + | 3.1 |
| 5 mM NaEDTA | |
| 10 μM (PP IX-mono-DMAE:PP IX-bis-DMAE - 20:80) + | 0.0 |
| 5 mM NaEDTA | |

*“PP IX-mono” type compounds are a mixture (about 50:50) of the mono-substituted PP IX at the C₁₅ position and the mono-substituted PP IX at the C₁₇ position.

The PP IX and modified PP IX compounds of Table 25 can be used in the film-forming combinations and compositions of the present description.

### Example 26

### Effect of PP IX and Modified PP IX on Dollar Spot Fungus

In this example, control of dollar spot fungus (Sclerotinia homoeocarpa) with PP IX and modified PP IX was assessed. Treatments were prepared in Phosphate Buffered Saline (PBS) in 24 well plates (in duplicates for light vs. dark incubation) at desired concentrations. Then, a 5 mm diameter plug of a Sclerotinia homoeocarpa isolate (3 isolates total tested) was inoculated into the PBS and incubated at 21° C. in the dark for 2 hours. After 2 hours, one of the 24 well plates (with isolates in triplicate) was left in the dark and one 24 well plate was placed under illumination for 1 hour (all at 21° C.). Following illumination, fungal plugs were removed from PBS, blotted dry on sterile filter paper and transferred to non-amended Potato Dextrose Agar (PDA). Radial growth of the fungus was monitored daily until the growth of S. homoeocarpa reaches the edge of the Petri-dish. Illumination was provided by LED lights emitting about 1000 μmol/m2/s photosynthetically active radiation (PAR). The results are summarized at Tables 26A and 26B.

TABLE 26A
Results in Dark (no light exposure)

| | Mean Radial | % |
|---|---|---|
| Treatment¹ | Growth^{2,3} | Inhibition⁴ |
| PBS (control) | 10.1 | — |
| 31 μM Protoporphyrin IX disodium salt + | 10.5 | −3.8 |
| 0.21% BrijO10:ArlasolveDMI (1:4) | | |
| 31 μM (PP IX-mono-DMAE:PP | 0.0 | 100.0 |
| IX-bis-DMAE - 20:80) + | | |
| 0.21% BrijO10:ArlasolveDMI (1:4) | | |
| 31 μM (PP IX-mono-DMAE:PP | 0.0 | 100.0 |
| IX-bis-DMAE - 50:50) + | | |
| 0.21% BrijO10:ArlasolveDMI (1:4) | | |
| 0.21% BrijO10:ArlasolveDMI (1:4) | 10.3 | −1.6 |

Notes on above table:
¹Treatments were prepared in Phosphate Buffered Saline (PBS), incubated on shaker (200 rpm) for 2 hours in the dark, then kept in dark for 1 hour with no shaking.
²Means were calculated based on 3 fungal isolates replicated 3 times, with 2 measurements per replicate (18 total measurements)
³Means represent growth that occurred between 24 and 48 hours of incubation at 21° C.
⁴% Inhibition calculated relative to non-amended control
*“PP IX-mono” type compounds are a mixture (about 50:50) of the mono-substituted PP IX at the C₁₅ position and the mono-substituted PP IX at the C₁₇ position.

TABLE 26B
Results in Light (exposed to light for 1 hour)

| | Mean Radial | % |
|---|---|---|
| Treatment¹ | Growth^{2,3} | Inhibition⁴ |
| PBS (control) | 10.2 | — |
| 31 μM Protoporphyrin IX disodium salt + | 0.0 | 100.0 |
| 0.21% BrijO10:ArlasolveDMI (1:4) | | |
| 31 μM (PP IX-mono-DMAE:PP | 0.0 | 100.0 |
| IX-bis-DMAE - 20:80) + 0.21% | | |
| BrijO10:ArlasolveDMI (1:4) | | |
| 31 μM (PP IX-mono-DMAE:PP | 0.0 | 100.0 |
| IX-bis-DMAE - 50:50) + 0.21% | | |
| BrijO10:ArlasolveDMI (1:4) | | |
| 0.21% BrijO10:ArlasolveDMI (1:4) | 6.1 | 40.2 |

Notes on above table:
¹Treatments were prepared in Phosphate Buffered Saline (PBS), incubated on shaker (200 rpm) for 2 hours in the dark, then exposed to light (Helios, 1000 PAR) for 1 hour.
²Means were calculated based on 3 fungal isolates replicated 3 times, with 2 measurements per replicate (18 total measurements)
³Means represent growth that occurred between 24 and 48 hours of incubation at 21° C.
⁴% Inhibition calculated relative to non-amended control
*“PP IX-mono” type compounds are a mixture (about 50:50) of the mono-substituted PP IX at the C₁₅ position and the mono-substituted PP IX at the C₁₇ position.

The PP IX and modified PP IX compounds of Tables 26A and 26B can be used in the film-forming combinations and compositions of the present description.

### Example 27

Effect of PP IX and modified PP IX on Colletotrichum orbiculare

Control of the fungal plant pathogen Colletatrichum orbiculare ATC20767 (Cgm) on the host plant Nicotiana bentharniana following treatment with modified PP IX compounds was assessed. Treatments were applied to N. benthamiana plants approximately 2 h prior to inoculation with a spore suspension of Cgm. Plants were then exposed to light for a 24-hour period followed by dark incubation until disease symptoms were evident on the water treated control plants. Once disease symptoms were evident, lesions were counted and leaf area measured in order to determine the number of lesions/cm² leaf area. Four replicate plants were used per treatment and plants were randomized under the light source Illumination is provided by LED lights emitting about 180 μmol/m²/s photosynthetically active radiation (PAR The results are shown in Table 27.

TABLE 27
Effect of modified PP IX compounds
on Colletotrichum orbiculare.

| Treatment | % inhibition |
|---|---|
| untreated control | 0 |
| 0.05% (PP IX-mono-DMAE:PP IX-bis-DMAE - | 93 |
| 20:80) | |
| 0.05% (PP IX-mono-DMAE:PP IX-bis-DMAE - | 89 |
| 50:50) | |
| 0.05% PP IX-mono-PEG₆₀₀ | 56 |
| 0.05% PP IX-mono-L-valine | 50 |
| 0.05% PP IX-mono-glycine | 35 |

*“PP IX-mono” type compounds are a mixture (about 50:50) of the mono-substituted PP IX at the C₁₅ position and the mono-substituted PP IX at the C₁₇ position.

The PP IX and modified PP IX compound of Table 27 can be used in the film-forming combinations and compositions of the present description.

### Abbreviations for Modified Ce6 and PP IX Compounds:

| | Compound | | |
|---|---|---|---|
| | abbreviation | Chemical structures | |
| 1 | Ce6-mix- DEAEAE^{15,17} amide | 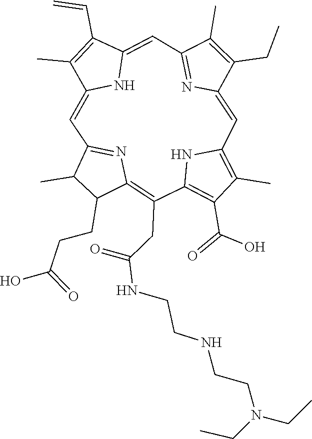 [SMILES: C=Cc1c(C)c2cc3nc(c(CC(=O)NCCNCCN(CC)CC)c4[nH]c(cc5nc(cc1[nH]2)C(C)=C5CC)c(C)c4C(=O)O)C(CCC(=O)O)C3C] | 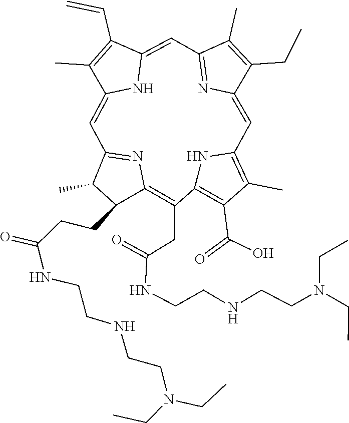 [SMILES: C=Cc1c(C)c2cc3nc(c(CC(=O)NCCNCCN(CC)CC)c4[nH]c(cc5nc(cc1[nH]2)C(C)=C5CC)c(C)c4C(=O)O)[C@@H](CCC(=O)NCCNCCN(CC)CC)[C@@H]3C] |
| 2 | Ce6-mix- DMAE^{15,17} amide | 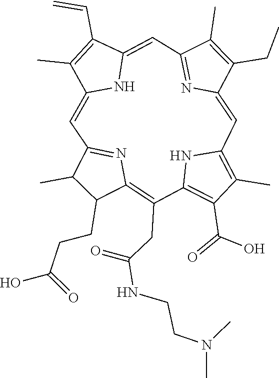 [SMILES: C=Cc1c(C)c2cc3nc(c(CC(=O)NCCN(C)C)c4[nH]c(cc5nc(cc1[nH]2)C(C)=C5CC)c(C)c4C(=O)O)C(CCC(=O)O)C3C] | 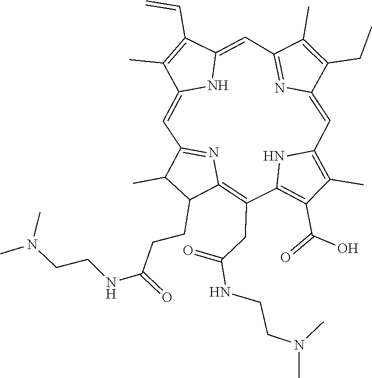 [SMILES: C=Cc1c(C)c2cc3nc(c(CC(=O)NCCN(C)C)c4[nH]c(cc5nc(cc1[nH]2)C(C)=C5CC)c(C)c4C(=O)O)C(CCC(=O)NCCN(C)C)C3C] |
| 3 | Ce6-mix- DMAB^{15,17} amide | 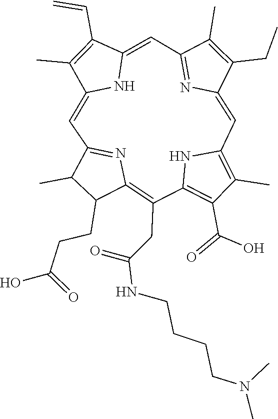 [SMILES: C=Cc1c(C)c2cc3nc(c(CC(=O)NCCCCN(C)C)c4[nH]c(cc5nc(cc1[nH]2)C(C)=C5CC)c(C)c4C(=O)O)C(CCC(=O)O)C3C] | 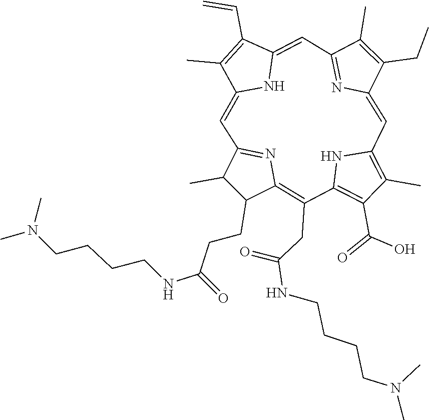 [SMILES: C=Cc1c(C)c2cc3nc(c(CC(=O)NCCCCN(C)C)c4[nH]c(cc5nc(cc1[nH]2)C(C)=C5CC)c(C)c4C(=O)O)C(CCC(=O)NCCCCN(C)C)C3C] |
| 4 | Ce6-mix- C4^{15,17} amide | 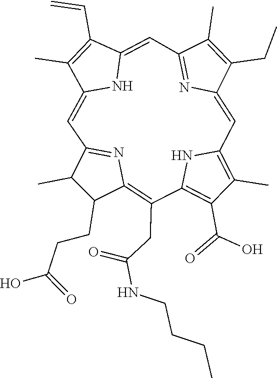 [SMILES: C=Cc1c(C)c2cc3nc(c(CC(=O)NCCCC)c4[nH]c(cc5nc(cc1[nH]2)C(C)=C5CC)c(C)c4C(=O)O)C(CCC(=O)O)C3C] | 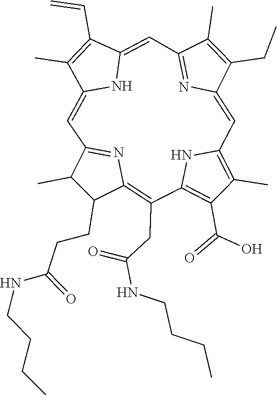 [SMILES: C=Cc1c(C)c2cc3nc(c(CC(=O)NCCCC)c4[nH]c(cc5nc(cc1[nH]2)C(C)=C5CC)c(C)c4C(=O)O)C(CCC(=O)NCCCC)C3C] |
| 5 | Ce6-mix- T(TMS) SP^{15,17} amide | 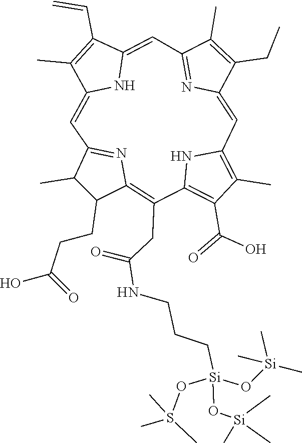 [SMILES: C=Cc1c(C)c2cc3nc(c(CC(=O)NCCC[Si](O[Si](C)(C)C)(O[Si](C)(C)C)OS(C)(C)C)c4[nH]c(cc5nc(cc1[nH]2)C(C)=C5CC)c(C)c4C(=O)O)C(CCC(=O)O)C3C] | 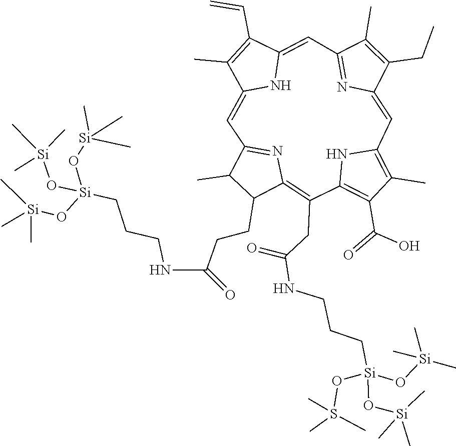 |
| 6 | Ce6- mono-EP¹⁵ amide octyl- ammonium salt | 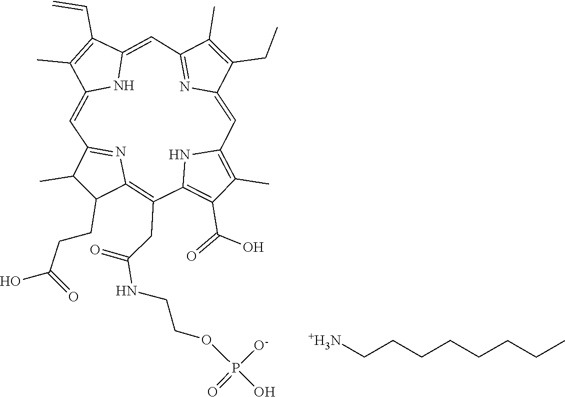 | |
| 7 | Ce6-mix- PEG₄₀₀^{15,17}- allyl ester | 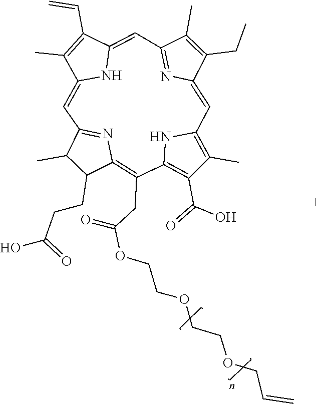 | 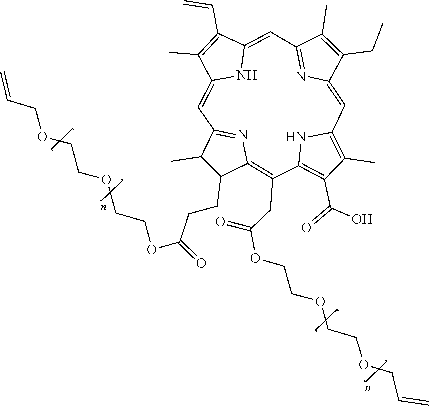 |
| 8 | Ce6-mix- PEG₆₀₀^{15,17}- oleate ester | 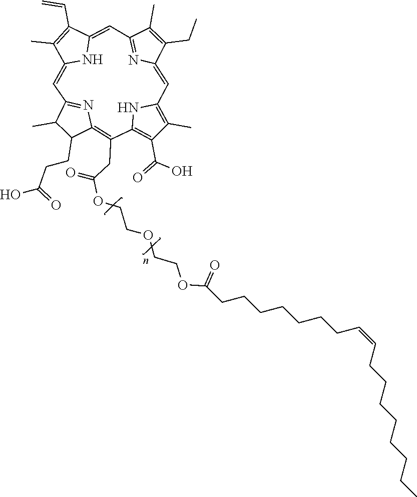 | |
| | | 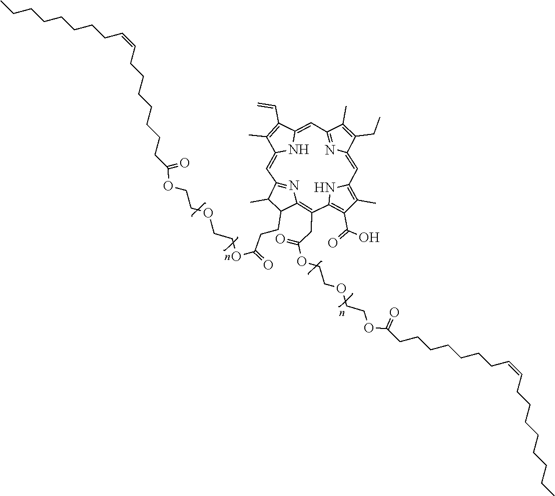 | |
| 9 | Ce6- mono- DMAE¹⁵ amide | 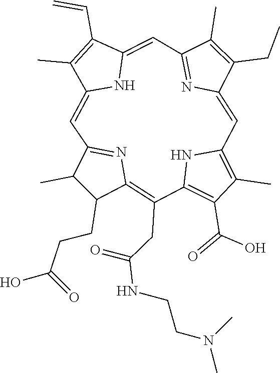 [SMILES: C=Cc1c(C)c2cc3nc(c(CC(=O)NCCN(C)C)c4[nH]c(cc5nc(cc1[nH]2)C(C)=C5CC)c(C)c4C(=O)O)C(CCC(=O)O)C3C] | |
| 10 | Ce6- mono- BAE¹⁵ amide | 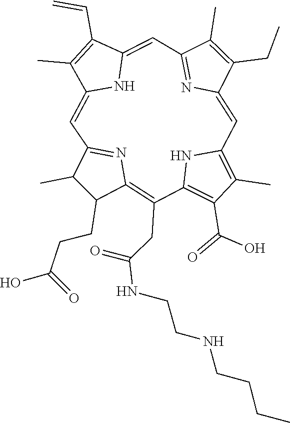 [SMILES: C=Cc1c(C)c2cc3nc(c(CC(=O)NCCNCCCC)c4[nH]c(cc5nc(cc1[nH]2)C(C)=C5CC)c(C)c4C(=O)O)C(CCC(=O)O)C3C] | |
| 11 | Ce6- mono-3TP- PEG₄₀₀¹⁵ a mide | 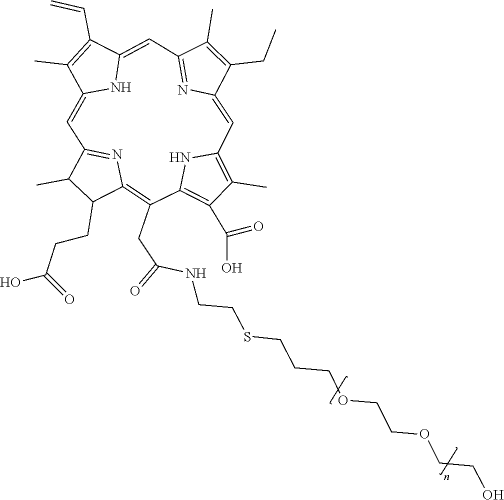 | |
| 12 | Ce6-bis- DMAE^{15,17} amide | 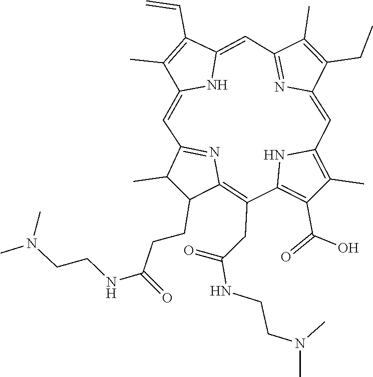 [SMILES: C=Cc1c(C)c2cc3nc(c(CC(=O)NCCN(C)C)c4[nH]c(cc5nc(cc1[nH]2)C(C)=C5CC)c(C)c4C(=O)O)C(CCC(=O)NCCN(C)C)C3C] | |
| 13 | Cu Ce6- mix- DMAE^{15,17} amide | 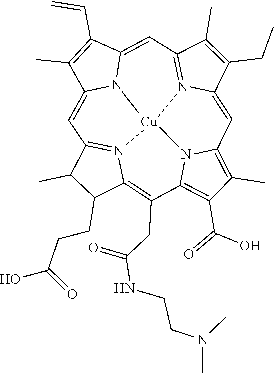 | 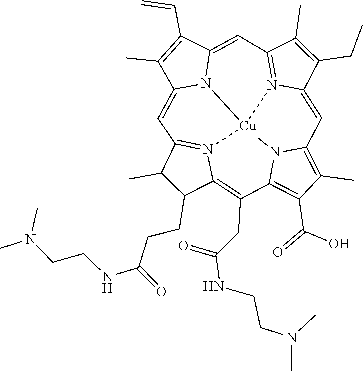 |
| 14 | Zn Ce6- mix- DMAE^{15,17} amide | 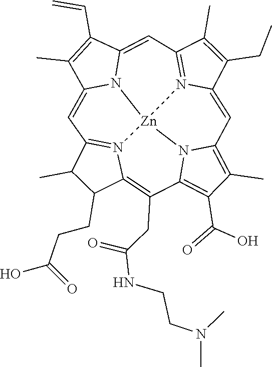 | 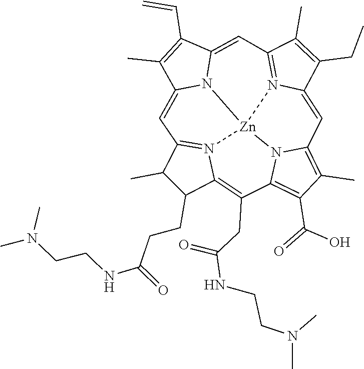 |
| 15 | Zn Ce6- mono- 3TP- PEG₄₀₀¹⁵ amide | 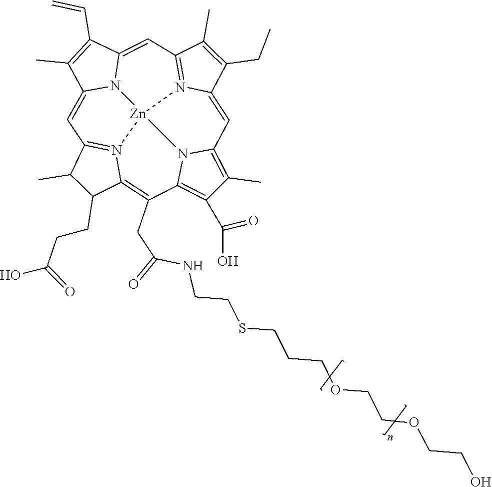 | |
| 16 | Pd Ce6-mix- DMAE^{15,17} amide | 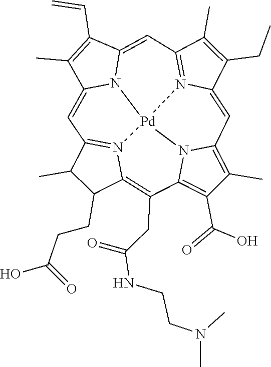 | 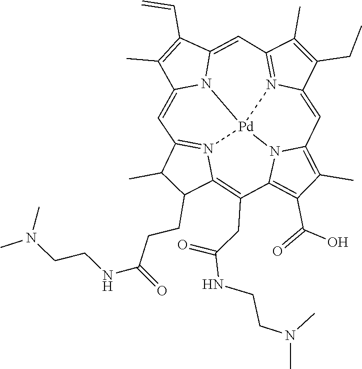 |
| 17 | PP IX- mono- DMAE | 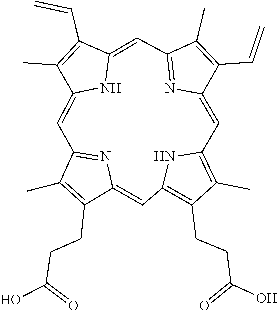 [SMILES: C=CC1=C(C)c2cc3[nH]c(cc4nc(cc5[nH]c(cc1n2)c(C)c5CCC(=O)O)C(CCC(=O)O)=C4C)c(C)c3C=C] | 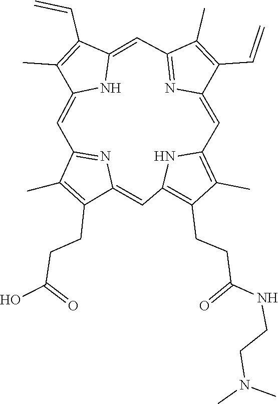 [SMILES: C=CC1=C(C)c2cc3[nH]c(cc4nc(cc5[nH]c(cc1n2)c(C)c5CCC(=O)NCCN(C)C)C(CCC(=O)O)=C4C)c(C)c3C=C] |
| 18 | PP IX- bis-DMAE | 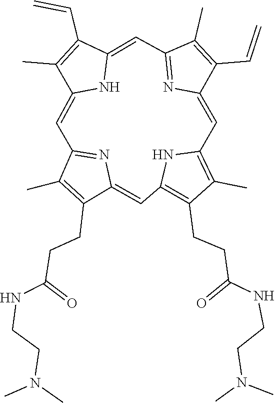 | |
| 19 | PP IX- mono- PEG₆₀₀ | 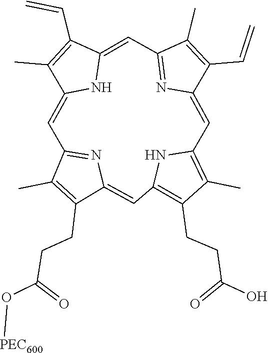 | 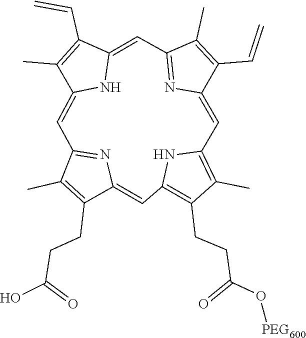 |
| 20 | PP IX- mono- valine | 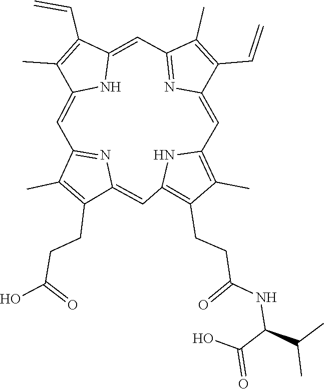 [SMILES: C=CC1=C(C)c2cc3[nH]c(cc4nc(cc5[nH]c(cc1n2)c(C)c5CCC(=O)N[C@H](C(=O)O)C(C)C)C(CCC(=O)O)=C4C)c(C)c3C=C] | 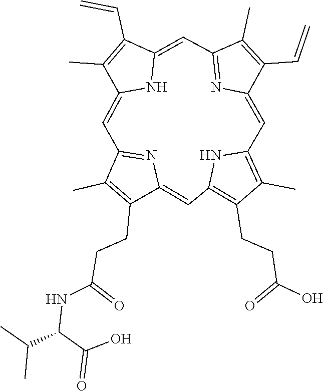 [SMILES: C=CC1=C(C)c2cc3[nH]c(cc4nc(cc5[nH]c(cc1n2)c(C)c5CCC(=O)O)C(CCC(=O)N[C@H](C(=O)O)C(C)C)=C4C)c(C)c3C=C] |
| 21 | PP IX- mono- glycine | 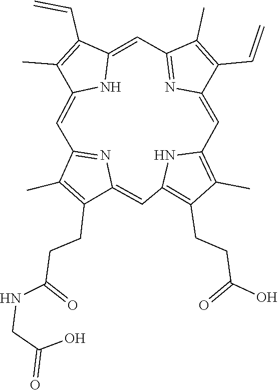 [SMILES: C=CC1=C(C)c2cc3[nH]c(cc4nc(cc5[nH]c(cc1n2)c(C)c5CCC(=O)O)C(CCC(=O)NCC(=O)O)=C4C)c(C)c3C=C] | 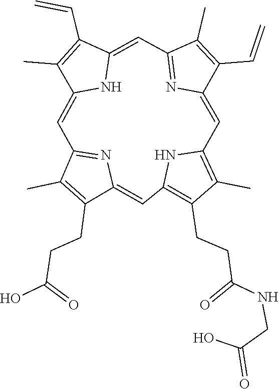 [SMILES: C=CC1=C(C)c2cc3[nH]c(cc4nc(cc5[nH]c(cc1n2)c(C)c5CCC(=O)NCC(=O)O)C(CCC(=O)O)=C4C)c(C)c3C=C] |

*All the Ce6 compounds have an (S), (S) stereochemistry for the two asymmetric carbons

All publications, patents, and patent documents cited herein above are incorporated by reference herein, as though individually incorporated by reference. The compounds, compositions, methods and uses described herein have been described with reference to various embodiments and techniques. However, one skilled in the art will understand that many variations and modifications can be made while remaining within the spirit and scope of the appended claims.

What is claimed:

1. A method for promoting the health of a plant, the method comprising:
applying to the plant a composition including:
a photosensitizer that generates reactive oxygen species in the presence of light and oxygen, the photosensitizer being selected from the group consisting of a porphyrin, a reduced porphyrin and a combination thereof,
a film-forming agent;
an antioxidant agent; and
a liquid carrier, in which the photosensitizer, the film-forming agent and the antioxidant agent are solubilized or dispersed; and
removing at least a portion of the aqueous carrier from the composition for the film forming agent to form a film on the plant that is substantially impermeable to oxygen when in a non-hydrated state, and wherein the composition can be penetrated by oxygen in a hydrated state.

2. The method of claim 1, wherein applying the composition to the plant is performed by at least one of irrigating and spraying.

3. The method of claim 1, wherein applying the composition to the plant comprises applying the composition to a non-regenerable part of the plant.

4. The method of claim 1, wherein removing the at least a portion of the liquid carrier from the composition comprises at least one of exposing the plant to a low humidity environment, exposing the plant to heat, exposing the plant to a stream or air, inert gas or nitrogen and allowing the composition to naturally dry on the plant.

5. The method of claim 4, wherein removing the at least a portion of the liquid carrier from the composition comprises allowing the composition to naturally dry on the plant.

6. The method of claim 1, wherein promoting the health of the plant comprises preventing or inhibiting growth of a microbial pathogen of the plant.

7. The method of claim 1, wherein promoting the health of the plant comprises inhibiting growth of a microbial pathogen of the plant.

8. The method of claim 7, wherein the microbial pathogen comprises a fungal pathogen, a bacterial pathogen, a virus, a viroid, a virus-like organism or a phytoplasma.

9. The method of claim 1, wherein promoting the health of the plant comprises increasing resistance of the plant to one or more abiotic stress.

10. The method of claim 1, wherein promoting the health of the plant comprises controlling an insect pest of the plant.

11. The method of claim 1, wherein the film-forming agent is selected from the group consisting of: ethylcellulose, methylcellulose, carboxymethyl cellulose, hydroxymethylcellulose, hydroxypropylcellulose, hydroxymethylpropylcellulose, guar gum, hydroxylpropyl cellulose, polyvinylpyrrolidone, nanocellulose, soy protein isolate, whey protein, collagen, starch, hydroxypropylated amylomaize starch, amylomaize starch, xylan, polyvinylidene chloride, polyvinyl alcohol (PVOH), ethylene vinyl alcohol (EVA), polyvinyl alcohol copolymer, and combinations thereof.

12. The method of claim 11, wherein the film-forming agent comprises polyvinyl alcohol.

13. The method of claim 12, wherein the polyvinyl alcohol has an average molecular weight from about 50 kDa to about 100 kDa, and a degree of hydrolysis equal to or greater than 99%.

14. The method of claim 1, wherein the antioxidant agent is selected from the group consisting of vanillin (4-hydroxy-3-methoxybenzaldehyde), o-vanillin (2-hydroxy-3-methoxybenzaldehyde), vanillyl alcohol, tannic acid, gallic acid, propyl gallate, lauryl gallate, carvacrol, eugenol, thymol, lignosulfonate sodium, t-butyl-hydroxyquinone, butylated hydroxytoluene, butylated hydroxyanisole, alpha-tocopherol, D-alpha-tocopheryl polyethylene glycol succinate, retinyl palmitate, beta-carotene, erythorbic acid, sodium erythorbate, sodium ascorbate, ascorbic acid, gluthatione, superoxide dismutase, catalase, sodium azide, 1,4-diazabicyclo[2.2.2]octane (DABCO), and combinations thereof.

15. The method of claim 14, wherein the antioxidant agent comprises a phenolic antioxidant.

16. The composition of claim 15, wherein the phenolic antioxidant is selected from the group consisting of vanillin (4-hydroxy-3-methoxybenzaldehyde), o-vanillin (2-hydroxy-3-methoxybenzaldehyde), vanillyl alcohol, tannic acid, gallic acid, propyl gallate, lauryl gallate, carvacrol, eugenol, thymol, lignosulfonate, and combinations thereof.

17. The method of claim 1, wherein the photosensitizer is chlorin e6 or a modified chlorin e6, a protoporphyrin IX (PP IX) or a modified PP IX, or meso-tetra-(4-sulfonatophenyl) porphyrin (TPPS).

18. The method of claim 1, further comprising a chelating agent,

19. The method of claim 1, wherein the film-forming agent is present in an amount between about 0.01 wt % and about 20 wt %, based on a total weight of the composition.

20. The method of claim 19, wherein the antioxidant agent is present in an amount between about 0.01 wt. % and about 5 wt. % based on the total weight of the composition and wherein the photosensitizer is present in an amount between about 0.01 wt. % and about 10 wt. % based on the total weight of the composition.
